(19) United States
(12) Patent Application Publication
(10) Pub. No.: US 2017/0304894 A1
(43) Pub. Date: Oct. 26, 2017

(54) PRINTING THREE-DIMENSIONAL OBJECTS USING BEAM ARRAY

(71) Applicant: Velo3D, Inc., Campbell, CA (US)

(72) Inventor: Benyamin BULLER, Cupertino, CA (US)

(21) Appl. No.: 15/523,524

(22) PCT Filed: Nov. 9, 2015
(86) PCT No.: PCT/US15/59790

§ 371 Date: May 1, 2017

Related U.S. Application Data
(60) Provisional application No. 62/077,646, filed on Nov. 10, 2014.
(60) Provisional application No. 62/082,506, filed on Nov. 20, 2014.

(51) Int. Cl. B22F 3/105; B33Y 70/00; B33Y 30/00; B33Y 40/00; B29C 35/08

(52) U.S. Cl. CPC B22F 3/105; B33Y 40/00; B33Y 70/00; B33Y 30/00; B22F 2003/1052; B22F 2003/1058; B22F 2003/1059; B29C 2035/0838; B22F 2003/1054

(57) ABSTRACT

Provided herein are systems, apparatuses, and methods for generating a three-dimensional (3D) object using an energy beam array. Also provided herein are systems, apparatuses and methods for generating a 3D object with small-scaffold features, as well as systems, apparatuses and methods for generating a 3D object using roll-to-roll. The roll-to-roll apparatus may include a moving platform of the 3D object. The 3D object can be formed by an additive manufacturing process from a material such as powder.

### CROSS-REFERENCE

This application claims priority to PCT Patent Application Serial Number PCT/US15/59790, filed Nov. 9, 2015, which claims priority to U.S. Provisional Patent Application Ser. No. 62/077,646, filed Nov. 10, 2014, and U.S. Provisional Patent Application Ser. No. 62/082,506, filed Nov. 20, 2014, all of which are entirely incorporated herein by reference.

### BACKGROUND

Three-dimensional (3D) printing (e.g., additive manufacturing) is a process for making a 3D object of any shape from a design. The design may be in the form of a data source such as an electronic data source, or may be in the form of a hard copy. The hard copy may be a two dimensional representation of a three dimensional object. The data source may be an electronic 3D model. 3D printing may be accomplished through an additive processes in which successive layers of material are laid down on top of each other. This process may be controlled and/or regulated (e.g., automatically, manually, or both). A 3D printer can be an industrial robot.

3D printing can generate custom parts quickly and efficiently. A variety of materials can be used in a 3D printing process including metal, metal alloy, ceramic or polymeric material. The polymeric material may be a resin In an additive 3D printing process, a first material-layer is formed, and thereafter, successive material-layers are added one by one, wherein each new material-layer is added on a pre-formed material-layer, until the entire designed three-dimensional structure (3D object) is materialized.

3D models may be created with a computer aided design package or via 3D scanner. The manual modeling process of preparing geometric data for 3D computer graphics may be similar to plastic arts, such as sculpting or animating. 3D scanning is a process of analyzing and collecting digital data on the shape and appearance of a real object. Based on this data, 3D models of the scanned object can be produced.

A large number of additive processes are currently available. They may differ in the manner in which layers are deposited to create the materialized structure. They may vary in the material or materials that are used to materialize the designed structure. Some processes melt or soften material to produce the layers. Examples for 3D printing processes include selective laser melting (SLM), selective laser sintering (SLS), direct metal laser sintering (DMLS) or fused deposition modeling (FDM). Other processes cure liquid materials using different technologies, such as stereo lithography (SLA). In laminated object manufacturing (LOM), thin layers (made inter alia of paper, polymer, metal) are cut to shape and joined together.

3D printing can be used to form objects of various sizes and configurations. Objects comprising internal features can have enhanced structural properties. Small lattice structures, such as nanostructures microstructures and mesostructures, can increase the strength to weight ratio of an object. However, formation of small lattice structures can require prolonged (and meticulous) manufacturing processes. These manufacturing processes can be time consuming, meticulous, and/or costly. Furthermore, these manufacturing processes can be limited to small objects and in some cases these manufacturing processes cannot be scaled to large production or production of large, macroscale, objects.

### SUMMARY

In one aspect, a method for generating a 3D object comprises (a) providing a material bed comprising a material for use in generating at least a portion of the 3D object; and (b) transforming at least a portion of the material in the material bed using a plurality of energy beams from an energy beam array to form a hardened material, which transforming comprises subjecting the plurality of energy beams to relative motion with respect to material bed along a vectorial path, wherein the hardened material forms at least a portion of the 3D object.

The material can be a powder material. The material can comprise individual particles formed of an elemental metal, metal alloy, ceramic, or an allotrope of elemental carbon. The energy beam and/or material bed may translate. The transforming step can comprise directly and/or indirectly hardening. Indirectly hardening may comprise transforming at least a portion of the material in the material bed into a transformed material that subsequently hardens into a hardened material to form at least a portion of the 3D object. Direct hardening may comprise transforming at least a portion of the material bed that constitutes hardening the at least a portion of the material bed. Transforming may comprise fusing. Fusing may comprise melting or sintering. The 3D object may comprise a (small) scaffold feature. The 3D object may comprise a scaffold feature generated by the plurality of energy beams. The path for generating the scaffold feature may comprise simultaneously generating a multiplicity of cells within the scaffold feature. The energy beam array may comprise an electromagnetic beam or a charged particle beam. The electromagnetic beam may be a laser. The laser can be a laser diode. The energy beam array may comprise an n by m matrix of energy sources, wherein ‘n’ is an integer greater than or equal to one, and wherein ‘m’ is an integer greater than or equal to two. Each of the plurality of energy beams may have a footprint diameter on an exposed surface of the material bed that is from about 0.3 micrometers to 100 micrometers. Each of the plurality of energy beams may have a power of 0.5 watts to 10 watts. At least two of the energy beams of the plurality of energy beams may each be generated by an energy source as part of the energy beam array. Each energy beams of the plurality of energy beams may each be generated by its own an energy source as part of the energy beam array. At least two of the (e.g., each) energy beam of the plurality of energy beams may be generated by the same energy source as part of the energy beam array. The energy source may produce a power of 0.5 watts to 10 watts.

In another aspect, a system for generating a 3D object comprises: (a) a material bed comprising a material for use in generating at least a portion of the 3D object; (b) an energy beam array that provides a plurality of energy beams that transforms at least a portion of the material in the material bed into a hardened material; (c) a controller that is operatively coupled to the energy beam array, wherein the controller directs the plurality of energy beams at the material bed along a vectorial (e.g., vector) path to transform at least a portion of the material in the material bed into a hardened material that forms at least a portion of the 3D object.

The transformation step can comprise an indirect hardening. The indirect transformation may comprise transformation of at least a portion of the material in the material bed into a transformed material that subsequently hardens to a hardened material to form at least a portion of the 3D object. Transformation may comprise fusing. Fusing may comprise melting or sintering. Transformation can be directly hardening. The 3D object may comprise a scaffold feature. Each of the plurality of energy beams can be independently controllable by the controller. The 3D object may comprise a scaffold feature that can be generated by the plurality of energy beams. The vectorial path for generating the scaffold feature can comprise forming multiple repeating cells within the scaffold feature while the energy beam array travels in one path. The system may further comprise an additional energy beam that provides an energy beam independently of the energy beam array. The system may further comprise an additional energy source that provides an energy beam independently of the energy beam array. The plurality of energy beams may comprise a electromagnetic beam or a charged particle beam. The electromagnetic beam can be a laser. The laser can be a laser diode. The energy beam array can comprise an ‘n by m matrix of energy beams. The variable ‘n’ can be an integer greater than or equal to one. The variable ‘m’ can be an integer greater than or equal to two. Each of the energy beams may have a spot size an exposed surface of the powder bed that can be at most about 100 micrometers. Each of the energy beams may have a spot size an exposed surface of the powder bed that can be from about 0.3 micrometers to about 100 micrometers. Each of the energy beams is generated by its own respective energy source having a power of at most about 10 Watts. Each of the energy beams is generated by its own respective energy source having a power of from about 0.5 Watts to about 10 Watts. The energy beams may form multiple cells within the small scaffold structure simultaneously. The cells may comprise space-filling polygons. The energy beams may comprise low power energy beams. The power can be from about one (1) watt to about ten (10) watts. The energy beams may be a highly focused energy beams. The focus of a footprint of at least two (e.g., each) of the energy beams on the exposed surface of the material bed can be from about 0.3 micrometers to about 100 micrometers. The energy beams may be single mode energy beams.

In another aspect, an apparatus for generating a 3D object may comprise: (a) a material bed comprising a material for use in generating at least a portion of the 3D object; and (b) an energy beam array that provides a plurality of energy beams that translate in a vectorial path along the exposed surface of the material bed, wherein the energy beam array is disposed adjacent to the material bed.

The energy beam array may be disposed above the exposed surface of the material bed. The material bed may be disposed adjacent to a platform. The energy beam array may be disposed above the exposed surface of the material bed. The apparatus may further comprise a material dispensing mechanism (e.g., material dispenser) that dispenses material into the material bed, wherein the material dispenser is disposed adjacent to the material bed. The apparatus may further comprising a layer dispensing mechanism disposed adjacent to the material bed. The layer dispensing mechanism may comprise a material dispensing mechanism or material leveling mechanism. The material dispensing mechanism can comprise an exit opening port from which the material dispenses onto the platform, wherein the material dispensing mechanism is disposed adjacent to the platform. The material leveling mechanism comprises a blade, wherein the material leveling mechanism is disposed adjacent to the platform. The material leveling mechanism may comprise a reservoir for collecting material from the material bed.

In another aspect, an apparatus for generating a first 3D object comprises a controller that is programmed to direct an energy beam array to travel along a vectorial path and transform at least a portion of a material bed into a hardened material to form at least a portion of the 3D object, wherein the controller is operatively coupled to the energy beam array. The controller may be operatively coupled to the material bed. The material may be a powder material. The path may exclude a raster pattern. The transformed material may form a scaffold (e.g., small scaffold) structure.

The energy beam array may form multiple cells within the small scaffold structure simultaneously. The cells may comprise space-filling polygons. The energy beams may comprise low power energy beams. The power may be from one (1) watt to ten (10) watts. The energy beams may comprise a high focus energy beams. The focus of a footprint of at least two (e.g., each) of the energy beams on the exposed surface of the material bed is at most about 100 micrometers. The focus of a footprint of at least two (e.g., each) of the energy beams on the exposed surface of the material bed is from about 0.3 micrometers to about 100 micrometers. The energy beams may be single mode energy beams.

In another aspect, a method for generating a first 3D object comprises: (a) disposing a powder material on a first platform to provide a powder bed, which platform is operatively coupled to a first station for transforming the powder material and a second station for transforming the powder material; (b) transforming, in the first station, at least a portion of the powder bed to form a first portion of hardened material that corresponds to at least a portion of the first 3D object; (c) translating the platform to the second station; (d) transforming, in the second station, at least a portion of the powder bed to form a second portion of hardened material that corresponds to at least a portion of the first 3D object.

The first platform can be slanted. The transforming can be additive and/or subtractive. The first station can be separated from the second station by a gap. The transforming in the first station utilizes a first energy beam. The transforming in the second station may utilize a second energy beam. The platform can be wrapped around a payout roll. The platform can be translated from a payout roll. The platform can be translated to an uptake roll. The platform can be wrapped around an uptake roll. The platform can be slanted such that the powder bed is deeper close to the uptake roll and shallower closer to the payout roll. The first platform may comprise multiple platforms. The translating may comprise using a motor. The method may further comprise a second translating platform that translates towards the first platform. The second platform may carry a second 3D object. The method may further comprise connecting the first three dimensional object to the second three dimensional object to form a third 3D object. The third 3D object may further comprise a device. The device may be externally controllable. The device may alter a characteristics of at least the third 3D object.

In another aspect, a system for generating a first 3D object comprises: (a) a powder bed disposed on a first platform, which first platform is translatable; (b) a first station comprising a first energy source that provides a first energy beam to transform at least a portion of the powder bed into a first hardened material that corresponds to at least a portion of the 3D object; (c) a second station comprising a second energy source that provides a second energy beam to transform at least a portion of the powder bed into a second hardened material that corresponds to at least a portion of the 3D object; and (c) a controller operatively coupled to the first platform, the first energy beam and the second energy beam, wherein the controller is programmed to: (i) direct the first energy beam along a first path to transform at least a portion of the powder bed into the first hardened material; (ii) translate the first platform from the first station to the second station; and (iii) direct the second energy beam along a second path to transform at least a portion of the powder bed into the second hardened material.

The first platform can be slanted. The first station can be separated from the second station by a gap. The first hardened material and the second hardened material each forms a portion of the 3D object. The system may further comprise a first energy source that generates the first energy beam. The system may further comprise a second energy source that generates the second energy beam. The first energy beam can comprise an array of energy beams. The platform can be wrapped around a payout roll. The platform can be translated from a payout roll. The platform can be translated to an uptake roll. The platform can be wrapped around an uptake roll. The platform can be slanted such that the powder bed is deeper close to the uptake roll and shallower closer to the payout roll. The first platform can comprise multiple platforms. The system may further comprise a motor that translates the platform. The system may further comprise a second translating platform that is operatively coupled to the controller. The controller may be programmed to translate the second platform towards the first platform. The second platform may carry a second 3D object. The system may further comprise connecting the first three dimensional object to the second three dimensional object to form a third three dimensional object. The third 3D object may further comprises a device. The device may be externally controllable. The device may alter a characteristic(s) of the 3D object. The characteristics may comprise porosity, temperature, conductivity, thickness, transparency, color, absorption, permeability, chemical, or physical characteristics.

In another aspect, an apparatus for generating a first 3D object comprises: (a) a powder bed disposed on a slanted first platform that translates; (b) a first station comprising a first energy beam that transforms at least a portion of the powder bed into a first hardened material as a portion of the 3D object, wherein the powder bed is disposed adjacent to the first energy beam; and (c) a second station comprising a second energy beam that transforms at least a portion of the powder bed into a second hardened material as a portion of the 3D object, wherein the powder bed is disposed adjacent to the second energy beam, wherein the transform translates from the first station to the second station.

The apparatus may further comprise a material dispenser that provides the powder bed to the platform. The material dispenser may dispense the material to form the material bed. The material dispenser may be disposed between the first station or the second station such that the material dispenser dispenses the material before the first energy beam and/or before the second energy beam transforms at least a portion of the powder bed. The first energy beam and/or the second energy beam may comprise an energy beam array. The platform may be slanted. The platform may be slanted such that the height of the material bed is greater at the second station as compared its height at the first station. The platform may be slanted such that the height of the material bed is greater at the first station as compared its height at the second station. The apparatus may further comprise a payout roll that translates the platform away from the payout roll. The apparatus may further comprise an uptake roll that translates the platform towards the payout roll. The apparatus may further comprise a second platform that carries a second 3D object. The second platform may translate towards the first platform. The second 3D objects may connect to the first three dimensional object to form a third 3D object. The third 3D object may comprise a device. The device may be externally controllable. The device may be inserted into the third 3D object before, during, and/or after the connection of the first three dimensional object to the second three dimensional object. The device may alter at least one characteristics of the third 3D object. The apparatus may further comprise a material dispenser that dispenses material into the material bed. The material dispenser may be disposed adjacent to the platform. The apparatus may further comprise a layer dispensing mechanism disposed adjacent to the platform. The layer dispensing mechanism may comprise a material dispensing mechanism (e.g., material dispenser) or material leveling mechanism. The material dispensing mechanism may comprise an exit opening port from which the material dispenses onto the platform. The material dispensing mechanism may be disposed adjacent to the platform. The material leveling mechanism may comprise a blade. The material leveling mechanism may be disposed adjacent to the platform. The material leveling mechanism may comprise a reservoir for collecting material from the material bed.

In another aspect, an apparatus for generating a first 3D object comprises a controller comprising one or more computer processors that are individually or collectively programmed to: (i) in a first station, direct a first energy beam along a first path to transform at least a portion of a powder bed into a first hardened material that forms at least a portion of the 3D object, wherein the powder bed is disposed on a translating platform; (ii) translate the platform from the first station to a second station; and (iii) direct a second energy beam along a second path to transform at least a portion of the powder bed into a second hardened material that forms at least a portion of the 3D object.

The first energy beam can be disposed in a first station. The controller can be operatively coupled to the platform. The controller can be operatively coupled to the first energy beam. The first hardened material and the second hardened material each may form a portion of the first 3D object. The first station can be separated from the second station by a gap. The translating platform can be slanted. The path may correspond to a cross section of the first 3D object. The path can be generated based on model of a predetermined (e.g., desired) first 3D object. The one or more computer processors may comprise a multi core processor. The controller may comprise parallel processor architecture. The one or more computer processors may comprise a field programmable gate arrays (FPGA).

In another aspect, a 3D object formed by a 3D printing process, comprises: a first layered structure comprising a first set of successively solidified melt pools of a first material and a second layered structure comprising a second set of successively solidified melt pools of a second material, wherein the first layered structure is distinguishable from the second layered structure and is connected to the second layer structure, wherein the 3D object comprises an externally controllable device.

The first material and the second material may be substantially identical or different. Distinguishing the first layered structure from the second layered structure may be by comparing the first successively solidified melt pools of the first layered structure, to the second successively solidified melt pools of the second layered structure. Connected can be by interconnecting and/or adhering. The interconnecting can comprise physically interconnecting. The adhering can comprise chemically adhering. The chemically adhering may be connected though a chemical bond comprising covalent, hydrogen, polar, non-polar, ionic bonds, or any combination thereof. The adhering can comprise welding or laminating. The connected can comprise a third material. The externally controllable device can be embedded within the 3D object. The externally controllable device may alter one or more metrological properties of the 3D object. The externally controllable device may alter one or more radiative properties of the 3D object. The externally controllable device may alter a temperature, hydroscopic, conduction properties of the 3D object, or any combination thereof. The externally controllable device may comprise a sensor and/or an energy radiator. The at least a portion of the externally controllable device can be at a surface of the 3D object. The externally controllable device can be disposed below an outer surface of the 3D object. The externally controllable device can be disposed within the 3D object. The externally controllable device can be visible from outer surface of the 3D object. At least a portion of the externally controllable device can form a portion of the outer surface of the 3D object.

In another aspect, a 3D object formed by a 3D printing process comprises: a layered structure comprising successive solidified melt pools of a material, which successive solidified melt pools are arranged in repeating cavity walls having a pitch that is at most about 25 micrometers.

The cavity walls may comprise at least one space filling polygon. The cavity walls may comprise a cavity interior that comprises a gas. The cavity walls may comprise a cavity interior that comprises a powder material. The cavity walls may comprise a cavity interior that is devoid of a material melt pool. The material may comprise a powder material. The 3D object may comprise at least one of (i) a tensile strength of at least about 100 megapascals (MPa), (ii) a density that is less than or equal to about 90% of a bulk density of the material, and (iii) a strength-to-weight ratio of at least about 500 kN*m/kg. The 3D object may comprise at least two of (i) a tensile strength of at least about 100 megapascals (MPa), (ii) a density that is less than or equal to about 90% of a bulk density of the material, and (iii) a strength-to-weight ratio of at least about 500 kN*m/kg. The 3D object may comprise (i) a tensile strength of at least about 100 megapascals (MPa), (ii) a density that is less than or equal to about 90% of a bulk density of the material, and (iii) a strength-to-weight ratio of at least about 500 kN*m/kg. The material can be selected from the group consisting of an organic polymer, elemental metal, metal alloy, ceramic, and an allotrope of elemental carbon. The 3D object can be devoid of one or more surface features indicative of layer removal during or after the 3D printing process. The object may further comprise a layered structure comprising successive solidified melt pools of a material that are arranged as a bulk material. The object may further comprise an externally controllable device that is embedded within the 3D object. The externally controllable device may alter one or more metrological properties of the 3D object. The externally controllable device may alter one or more radiative properties of the 3D object. The externally controllable device may alter one or more of the group consisting of temperature, hydroscopic, and conduction properties of the 3D object. The externally controllable device may comprise a sensor or an energy radiator.

In another aspect, a system for additively generating at least one three-dimensional (3D) object comprises: a payout roll that retains a roll of a platform; an uptake roll that accepts the platform from the payout roll; a source of powder that supplies the powder to the platform as the platform moves from the payout roll to the uptake roll, wherein the powder comprises individual particles having a material selected from the group consisting of polymer, metal, ceramic and carbon; at least one energy source that provides energy to at least a portion of the powder as the platform moves from the payout roll to the uptake roll; and a control system that is in communication with the energy source, wherein the control system regulates the application of energy from the energy source to the powder along a pattern to additively generate the 3D object.

The uptake roll may continuously accept the platform from the payout roll during formation of the 3D object. The at least one energy source may comprise an n×m array of individual energy sources, wherein ‘n’ is greater than or equal to 2 and ‘m’ is greater than or equal to 1. In some instances, ‘m’ can be greater than or equal to 2. The individual energy sources are independently controllable. The powder can have a plurality of layers, wherein an individual layer of the plurality of layers has a thickness L1, wherein the powder has a total thickness L2, and wherein n=L2/L1. The n×m array of individual energy sources can include at least a first energy source and a second energy source, wherein the first energy source and the second energy source are oriented longitudinally with respect to a direction of movement of the platform. The n×m array of individual energy sources can include at least a first energy source and a second energy source, wherein the first energy source and the second energy source are oriented laterally with respect to a direction of movement of the platform. The system may further comprise a chamber between the payout roll and the uptake roll, wherein the platform is moved through the chamber during formation of the 3D object. The chamber can be a vacuum chamber. The chamber can be at a pressure that is less than about 10⁻⁶ Torr. The chamber can provide an inert gaseous environment. The system may further comprise an additional energy source that provides energy to the powder independently of the at least one energy source. The pattern can be a vector pattern. The pattern can be a raster pattern. The system may further comprise a lens that is in optical communication with the at least one energy source. The lens may direct energy from the at least one energy source to the powder. The at least one energy source can comprise a plurality of energy sources. The lens may be a single common lens that is in optical communication with the plurality of energy sources. The system may further comprise a scanning member that directs energy from the at least one energy source to the powder along the pattern. The scanning member can be a piezoelectric device, galvanometer, gimbal, X-Y stage, or a combination thereof. The at least one energy source can provide energy using at least one energy beam that is selected from the group consisting of an electromagnetic beam, electron beam, microwave beam and plasma beam. The energy beam can be a laser beam or a microwave beam. The control system can direct the at least one energy source to supply energy to the powder in pulses. The pulses may have a dwell time from about 0.1 microseconds (μsec) to about 10000 μsec per each individual energy source. The dwell time can be from about 1 μsec to about 10 μsec. The energy beam may have a spot size on an exposed surface of the powder from about 0.3 microns (μm) to 100 μm. The fundamental length scale of the spot size of the energy beam on the exposed surface of the powder is from about 0.3 μm to about 2 μm, from about 2 μm to about 5 μm, from about 5 μm to about 20 μm, or from about 20 μm to about 50 μm. The at least one energy sources can be applied at a power from about 0.5 watts to about 10000 watts. The power can be from about 1 watt to about 10 watts. One or both of the payout roll and the uptake roll can be included in a chamber.

In another aspect, a method for forming at least one 3D object comprises: (a) initiating the movement of a platform from a payout roll to an uptake roll; (b) supplying powder to the platform as the platform moves from the payout roll to the uptake roll, wherein the powder comprises individual particles having a material selected from the group consisting of polymer, metal, ceramic and carbon; and (c) additively generating the at least one 3D object by directing energy from at least one energy source to the powder as the platform moves from the payout roll to the uptake roll, wherein the energy is directed to the powder along a pattern that corresponds to the 3D object.

The pattern can correspond to a model design of the at least one 3D object. The individual particles can be formed of a metal, metal alloy, graphite, or polymeric material. The energy can be directed to the powder along an energy beam that is selected from the group consisting of an electromagnetic beam, electron beam and plasma beam. The additively generating can comprise directing the energy beam to the powder along a vector pattern. The additively generating can comprise directing the energy beam to the powder along a raster pattern. The additively generating can comprise heating the powder using the energy that is directed from the at least one energy source. The additively generating can comprise melting and cooling the powder. The additively generating can comprise successively melting and cooling the powder. The additively generating the at least one 3D object can comprise generating a plurality of 3D objects. The 3D objects can be distributed in a space filling pattern (e.g., honeycomb pattern). The 3D objects can be scaffolds in a lattice pattern. The lattice can be a diamond, tetragonal lattice, or cubic lattice. The 3D objects can be fibers. The 3D objects can be interconnected.

In another aspect, a material comprises: a sheet formed of a first material selected from the group consisting of polymer, metal, ceramic and carbon, wherein the platform has a first thickness (T1); and a plurality of 3D objects adjacent to the sheet, wherein the 3D objects are formed of a second material selected from the group consisting of polymer, metal, ceramic and carbon, and wherein the plurality of 3D objects have a second thickness (T2)≧T1, wherein the 3D objects are micro-scaffold features that are spaced apart by about 25 micrometers (microns) or less, wherein the 3D objects are part of an array that extends along the sheet at a longitudinal dimension that is greater than 1 meter. The layer can have a density that is less than or equal to about 50% of a bulk density of the second material. In some instances, T2≧3*T1. In some instances, T2≧10*T1. In some instances, at least about 30% of a volume of the layer is void space. The first material and second material can be different materials. The first material and second material can be substantially the same material (e.g., in chemical formula, metallurgical, and/or crystal structure). The 3D objects can be oriented at an angle that is less than 90° with respect to a plane of the platform. In some instances, T1 is less than or equal to about 5 millimeters. The platform and layer have a total thickness (T3) that can be at most about 5 mm. Sometimes, T1+T2=T3. The individual 3D objects have a wall or feature thickness that is at most about 1 mm. The 3D objects can be distributed in a space filling pattern (e.g., honeycomb pattern). The 3D objects can be scaffolds in a lattice pattern. The lattice can be a diamond, tetragonal, or cubic lattice. The sheet can be a bundle of fibers, a mesh or a net. The 3D objects can be fibers. The 3D objects can be interconnected.

In another aspect, a method for generating 3D objects comprises: (a) directing a platform from a payout roll to an uptake roll, wherein the platform is formed of a first material selected from the group consisting of polymer, metal, ceramic and carbon, wherein the platform has a first thickness (T1); and (b) additively generating the 3D objects adjacent to the platform, wherein the 3D objects are formed of a second material selected from the group consisting of polymer, metal, ceramic and carbon, and wherein the 3D objects have a second thickness (T2)≧T1.

In another aspect, a method for forming an array of 3D objects comprises: (a) providing one or more layers of powder adjacent to a platform, wherein the powder comprises individual particles having a material selected from the group consisting of polymer, metal, ceramic and carbon; and (b) from the one or more layers, additively generating the array of 3D objects with micro-scaffold features that are spaced apart by about 25 micrometers (microns) or less, wherein the array extends along the platform at a longitudinal dimension that is greater than 1 meter.

In another aspect, a system for forming 3D objects comprises: a sheet formed of a first material selected from the group consisting of polymer, metal, ceramic and carbon, wherein the sheet has a first thickness (T1); a powder having a plurality of layers of particles formed of a second material selected from the group consisting of polymer, metal, ceramic and carbon, wherein an individual layer of the plurality of layers has a thickness L1 and the powder has a total thickness L2>L1; and a plurality of energy sources in an n×m array, wherein individual energy sources of the array provide energy to at least a portion of the powder to additively generate 3D objects from the powder, wherein ‘m’ is greater than or equal to 1 and ‘n’ is greater than equal to L2/L1.

In another aspect, a method for forming a 3D object comprises: (a) providing one or more layers of powder adjacent to a platform, wherein the powder comprises individual particles having a material selected from the group consisting of polymer, metal, ceramic and carbon; and (b) from the one or more layers, additively generating at least a portion of the 3D object with small-scaffold features that are spaced apart by about 25 micrometers (microns) or less, wherein the 3D object has a macroscopic dimension that is less than or equal to about 10 millimeter.

The macroscopic dimension can be greater than spacing between the small-scaffold features. The additively generating may comprise melting the powder. The method can further comprise additively generating an enclosure that encloses at least a portion of the small-scaffold features. The additively generating can comprise additively generating the small-scaffold features. The individual particles can be formed of a metal or metal alloy. The individual particles can be formed of graphite. The individual particles can be formed of a polymeric material. The small-scaffold features can be spaced apart by about 10 microns or less. The small-scaffold features can be spaced apart by about 1 micron or less. The macroscopic dimension can be less than or equal to 3 mm. The macroscopic dimension can be less than or equal to 1 mm. The 3D object can have a tensile strength of at least about 25 megapascals (MPa). The can be tensile strength can be at least about 50 MPa. The tensile strength can be at least about 100 MPa. The tensile strength can be at least about 1000 MPa. The tensile strength can be at least about 5000 MPa. The small-scaffold can be part of an array that comprises periodic domains. The array can comprise one or more non-periodic domains. The small-scaffold features can be part of an array comprising an ordered lattice. The at least a portion of the small-scaffold features can be interconnected. The 3D object can have a density that is less than or equal to about 90%, 80%, 70%, 60%, or 50% of the bulk density. The 3D object can have strength-to-weight ratio of at least about 5 kN*m/kg, 100 kN*m/kg, 500 kN*m/kg, 1000 kN*m/kg, 10000 kN*m/kg, or 30000 kN*m/kg. The additively generating step can be performed upon the application of an energy beam to the one or more layers. The energy beam can be an electromagnetic beam, electron beam, or plasma beam. The energy source can be an electromagnetic beam that is a laser beam or a microwave beam. The energy source can be a laser beam from a single head laser. The energy source can be a laser beam from a multi-head laser. The multi-head laser can have an n×m array of laser diodes, wherein ‘n’ is greater than or equal to 2 and ‘m’ is greater than or equal to 1. Sometimes, ‘m’ is greater than or equal to 2. The additively generating step can comprise directing the energy beam to the one or more layers along a vector pattern. The additively generating step can comprise directing the energy beam to the one or more layers along a raster pattern. The small-scaffold features can be formed by supplying the energy beam in pulses. The energy beam can be pulsed at a dwell time from about 0.5 microseconds to 100 microseconds. The dwell time can be from about 1 microsecond to 10 microseconds. The energy beam can have a spot diameter on the one or more layers from 0.3 micrometers to 100 micrometers. The diameter can be from 2 micrometers to 50 micrometers. The energy beam can be applied at a power from 0.5 watts to 100 watts. The power can be from about 1 watt to 10 watts. The 3D object can have a gaseous space density of at least 10%, 30%, 50%, 80%, or 90%. The method may further comprise repeating (a) and (b) one or more times to generate the 3D object.

In another aspect, a method for forming a 3D object comprises: (a) providing one or more layers of powder adjacent to a platform, wherein the powder comprises individual particles having a material selected from the group consisting of polymer, metal, ceramic and carbon; and (b) heating at least a portion of the one or more layers to generate at least a portion of the 3D object with small-scaffold features that are spaced apart by about 25 micrometers (microns) or less, wherein the 3D object has a macroscopic dimension that is less than or equal to about 10 millimeter. The heating can comprise melting the powder.

In another aspect, a method for forming a 3D object comprises additively generating the 3D object from a powder of a material selected from the group consisting of polymer, metal, ceramic and carbon, wherein the 3D object as additively generated has small-scaffold features that have a pitch that is less than or equal to about 25 micrometers and at least one of (i) a tensile strength of at least about 100 megapascals (MPa), (ii) a density that is less than or equal to about 90% of a bulk density of the material, and (iii) a strength-to-weight ratio of at least about 500 kN*m/kg. The 3D object as additively generated can have at least two of (i)-(iii). The 3D object as additively generated has at all of (i)-(iii).

In another aspect, a method for forming a 3D object comprises: (a) providing one or more layers of powder adjacent to a platform, wherein the powder comprises individual particles having a material selected from the group consisting of polymer, metal, ceramic and carbon; and (b) from the one or more layers, additively generating at least a portion of the 3D object with small-scaffold features that are spaced apart at a pitch that is less than or equal to 25 micrometers (microns) wherein the 3D object has a macroscopic dimension that is less than or equal to about 10 millimeter. The pitch can be at most about 5 micrometers (μm), 2 μm, or 1 μm. The macroscopic dimension is at most about 3 mm, 2 mm, 1 mm, 0.5 mm, 0.25 mm, or 0.1 mm. The individual small-scaffolds may have a thickness that is at most about 10 μM, or 5 μm.

In another aspect a system for additively generating a 3D object with small-scaffold features comprises: a platform that accepts a layer of a powder material; a source of the powder material that supplies the powder material to the platform; an (e.g., first) energy source that provides energy to at least a portion of the layer, wherein the energy source comprises an n×m array of individual energy sources, wherein ‘n’ is greater than or equal to 2 and ‘m’ is greater than or equal to 1; and a control system that is in communication with the energy source, wherein the control system regulates the application of energy from the energy source to the layer along a vector pattern to form the 3D with small-scaffold features, which small-scaffold features are spaced apart by about 25 micrometers (microns) or less.

The individual energy sources can be independently controllable. The system may further comprise a chamber containing the platform. The chamber can be a vacuum chamber. The chamber can be at a pressure that is less than about 10⁻⁶ Torr. The chamber can provide an inert gaseous environment. The system may further comprise an additional (e.g., second) energy source that provides energy independently of the (e.g., first) energy source. The energy source can be usable to generate the small-scaffold features and the additional energy source is usable to generate a perimeter of the 3D object. A scan direction of the vector pattern can be selected such that a projected distance between adjacent individual energy sources in the array along a scan direction is tunable to match a spacing between individual small-scaffold features. The array can be rotatable such that a projected distance between individual energy sources in the array along a scan direction is tunable to match a spacing between individual small-scaffold features. The system may further comprise at least one (e.g., a single) common lens that directs energy from the energy source to the layer. The system may further comprise a scanning member that directs energy from the energy source to the layer along the vector pattern. The scanning member can be a piezoelectric device, galavanometer, gimble, X-Y stage, or a combination thereof. The (e.g., first) energy source can provide energy through an electromagnetic beam, electron beam, microwave beam or plasma beam. The individual energy sources provide energy through an electromagnetic beam that is a laser beam or a microwave beam. In some instances, ‘m’ is at least 2. The control system may direct the individual energy sources to supply energy to the layer in pulses. The pulses can have a dwell time from about 0.5 microseconds (μsec) to about 100 μsec per each individual energy source. The dwell time can be from about 1 μsec to about 10 μsec. Each of the individual energy sources can have a spot size on the layer having a fundamental length scale from about 0.3 μm to about 100 μm. The spot size can have a fundamental length scale from about 0.3 μm to about 2 μm, from about 2 μm to about 5 μm, from about 5 μm to about 20 μm, or from about 20 μm to about 50 μm. Each of the individual energy sources can be applied at a power from about 0.5 watts to 100 watts. The power can be from about 1 watt to 10 watts.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure,” “Fig.” and “FIG.” herein), of which:

FIG. 1 schematically illustrates a vertical cross section of a three-dimensional (3D) printing system and its components;

FIG. 2 schematically illustrates various views of a 3D object;

FIG. 3 schematically illustrates a vertical cross section of a three-dimensional (3D) printing system and its components;

FIGS. 4A, 4B, 5A and 5B schematically illustrate various arrays of energy beams;

FIG. 6 schematically illustrates various paths;

FIG. 7 schematically illustrates various paths;

FIGS. 8A-8D schematically illustrates a horizontal view of various stages in the fabrication of a small-scaffold structure by an energy beam array;

FIGS. 9A and 9B schematically illustrate side views of various energy beams and lenses;

FIG. 10 schematically illustrate side views of various stages in the fabrication a small scaffold structure;

FIG. 11 schematically illustrates a computer control system that is programmed or otherwise configured to facilitate the formation of a 3D object;

FIGS. 12A and 12B illustrates various 3D object portions;

FIG. 13 schematically illustrates a side view of a roll-to-roll system for additively generating 3D objects;

FIG. 14 schematically illustrates a side view of a roll-to-roll system for additively generating 3D objects;

FIG. 15 schematically illustrates a side view of a roll-to-roll system for additively generating 3D objects; and

FIG. 16 schematically illustrates a side view of a 3D object in a material bed.

The Figures and components therein may not be drawn to scale.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a”, “an” and “the” are not intended to refer to only a singular entity, but include the general class of which a specific example may be used for illustration. The terminology herein is used to describe specific embodiments of the invention(s), but their usage does not delimit the invention(s). When ranges are mentioned, the ranges are meant to be inclusive, unless otherwise specified. For example, a range between value 1 and value 2 is meant to be inclusive and include value 1 and value 2. The inclusive range will span any value from about value 1 to about value 2.

The term “adjacent” or “adjacent to,” as used herein, includes ‘next to’, ‘adjoining’, ‘in contact with’, and ‘in proximity to.’

In an aspect disclosed herein are methods, systems and apparatuses for fabrication of a 3D object using roll-to-roll. A roll-to-roll apparatus can include a platform (e.g., a base) that is directed from a payout roll to an uptake roll. The apparatus may include at least one chamber between the payout roll and the uptake roll to additively generate an object adjacent to the platform as the platform moves from the payout roll to the uptake roll. The 3D object can be additively generated by providing a powder adjacent to the platform and supplying energy to the powder from one or more energy sources that are disposed along the platform longitudinally and/or laterally. Energy can be supplied to the powder along a pattern. The pattern can be a vector pattern or a raster pattern.

The platform may be a building platform. The platform may be a support platform. The platform may be a structure adjacent to which at least a portion of the 3D object is formed. The platform may be a plane. The platform may be a slab and/or strap of material. The platform may be flat and/or smooth. The platform may be non-flat and/or non-smooth. The platform may comprise a substrate, a base, or a bottom of an enclosure.

In some embodiments, the roll-to-roll apparatus, system and/or method comprises a stop and repeat step. In some embodiments, an array of energy beams is situated above the rolling one or more platform. The array of energy beams can comprise a first, second, third, fourth, fifth, sixth, or more energy beams. The energy beams may be individually regulated. Each of the energy beams may form a layer structure from the material (e.g., powder) disposed on the rolling platform. The platform(s) may move from the payout roll to the uptake roll. The moving platform may be slanted. The slanting may at an angle that is equal or less than the angle of repose of the powder material relative to the horizontal plane. The slanting may at an angle that is less than the angle at which the powder material begins to slump. The slanted platform may facilitate the formation of a powder bed with a slated bottom (e.g., that comprises the platform(s)). The moving platform(s) may move and stop sequentially. The moving platform(s) may stop at a station. The station may include an energy beam that transforms the pre-transformed (e.g., powder) material to a transformed material. After the transformation, a recoater may add another layer of material on the slanted powder bed. The platform will then continue to move such that the powder bed with the transformed material will progress to the next station, at which the top layer of powder material will be transformed to an additional layer of transformed material as part of the 3D object.

In another aspect the invention relates to fabrication of a 3D object with unique internal (controlled) structure. The unique (controlled) internal structure may comprise cavities and/or integration of one or more devices within the internal structure. The devices may include passive or active devices. The devices may include electronic devices. The devices may include Bluetooth® technology. The devices may include sensor, actuator, antenna (e.g., radio frequency identification (RFID)), magnet, energy harvesting device (e.g., solar cell), colors, radiation emitter, or energy generating device (e.g., batteries). The radiation emitters may emit radiation comprising radio, infrared, visible, ultraviolet, X-ray, or gamma radiation. The 3D object with unique internal (controlled) structure may include one or more material type (e.g., formula). The 3D object with unique internal (controlled) structure may be fabricated using roll-to-roll. For example, a first 3D object can be fabricated on a first rolling platform, and a second 3D object can be fabricated on a second rolling platform. The two rolling platforms can roll adjacent to each other such that the first and the second 3D object will come to close proximity. The first and the second 3D object can be connected (e.g., via welding, lamination, gluing, chemical bonding (e.g., covalent), sticking, or otherwise adhering to each other. The first and/or second 3D objects may comprise the one or more devices. The first and second 3D objects may be irreversibly or reversibly joined. The 3D object with the unique internal structure may be actuated (e.g., electrically, optically, and/or magnetically) The 3D object may be actuated (e.g., stimulated) to deform. The deformation may include contraction or expansion. The internal structure may be controlled. The control may comprise controlling (e.g., regulating) the porosity, temperature, conductivity, thickness, transparency, color, absorption, permeability, chemical, and/or physical characteristics of the 3D object. The devices may effectuate the control. The devices may respond to an external trigger (e.g., signal or other input). For example, the external trigger (e.g., signal) may be received by the device and cause it to alter the characteristic of the 3D object (e.g., heat up, contract, expand, change color, alter its conductivity, alter its magnetic field, alter its electric field, alter the amount of radiation that is emitted from the 3D object, alter its water absorption properties, alter its internal pore size(s)).

The internal structure may have increased or decreased strength, toughness, heat conduction, environmental resistant, and/or flexibility, as compared to a respective material that is devoid of the internal structure. The 3D object may be elongated. The 3D object may be substantially flat.

The array of energy beams may comprise of two or more energy beams (e.g., emerging from two or more energy sources respectively) that are separated by a distant “d” (e.g., separated by a gap). The gap may be at least about 1.5, 2, 3, 4, 5, 6, 7, 8, 9, 10, 15, 20, 25, 30, 35, 40, 50, 60, 70, 80, or 90 times the fundamental length scale of the energy beam (e.g., average FLS). The fundamental length scale is herein abbreviated as “FLS.” FLS refers to diameter, spherical equivalent diameter, length, width, or diameter of a bounding sphere, and may represent the average FLS in a collection of individual FLSs. The gap may be at most about 1.5, 2, 3, 4, 5, 6, 7, 8, 9, 10, 15, 20, 25, 30, 35, 40, 50, 60, 70, 80, or 90 times the FLS (e.g. average FLS) of the energy beam. The gap may be the FLS multiplier of the energy beam by any value between the afore-mentioned FLS multiplier values (e.g., from at least about 1.5 to at least about 90, from at least about 1.5 to at least about 3, from at least about 3 to at least about 30, from at least about 30 to at least about 70, or from at least about 70 to at least about 90). The FLS of the energy beam may be measured at the exposed surface of the material bed or at the exit of the (respective) energy source(s). The FLS of the energy beam may be at least about 0.5 micrometers (μm), 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, or 100 μm. The FLS of the energy beam may be at most about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, or 100 μm. The FLS of the energy beam may be any value between the aforementioned values (e.g., from about 0.5 μm to about 90 μm, from about 0.5 μm, to about 10 μm, from about 10 μm to about 50 μm, or from about 50 μm to about 100 μm).

In some embodiments, each energy beam is generated by a respective energy source. The array of energy beams may comprise an array of energy sources. The array of energy sources may be situated on or in a platform. In some embodiments, at least two energy beams in the energy beam array (e.g., all the energy beams) may be generated by a common energy source. The energy beams may be split from the energy source into multiple energy beams using an optical system (e.g., as disclosed herein). The optical system may comprise a lens or mirror.

In another aspect disclosed herein is an array of energy beams (e.g., array of energy sources). The array of energy beam may fabricate various 3D object parts. For example, the array of energy beam may fabricate an internal structure of a 3D objects. The array of energy beam may fabricate a lattice. The lattice may comprise hollow cavities (e.g., compartments). The lattice may comprise a scaffold (e.g., formed of the cavity walls). The array of energy beams may form a brush (e.g., a comb, or rake) of energy beams. The array may be one or two-dimensional. The array may move in space and be directed into a material bed. The material bed may comprise powder particles. The material bed may be a powder bed. The one or more energy beams may interact with the material within the material bed to transform at least a portion thereof to a transformed material that subsequently hardens into a hardened material. In some instances, the energy beam may transform the material within the material bed to a hardened material (e.g., directly). The energy beam array may travel in space. For example, the energy beam array may travel vertically, horizontally, or in an angle (e.g., planar angle, or compound angle). The energy beam array may travel in a vector and/or in a raster fashion. The energy beam array may travel in a vector pattern. In some embodiments, the energy beam array may not travel in a raster pattern. In some embodiments, the energy beam array may travel in a pattern that differs from a raster pattern. The energy beam array may rotate. The rotation may comprise rotation along an axis that is substantially perpendicular to the platform, the exposed surface of the powder bed, and/or normal to the direction of the gravitational force. The energy beam array may tilt in an angle between 0 and 90 degrees with respect to the platform, the exposed surface of the powder bed, and/or normal to the direction of the gravitational force. The energy beam array may travel in a non-raster fashion. The energy beam array may travel along a straight or winding path. The path may be a directional path. The path may be a vectorial path. The path may include a curvature. The path may include an angle. The angle may be obtuse, acute, or a straight angle. The winding path may be a two dimensional path. The straight or winding path may be a path along the exposed surface of the material bed.

The energy beam may be a laser beam. The laser may be a diode laser. The laser may be a semiconductor laser. The laser may comprise an epitaxial structure. The laser may comprise a p-i-n, or a p-n diode junction. The laser may comprise quantum wells. The semiconductor may comprise gallium arsenide, indium phosphide, gallium antimonide, or gallium nitride. The laser may be a double hetero-structure, quantum well, quantum cascade, separate confinement heterostructure, distributed Bragg reflector, distributed feedback, vertical-cavity surface-emitting, vertical-external-cavity surface-emitting, external-cavity diode, or any combination thereof.

The laser may comprise a fiber laser. The laser may be a solid state laser. The solid state laser may comprise yttrium orthovanadate (Nd:YVO4), yttrium lithium fluoride (Nd:YLF), or yttrium aluminum garnet (Nd:YAG). The laser may comprise Erbium and/or Ytterbium. The laser may comprise a double clad fiber. The laser may be a gas, photonic crystal, dye, semiconductor, or free-electron laser. The laser may be a multimode or single mode laser (e.g., diode laser). The energy beams may be individually addressable. The energy beam may be a diffraction-limited beam. The energy beam may have a specific dimension (e.g., FLS such as a cross section) by which it leaves the energy source (e.g., laser). The energy beam may diverge at an angle that is a minimum possible divergence for the dimension by which the energy beam leaves the energy source. The energy beam may diverge to a greater dimension (e.g., cross-section) as compared to the opening of the energy source. The energy beam may propagate in single mode. The energy beam may propagate in multi mode. The energy beam may be focused. Each of the energy beams in the array may be individually regulated (e.g., manually, automatically, and/or by a controller). The regulation may include regulation of power, focus or defocus, and angle. Focusing or defocusing includes alteration of the FLS of the energy beam (e.g., as measured at the exposed surface of the material bed). Altering the FLS of the cross section measured at the exposed surface of the material bed may be by at least about 0.001, 0.005, 0.01, 0.05, 0.1, 0.5, 1.5, 2, 5, 10, 20, 30, 40, 50, 60, 70, 80, 90, 100, or 150 times the unaltered FLS of the energy beam at the exposed surface of the material bed. Altering the FLS of the cross section measured at the exposed surface of the material bed may be by at most about 0.005, 0.01, 0.05, 0.1, 0.5, 1.5, 2, 5, 10, 20, 30, 40, 50, 60, 70, 80, 90, 100, or 150 times the unaltered FLS of the energy beam at the exposed surface of the material bed. Altering the FLS of the cross section measured at the exposed surface of the material bed may be by any value between the aforementioned values (e.g., from about 0.001 to about 150, from about 0.001 to about 10, from about 10 to about 50, from about 50 to about 100, or from about 100 to about 150 times the unaltered FLS of the energy beam at the exposed surface of the material bed).

The scaffold may comprise a periodic structure. The periodicity (e.g., line spacing) and/or line width of the small-scaffold structure may be in specific ranges, which is enabled by the energy beam array (e.g., correspond to the spading of the array). The material may comprise elemental metal, metal alloy, ceramic, glass, or an allotrope of elemental carbon. The array of energy beam may facilitate the generation of fine lines, threads, or lattice walls. For example, the energy beam array may facilitate the fabrication of a material (e.g., carbon fiber) lattice without requiring a second material (e.g., a composite or a filler). For example, the energy beam array may facilitate the fabrication of a lattice comprised of single crystals, and/or single crystal fibers. The array of energy beam may form a small scaffold structure from at least a portion of the material in the material bed. The small scaffold structure can be nano, micro, or meso scale scaffold structure.

The platform that comprises the energy beam array may be tilted by an acute angle Zeta. Zeta may be at least about 1°, 5°, 10°, 15°, 20°, 30°, 40°, 50°, 60°, 70°, 80°, or 85° with respect to the average exposed surface of the material bed, platform, or a plane normal to the direction of the gravitational force. Zeta that may be at most about 1°, 5°, 10°, 15°, 20°, 30°, 40°, 50°, 60°, 70°, 80°, or 85° with respect to the average exposed surface of the material bed, platform, or a plane normal to the direction of the gravitational force. Zeta may have any value between the afore-mentioned values (e.g., from about 1° to about 90°, from about 1° to about 45°, from about 45° to about 90°, or from about 20° to about 70° with respect to the average exposed surface of the material bed, platform, or a plane normal to the direction of the gravitational force). The tilt angle may cause at least partial overlap, or bordering of at least two energy beam cross-sections (e.g., at the exposed surface of the material bed. The tilt angle may preserve the separation of at least two energy beam cross-sections (e.g., at the exposed surface of the material bed. The separation may include separation with diminished distance between the at least two energy beam cross-sections. Tilting may reduce the gap between the at least two energy beam cross sections. In some instances, reducing the gap includes causing the at least two energy beam cross sections to at least partially overlap, or touch (e.g., border each other). In some instances, reducing the gap may preserve the separation for the at least two energy beam cross sections.

In some embodiments, the planar 3D object is a portion of a larger 3D object that comprises one or more planar 3D objects with the unique properties. The unique properties can be toughness and lightness. The unique properties can comprise hollow cavities within the planar 3D object.

The term “small-scaffold,” as used herein, generally refers to a material with individual scaffolds that are spaced apart from one another. Scaffolds may be features as part of a 3D object. Scaffolds can be fibers, which can interlock with other fibers of the small-scaffold. Scaffolds can have lengths that are larger than their average widths or diameters. The scaffolds can be part of a mesh of interconnected fibers that support one another. In some cases, a small-scaffold is a porous structure (e.g., comprising one or more cavities). The pores can have a FLS that are at most about 5 mm, 1 mm, 0.5 mm, 100 μm, 50 μm, 40 μm, 30 μm, 25 μm, 20 μm, 15 μm, 10 μm, 5 μm, 1 μm, 500 nm, 400 nm, 300 nm, 200 nm, 100 nm, or 50 nm. The pores can have a FLS that is at least about 5 mm, 1 mm, 0.5 mm, 100 μm, 50 μm, 40 μm, 30 μm, 25 μm, 20 μm, 15 μm, 10 μm, 5 μm, 1 μm, 500 nm, 400 nm, 300 nm, 200 nm, 100 nm, or 50 nm. The pores can have a FLS that is of any value between the afore-mentioned values (e.g., from about 50 nm to about 1 mm, from about 50 nm to about 1 μm, from about 1 μm, to about 100 μm, or from about 100 μm, to about 5 mm). Individual scaffolds can be solid features that can interconnect to form a lattice with pores (e.g., cavities). The cavities may be filled with one or more gasses. The cavities may be filled with one or more reinforcing materials. The cavities may be filled with pre-transformed material (e.g., powder). The distance can characterize a pitch along a given dimension (e.g., x-axis). The pitch may have a value equal to the FLS values of the pores mentioned herein. In some examples, a small-scaffold includes individual cavities that are spaced apart by a first distance (e.g., first pitch distance) along a first dimension (e.g., x-axis), spaced apart by a second distance (e.g., second pitch distance) along a second dimension (e.g., y-axis), spaced apart by a third distance (e.g., third pitch distance) along a third dimension (e.g., z-axis), or any combination thereof. The pitch along the z axis (e.g., vertical dimension) may be related to the height of the layer (e.g., powder layer). The first distance can be the same or different than the second distance, and or third distance. In some examples, a scaffold may includes two or more small scaffolds that are spaced apart by a first distance along a first dimension (e.g., x-axis), spaced apart by a second distance along a second dimension (e.g., y-axis), spaced apart by a third distance along a third dimension (e.g., z-axis), or any combination thereof. The first distance can be the same or different than the second distance, and or third distance. In some cases, the distance between the two or more small scaffolds can be from 2 to 100 times the FLS of an individual small scaffold.

In some embodiments, the small scaffold feature may be surrounded by a rim. The rim may be complete or partial. The rim may comprise one or more gaps. The scaffold may be fabricated by focused or non-focused energy beams in the array. The scaffold may be fabricated by at least two energy beams within the array that do not overlap (e.g., at the exposed surface of the material bed). The rim may be fabricated by at least two non-focused or defocused energy beams within the array. The rim may be fabricated by at least two energy beams that have a cross-sections that at least partially overlap (e.g., at the exposed surface of the material bed). The at least partial overlapping of the energy beams of the energy beam array may be achieved by defocusing the energy beams, tilting the energy array platform that will cause at least a partial overlap of two or more energy beams, or any combination thereof. The overlap may comprise an overlap of at least about 1%, 5%, 10%, 20%, 30%, 40%, 50%, 60%, 70%, 80%, 90%, or 95% of the footprint area (e.g., average footprint area) of the energy beam on the exposes surface of the energy source. The overlap may comprise an overlap of at most about 1%, 5%, 10%, 20%, 30%, 40%, 50%, 60%, 70%, 80%, 90%, or 95% of the footprint area (e.g., average footprint area) of the energy beam on the exposes surface of the energy source. The overlap may comprise an overlap of any value between the aforementioned values (e.g., from about 1% to about 95%, from about 1% to about 50%, or from about 50% to about 95%, wherein the percentages refer to the percentage of the footprint area (e.g., average footprint area) of the energy beam on the exposed surface of the material bed).

The rim may be fabricated by a second energy beam. The second energy beam may not be a part of the energy beam array. The second energy beam may be independent from the energy beam array. The scaffold may be adjacent to at least a portion of the 3D object that does not comprise a small scaffold structure. The scaffold may be adjacent to at least one portion of the 3D object that may have a substantially continuous structure (e.g., without small cavities). The adjacent portion of the 3D object that does not comprise a small scaffold structure may contact the small scaffold structure directly or indirectly. The adjacent portion of the 3D object that does not comprise a small scaffold structure may be a dense portion of the 3D object (e.g., more dense that the small scaffold structure). The adjacent portion of the 3D object that does not comprise a small scaffold structure may be fabricated in a manner akin to the fabrication of the rim.

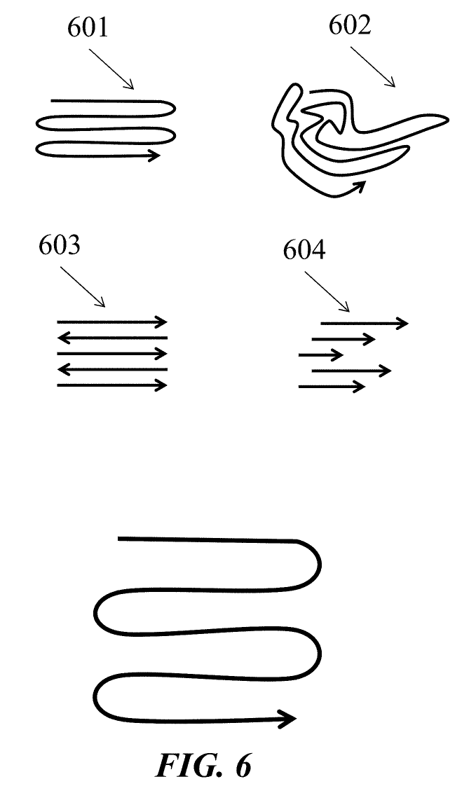

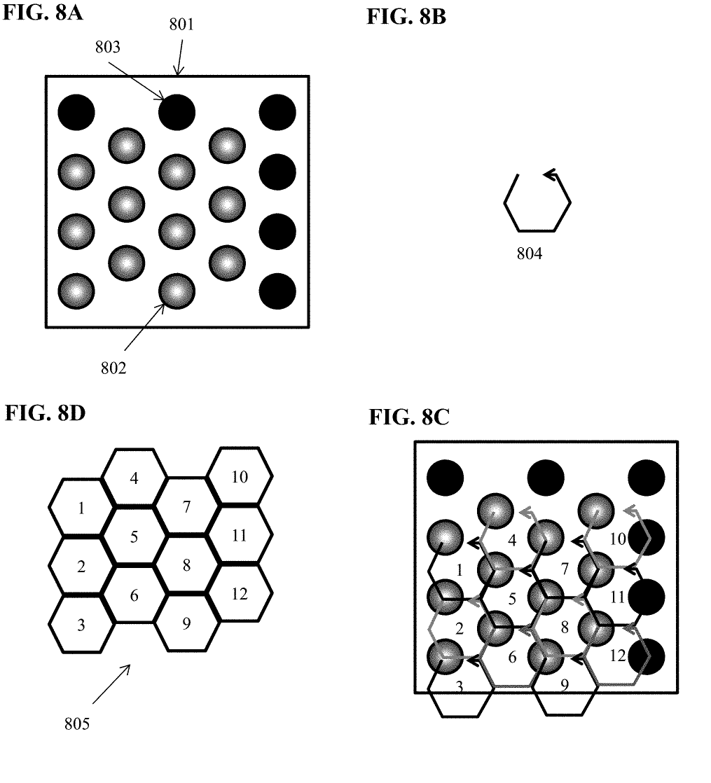

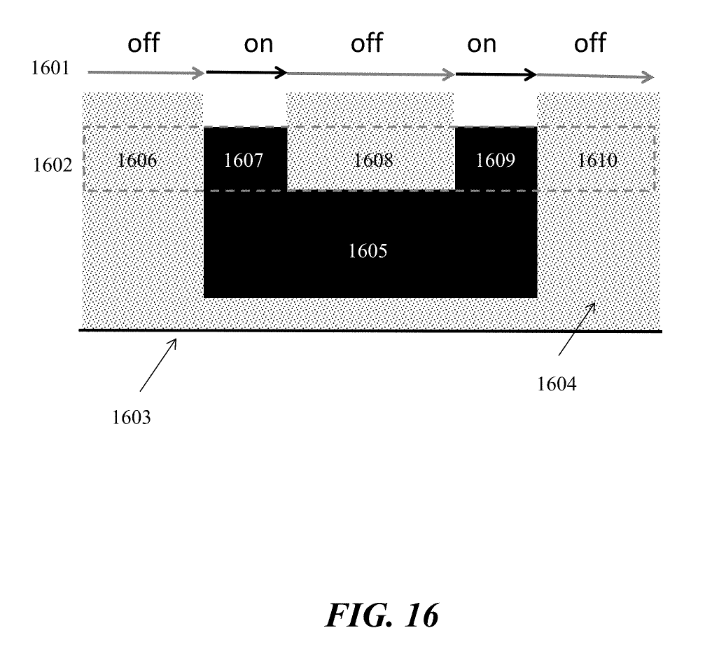

In some embodiments the path traveled by the energy beam array follows one or more vectorial paths (e.g., FIG. 6). In some embodiments, the vectorial path correlates to one repeating unit of the small scaffold feature. FIGS. 8A-8D show examples of stages in the formation of a small scaffold feature 805, viewed from the bottom up horizontally. The array of energy beams may comprise energy beams (e.g., each generated from an individual energy source respectively) situated on a platform (e.g., 801). The energy beam in the array may be on (e.g., 802), or off (e.g., 803). The intensity of the energy beams may be modulated depending on the small scaffold feature portion printed. FIG. 16 shows an example of a vertical cross section of a portion of a 3D object. The portion can be a cell of a small-scaffold feature. The energy beam may be modulated as it passes along the material bed to generate a layer of the 3D object. The modulation may form present, dense, light, thick, thin, or absent features. For example, when an energy beam travels along the path in FIG. 16, 1601, it can be turned on or off. When the energy beam is turned off, the material in the material bed 1604 does not transform (e.g., 1606, 1608, and 1610). In the example in FIG. 16, when the energy beam turns on, the energy beam transforms the material in the material bed to generate a portion of the 3D object (e.g., portions 1607 and 1609). In some embodiments, multiple repeating cells (e.g., cavity walls) of the small-scaffold structure may be printed simultaneously. The cell can be a unit cell (e.g., smallest repeating cell), or may comprise multiple unit cells. In some instances, the movement of the energy beam array (e.g., as a whole) may correspond to the cell. FIG. 8B shows an example of the path of the energy beam array FIG. 8A, 801 that forms the small scaffold structure FIG. 8D, 805 comprising 12 unit cells. FIG. 8C shows an example of the energy beam array following the energy array path FIG. 8B, 804. FIG. 8C shows the individual paths that each energy beam in the array follows. Since the energy beam array comprises multiple energy beams that can operate simultaneously, when the energy beam array follows a path, the energy beams within the array follow substantially the same path at their designated locations of the individual energy beams. As the energy beams follow the path, they may transform the (pre-transformed) material in the material bed into a transformed material. In some embodiments (e.g., depending on the material), the transformed material may be the hardened material (e.g., as part of the 3D object). In some embodiments, the transformed material may subsequently harden into a hardened material to form at least a portion of the 3D object.

The term “3D printing” (also “3D printing”), as used herein, generally refers to a process for forming a 3D object. Examples of 3D printing include additive printing, subtractive printing, or a combination thereof.

The present disclosure provides 3D printing apparatuses, systems, and methods for forming a 3D object. For example, a 3D object may be formed by sequential addition of material or joining of material to form a structure, in a controlled manner (e.g., under manual or automated control). In a 3D printing process, the deposited material may be fused, sintered, melted, bound or otherwise connected to form at least a portion of the desired object (e.g., 3D object). Fusing, binding or otherwise connecting the material is collectively referred to herein as “transforming” the material. Fusing the material may refer to melting, smelting, or sintering the material. A liquefied state refers to a state in which at least a portion of a transformed material is in a liquid state. A liquidus state refers to a state in which an entire transformed material is in a liquid state. The apparatuses, methods, and systems provided herein are not limited to the generation of a single 3D object, but are may utilized to generate one or more 3D objects simultaneously (e.g., in parallel) or separately (e.g., sequentially).

Examples of 3D printing include additive printing (e.g., layer by layer printing, additive manufacturing), subtractive printing, or a combination thereof. 3D printing methodologies can comprise powder bed printing, extrusion, wire, granular, laminated, light polymerization, or power bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing (e.g., powder 3D printing) can comprise direct metal laser sintering (DMLS), electron beam melting (EBM), selective laser melting (SLM), selective heat sintering (SHS), or selective laser sintering (SLS). Power bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). The 3D printing methodology may include polyjet, stereolithography, extrusion, or powder bed based methodology.

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

The methods described herein may further comprise repeating the steps of material deposition and material transformation steps to produce a 3D object (or a portion thereof) by at least one additive manufacturing method. For example, the methods described herein may further comprise repeating the steps of depositing a layer of material (e.g., powder) and transforming at least a portion of the material to connect to the previously formed 3D object portion (i.e., repeating the printing cycle), thus forming at least a portion of a 3D object. The transforming step may comprise utilizing an energy beam to transform the material. In some instances the energy beam is utilized to transform at least a portion of the material (e.g., powder), for example utilizing any of the methods described herein.

The 3D object disclosed herein can be used in various applications in industries comprising aerospace (e.g., aerospace super alloys), jet engine, missile, automotive, marine, locomotive, satellite, defense, oil & gas, energy generation, semiconductor, fashion, military, construction, agriculture, printing, painting, catalysis, or medical. For example, the small scaffold feature may be used as a catalyst (e.g., when at the small scaffold structure is at least partially accessible to a fluid (e.g., liquid or gas)). The catalyst may comprise a material disclosed herein (e.g., platinum or palladium). The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The 3D objects can be used in various applications comprising implants, or prosthetics. The 3D objects can be used in various applications used in the fields comprising human surgery, veterinary surgery, implants (e.g., dental), or prosthetics.

The FLS of the printed 3D object or a portion thereof can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object or a portion thereof can be at most about 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. The FLS of the printed 3D object, or a portion thereof, can any value between the aforementioned values (e.g., from about 50 μm to about 1000 m, from about 500 μm to about 100 m, from about 50 μm to about 50 cm, or from about 50 cm to about 1000 m). In some cases the FLS of the printed 3D object or a portion thereof may be in between any of the afore-mentioned FLSs. The portion of the 3D object may be a heated portion or disposed portion (e.g., tile). In some instances, the small-scaffold may have a FLS that has a value equal to the values of the FLS of the printed 3D object mentioned herein.

Some 3D printing processes may include deposition of the material (e.g., powder) within an enclosure. The deposited material may form a material bed. The material bed may be supported by a platform. The platform may include a base, a substrate, or both. The platform may be stationary or moving. The platform may be a roll. Multiple platforms can be connected to form one integrated platform. The integrated platform may form a roll. The integrated platform may be included in a roll. The roll may comprise a single platform. The enclosure may comprise a chamber. The chamber may be a sealable chamber. The enclosure and/or its constituents (e.g., chamber) may comprise openings. The enclosure and/or its constituents may comprise windows.

The 3D object may be formed within the material bed. The deposited material within the enclosure can be a liquid material or a solid material. The deposited material within the enclosure can be in the form of a powder, wires, sheets, or droplets. The material may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball or a carbon nanotube. The ceramic material may comprise cement. The ceramic material may comprise alumina, zirconia, carbide (e.g., silicon carbide, or tungsten carbide), or nitride (e.g., boron nitride, or aluminum nitride). The ceramic material may include a high performance material (HPM). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material (e.g., polymer) may comprise epoxy. The organic material may comprise carbon and sulfur atoms. In some embodiments, the material may exclude an organic material. The material may comprise a solid or a liquid. In some embodiments, the material may comprise a silicon-based material, for example, silicon based polymer or a resin. The material may comprise an organosilicon-based material. The material may comprise silicon and hydrogen atoms. The material may comprise silicon and carbon atoms. In some embodiments, the material may exclude a silicon-based material. The solid material may comprise powder material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. In some instances, a reinforcing material is absent. The material can comprise powder (e.g., granular material) or wires. The bound material can comprise chemical bonding. Chemical bonding can comprise covalent bonding. The material may be pulverous. The material may comprise elemental metal, metal alloy, ceramic or elemental carbon. The printed 3D object can be made of a single material or multiple materials. Sometimes one portion of the 3D object may comprise one material, and another portion may comprise a second material different from the first material. The powder material may be a single material (e.g., a single alloy or a single elemental metal). The powder material may comprise one or more materials. For example, the powder material may comprise two alloys, an alloy and an elemental metal, an alloy and a ceramic, or an alloy and an elemental carbon. The powder material may comprise an alloy and alloying elements (e.g., for inoculation). The material may comprise blends of material types. The material may comprise blends with elemental metal or with metal alloy. The material may comprise blends without elemental metal or with metal alloy. The material may comprise a stainless steel. The material may comprise a titanium alloy, aluminum alloy or nickel alloy.

In some cases, a layer of the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramics, an alloy and an elemental carbon). In certain embodiments each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than member of a type of material.

In some examples the material, the base, or both the powder and the base comprise a material wherein its constituents (e.g., atoms) readily lose their outer shell electrons, resulting in a free flowing cloud of electrons within their otherwise solid arrangement. In some examples the powder, the base, or both the powder and the base comprise a material characterized in having high electrical conductivity, low electrical resistivity, high thermal conductivity, or high density. The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times.” The high electrical conductivity can be between any of the aforementioned electrical conductivity values (e.g., from about 1*10⁵ S/m to about 1*10⁸ S/m). The thermal conductivity, electrical resistivity, electrical conductivity, and/or density can be measured at ambient temperature (e.g., at R.T., or 20° C.). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸ or 1*10⁻⁸ Ω*m. The low electrical resistivity can be between any of the aforementioned values (e.g., from about 1×10⁻⁵ m to about 1×10⁻⁸ Ω*m). The high thermal conductivity may be at least about 10 Watts per meters times degrees Kelvin (W/mK), 15 W/mK, 20 W/mK, 35 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be between any of the aforementioned thermal conductivity values (e.g., from about 20 W/mK to about 1000 W/mK). The high density may be at least about 1.5 grams per cubic centimeter (g/cm³), 1.7 g/cm³, 2 g/cm³, 2.5 g/cm³, 2.7 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore mentioned values (e.g., from about 1 g/cm³ to about 25 g/cm³).

The elemental metal can be an alkali metal, an alkaline earth metal, a transition metal, a rare earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium or Osmium. The transition metal can be mercury. The rare earth metal can be a lanthanide or an actinide. The antinode metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth. The material may comprise a precious metal. The precious metal may comprise gold, silver, palladium, ruthenium, rhodium, osmium, iridium, or platinum. The material may comprise at least about 40%, 50%, 60%, 70%, 80%, 90%, 95%, 97%, 98%, 99%, 99.5% or more precious metal. The powder material may comprise at most about 40%, 50%, 60%, 70%, 80%, 90%, 95%, 97%, 98%, 99%, 99.5% or less precious metal. The material may comprise precious metal with any value in between the afore-mentioned values. The material may comprise at least a minimal percentage of precious metal according to the laws in the particular jurisdiction.

The metal alloy can comprise iron based alloy, nickel based alloy, cobalt based allow, chrome based alloy, cobalt chrome based alloy, titanium based alloy, magnesium based alloy, or copper based alloy. The alloy may comprise an oxidation or corrosion resistant alloy. The alloy may comprise a super alloy (e.g., Inconel). The super alloy may comprise Inconel 600, 617, 625, 690, 718 or X-750. The alloy may comprise an alloy used for aerospace applications, automotive application, surgical application, or implant applications. The metal may include a metal used for aerospace applications, automotive application, surgical application, or implant applications.

The alloy may include a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron-based alloy can comprise Elinvar, Fernico, Ferroalloys, Invar, Iron hydride, Kovar, Spiegeleisen, Staballoy (stainless steel), or Steel. In some instances the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron-based alloy may include cast iron or pig iron. The steel may include Bulat steel, Chromoly, Crucible steel, Damascus steel, Hadfield steel, High speed steel, HSLA steel, Maraging steel, Reynolds 531, Silicon steel, Spring steel, Stainless steel, Tool steel, Weathering steel, or Wootz steel. The high-speed steel may include Mushet steel. The stainless steel may include AL-6XN, Alloy 20, celestrium, marine grade stainless, Martensitic stainless steel, surgical stainless steel, or Zeron 100. The tool steel may include Silver steel. The steel may comprise stainless steel, Nickel steel, Nickel-chromium steel, Molybdenum steel, Chromium steel, Chromium-vanadium steel, Tungsten steel, Nickel-chromium-molybdenum steel or Silicon-manganese steel. The steel may be comprised of any Society of Automotive Engineers (SAE) grade such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H or 304H. The steel may comprise stainless steel of at least one crystalline structure selected from the group consisting of austenitic, superaustenitic, ferritic, martensitic, duplex and precipitation-hardening martensitic. Duplex stainless steel may be lean duplex, standard duplex, super duplex or hyper duplex. The stainless steel may comprise surgical grade stainless steel (e.g., austenitic 316, martensitic 420 or martensitic 440). The austenitic 316 stainless steel may include 316L or 316LVM. The steel may include 17-4 Precipitation Hardening steel (also known as type 630 is a chromium-copper precipitation hardening stainless steel; 17-4PH steel). The stainless steel may comprise 360L stainless steel.

The titanium-based alloys may include alpha alloys, near alpha alloys, alpha and beta alloys, or beta alloys. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38 or higher. In some instances the titanium base alloy includes TiAl₆V₄ or TiAl₆Nb₇.

The Nickel based alloy may include Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The Brass may include nickel hydride, stainless or coin silver. The cobalt alloy may include Megallium, Stellite (e. g. Talonite), Ultimet, or Vitallium. The chromium alloy may include chromium hydroxide, or Nichrome.

The aluminum-based alloy may include AA-8000, Al—Li (aluminum-lithium), Alnico, Duralumin, Hiduminium, Kryron Magnalium, Nambe, Scandium-aluminum, or, Y alloy. The magnesium alloy may be Elektron, Magnox or T-Mg—Al—Zn (Bergman phase) alloy. At times, the material excludes at least one aluminum-based alloy (e.g., AlSi₁₀Mg).

The copper based alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo or Tumbaga. The Brass may include Calamine brass, Chinese silver, Dutch metal, Gilding metal, Muntz metal, Pinchbeck, Prince's metal, or Tombac. The Bronze may include Aluminum bronze, Arsenical bronze, Bell metal, Florentine bronze, Guanin, Gunmetal, Glucydur, Phosphor bronze, Ormolu or Speculum metal. The elemental carbon may comprise graphite, Graphene, diamond, amorphous carbon, carbon fiber, carbon nanotube, or fullerene.

A trace amount of impurities can be included in the material. The trace amount can be a concentration of at most about 10,000 ppm, 1000 ppm, 500 ppm, 400 ppm, 200 ppm, 100 ppm, 50 ppm, 10 ppm, 5 ppm, or 1 ppm.

The material (e.g., alloy or elemental) may comprise a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may be used for products comprising devices, machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The devices may comprise medical devices (e.g., for human & veterinary). The material may be used for products comprising those used for human or veterinary applications comprising implants, and/or prosthetics. The material may be used for products comprising those used for applications in the fields comprising human or veterinary surgery, implants (e.g., dental), or prosthetics.

The powder material (also referred to herein as a “pulverous material”) may comprise a solid comprising fine particles. The powder may be a granular material. The powder can be composed of individual particles. At least some of the particles can be spherical, oval, prismatic, cubic, or irregularly shaped. At least some of the particles can have a FLS. The FLS of at least some of the particles can be from about 1 nanometers (nm) to about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, or 5 nm. At least some of the particles can have a FLS of at least about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nanometers (nm) or more. At least some of the particles can have a FLS of at most about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nm or less. In some cases at least some of the powder particles may have a FLS in between any of the afore-mentioned FLSs.

The powder can be composed of a homogenously shaped particle mixture such that all of the particles have substantially the same shape and FLS magnitude within at most about 1%, 5%, 8%, 10%, 15%, 20%, 25%, 30%, 35%, 40%, 50%, 60%, 70%, or less distribution of FLS. In some cases the powder can be a heterogeneous mixture such that the particles have variable shape and/or FLS magnitude. In some examples, at least about 30%, 40%, 50%, 60%, or 70% (by weight) of the particles within the powder material have a largest FLS that is smaller than the median largest FLS of the powder material. In some examples, at least about 30%, 40%, 50%, 60%, or 70% (by weight) of the particles within the powder material have a largest FLS that is smaller than the mean largest FLS of the powder material.

In some examples, the size of the largest FLS (e.g., diameter, spherical equivalent diameter, length, width, or diameter of a bounding circle) of the fused, connected or bound material (e.g., powder material) is greater than the average largest FLS of the powder material by at least about 1.1 times, 1.2 times, 1.4 times, 1.6 times, 1.8 times, 2 times, 4 times, 6 times, 8 times, or 10 times. In some examples, the size of the largest FLS of the transformed material is greater than the median largest FLS of the powder material by at most about 1.1 times, 1.2 times, 1.4 times, 1.6 times, 1.8 times, 2 times, 4 times, 6 times, 8 times, or 10 times. The powder material can have a median largest FLS that is at least about 1 μm, 5 μm, 10 μm, 20 μm, 30 μm, 40 μm, 50 μm, 100 μm, or 200 μm. The powder material can have a median largest FLS that is at most about 1 μm, 5 μm, 10 μm, 20 μm, 30 μm, 40 μm, 50 μm, 100 μm, or 200 μm. In some cases the powder particles may have a FLS in between any of the FLSs listed above (e.g., from about 1 μm to about 200 μm, from about 1 μm to about 50 μm, or from about 5 μm to about 40 μm).

The term “layer,” as used herein, generally refers to a layer material (e.g. pre-transformed material such as powder) on a platform or on a previous layers. A layer can be a thin plane of material. The layer of material can be thermally manipulated to form (e.g., subsequently form) at least a fraction of a 3D object. Layers can be provided additively or sequentially to form at least a fraction of a solidified 3D object. A layer may include a film or thin film. A layer can comprise liquid and/or solid material. A layer can have a thickness from about a monoatomic monolayer (ML) to 1 ML, tens of monolayers, hundreds of monolayers, thousands of monolayers, millions of monolayers, billions of monolayers, or trillions of monolayers. In an example, a layer is a multilayer structure having a thickness greater than one monoatomic monolayer. Adjacent layers can be joined. Adjacent layers can be fused.

The layer of material (e.g., powder) may be of a predetermined height (thickness). The layer of material can comprise the material prior to its transformation. The layer may have an upper surface that is substantially flat, leveled, or smooth. In some instances, the layer may have an upper surface that is not flat, leveled, or smooth. The layer may have an upper surface that is corrugated or uneven. The layer may have a predetermined height. The height of the layer of material (e.g., powder) may be at least about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1000 mm, or more. The height of the layer of material (e.g., powder) may be at most about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1000 mm, or less. The height of the layer of material (e.g., powder) may be any number between the afore-mentioned heights (e.g., from about 5 μm to about 1000 mm, from about 5 μm to about 1 mm, from about 25 μm to about 1 mm, or from about 1 mm to about 1000 mm). The “height” of the layer of material (e.g., powder) may at times be referred to as the “thickness” of the layer of material. The layer may be a sheet of metal. The layer may be fabricated using a 3D manufacturing methodology. Occasionally, the first layer may be thicker than a subsequent layer. The first layer may be at least about 1.1 times, 1.2 times, 1.4 times, 1.6 times, 1.8 times, 2 times, 4 times, 6 times, 8 times, 10 times, 20 times, 30 times, 50 times, 100 times, 500 times, 1000 times, or more thicker (higher) than the average thickness of a subsequent layer, the average thickens of an average subsequent layer, or the average thickness of any of the subsequent layers.

The term “auxiliary supports,” as used herein, generally refers to features that are part of a printed 3D object, but are not part of the desired, intended, designed, ordered, or final 3D object. Auxiliary supports may provide structural support during and/or subsequent to the formation of the 3D object. Auxiliary supports may be anchored to the enclosure. For example, auxiliary supports may be anchored to the platform, to the side walls of the material bed, to a wall of the enclosure, or to an object (e.g., stationary or semi-stationary) within the enclosure. Auxiliary supports may enable the removal or energy from the 3D object that is being formed. Examples of auxiliary supports comprise fin (e.g., heat fin), anchor, handle, pillar, column, frame, footing or another stabilization feature. In some instances, the auxiliary supports are mounted, clamped, or situated on the platform. The auxiliary supports can be anchored to the platform, to the sides (e.g. walls) of the platform, to the enclosure, to an object (stationary or semi-stationary) within the enclosure, or any combination thereof.

In some examples, the generated 3D object can be printed without auxiliary supports. In some examples, overhanging feature of the generated 3D object can be printed without auxiliary supports. The generated object can be devoid of auxiliary supports. The generated object may be suspended (e.g., float anchorless) in the material bed (e.g., powder). The generated object may be suspended in the layer of material (e.g., powder). FIG. 16 shows an example of a 3D object (including portions 1605, 1607 and 1609) that floats anchorless in the material bed 1604. The material (e.g., powder material) can offer support to the printed 3D object (or the object during its generation). Sometimes, the generated 3D object may comprise one or more auxiliary supports. The one or more auxiliary supports may be suspended in the material (e.g., powder material). The one or more auxiliary supports can be suspended in the material (e.g., powder) within the layer of material in which the object has been formed. The one or more auxiliary supports can be suspended in the material within a layer other than the one in which the object has been formed (e.g., a previously deposited layer of (e.g., powder) material). The auxiliary support may touch the platform. The auxiliary support may be suspended in the material (e.g., powder material) and not touch the platform. The distance between any two auxiliary supports can be at least about 1 millimeter, 1.3 millimeters (mm), 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, 45 mm, or more. The distance between any two auxiliary supports can be at most 1 millimeter, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, 45 mm, or less. The distance between any two auxiliary supports can be any value in between the afore-mentioned distances. The distance may be the shortest distance between any two auxiliary supports.

In some examples, the diminished number of auxiliary supports or lack of one or more auxiliary support, will provide a 3D printing process that requires a smaller amount of material, produces a smaller amount of material waste, and/or requires smaller energy as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforesaid values (e.g., from about 1.1 to about 10, or from about 1.5 to about 5).

Objects with an internal cavity structure can have superior strength to weight ratio compared to an object with similar volume formed of a dense (e.g., hardened such as solid) material. Provided herein are systems, apparatuses and methods for the formation of objects with internal cavity structure formed by an additive manufacturing processes.

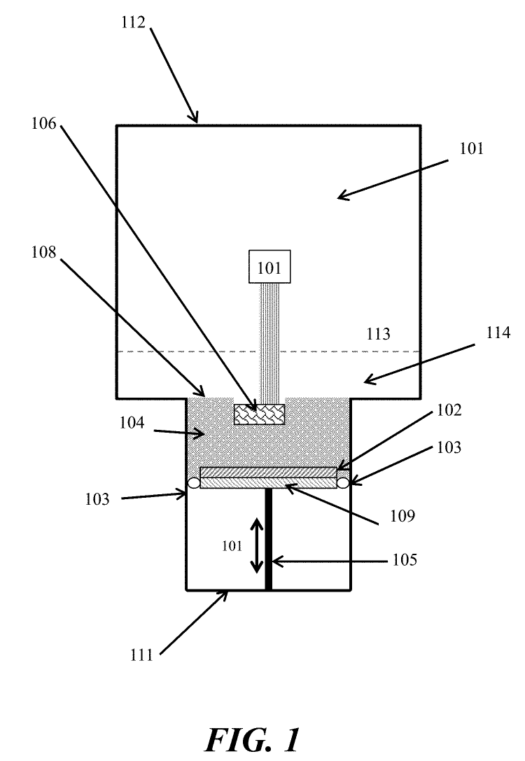

The present disclosure provides systems, apparatuses and/or methods for 3D printing of an object from a powder material. FIG. 1 shown an example of a system and/or apparatus for forming a 3D object that may comprise a small-scaffold feature.

FIG. 1 depicts an example of a system that can be used to generate a 3D object using a 3D printing process disclosed herein. The pre-transformed material (e.g., powder material) may be deposited in an enclosure (e.g., a container). FIG. 1 shows an example of a container 112. The container can contain the pre-transformed material (e.g., without spillage; FIG. 1, 104). The pre-transformed material may be placed in, or inserted to the container. The material may be deposited in, pushed to, sucked into, or lifted to the container. The material may be layered (e.g., spread) in the container. The container may comprise a substrate (e.g., FIG. 1, 109). The substrate may be situated adjacent to the bottom of the container (e.g., FIG. 1, 111). Bottom may be relative to the gravitational field, or relative to the position of the footprint of the energy beam (e.g., FIG. 1, 101) on the layer of pre-transformed material (e.g., powder) within the material bed. The container may comprise a base (e.g., FIG. 1, 102). The base may reside adjacent to the substrate. The pre-transformed material may be layered adjacent to a side of the container (e.g., on the bottom of the container). The pre-transformed material may be layered adjacent to the substrate and/or adjacent to the base. Adjacent to may be above. Adjacent to may be directly above, or directly on. The substrate may have seals to enclose the material in a selected area within the container (e.g., FIG. 1, 103). The seals may be flexible or non-flexible. The seals may comprise a polymer or a resin. The seals may comprise a round edge or a flat edge. The seals may be bendable or non-bendable. The seals may be stiff. The container may comprise the base. The base may be situated within the container.

The platform (also herein, “printing platform”) may be part of the container. The substrate and/or the base may be removable or non removable. The platform may be substantially horizontal, substantially planar, or non-planar. The platform may have a surface that points towards the deposited material (e.g., powder material), which at times may point towards to top of the container. The platform may have a surface that points away from the deposited material (e.g., powder material), which at times may point towards to bottom of the container. The platform may have a surface that is substantially flat. The platform may have a surface that is not flat. The platform may have a surface that comprises protrusions or indentations. The platform may have a surface that comprises embossing. The platform may have a surface that comprises supporting features. The platform may have a surface that comprises a mold. The platform may have a surface that comprises a wave formation. The surface may point towards the layer of material (e.g., powder) within the material bed. The wave may have an amplitude (e.g., vertical amplitude or at an angle). The base may comprise a mesh through which the material is able to flow though. The platform may comprise a motor. The substrate or the base may be fastened to the container or to a conveyor belt. The platform (e.g., base and/or substrate) may be fastened to the substrate. The platform may be transportable. The transportation of the platform may be regulated and/or controlled by a controller (e.g., control system). The platform may be transportable horizontally, vertically, or at an angle (e.g., planar or compound).

The motor can comprise an electric motor. The electric motor can be a direct current (DC) or an alternative current (AC) motor. The motor can comprise a rotor, stator, gas gap, winding, or commutator. The motor can comprise a starter. The starter can be a direct-on-line or soft-start starter. The motor may comprise a power inverter, variable-frequency drive, or electronic commutator. The motor may comprise a magnetic, electrostatic, or piezoelectric component. The rotor may comprise rotary (e.g., ironless or coreless rotor motor), axial rotor, servo, stepper, linear, induction (e.g., Cage and wound rotor induction motor), torque, synchronous, or double fed electric motors.

The platform may be vertically transferable, for example using an elevator, a roll, a gear, a conveyor (e.g., a conveyor belt), or any combination thereof. An elevation mechanism is shown as an example in FIG. 1, 105. The up and down arrow next to the elevation mechanism 105 signifies a possible direction of movement of the elevation mechanism, or a possible direction of movement effectuated by the elevation mechanism.

The system can include an enclosure (e.g., a chamber 112). At least some of the components in the system can be enclosed in the chamber. At least a fraction of the chamber can be filled with a gas to create a gaseous environment (i.e., an atmosphere). The gas can be an inert gas (e.g., Argon, Neon, Helium, Nitrogen). The chamber can be filled with another gas or mixture of gases. The gas can be a non-reactive gas (e.g., an inert gas). The gaseous environment can comprise argon, nitrogen, helium, neon, krypton, xenon, hydrogen, carbon monoxide, or carbon dioxide. The pressure in the chamber can be at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, 1000 bar, or more. The pressure in the chamber can be at least 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at most 10⁻⁷ Torr, 10⁻⁶ Torr, 10⁻⁵ Torr, or 10⁻⁴ Torr, 10⁻³ Torr, 10⁻² Torr, 10⁻¹ Torr, 1 Torr, 10 Torr, 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at a range between any of the aforementioned pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). In some cases the pressure in the chamber can be standard atmospheric pressure. The pressure in the chamber can be below or above standard atmospheric pressure. In some cases the pressure in the chamber can be ambient pressure (i.e., neutral pressure). In some examples, the chamber can be under vacuum pressure. In some examples, the chamber can be under a positive pressure (i.e., above ambient pressure). In some cases the chamber can be a vacuum chamber. Vacuum can be maintained using a pumping system having, for example, turbomolecular (“turbo”) pump, cryogenic pump, or ion pump, in some cases backed by a mechanical pump. The pumping system can include one or more valves to regulate pumping. The chamber can be pressurized to a pressure of at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. The chamber can be pressurized to a pressure of at most 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. The pressure in the chamber can be at a range between any of the aforementioned pressure values (e.g., from about 10⁻⁷ Torr to about 1000 bar, from about 10⁻⁷ Torr to about 1 Torr, from about 1 Torr to about 100 Barr, from about 1 bar to about 10 bar, from about 1 bar to about 100 bar, or from about 100 bar to about 1000 bar). In some cases the chamber pressure can be standard atmospheric pressure.

The chamber can comprise two or more gaseous layers. The gaseous layers can be separated by molecular weight or density such that a first gas with a first molecular weight or density is located in a first region below the imaginary line 113, and a second gas with a second molecular weight or density is located in a second region of the chamber above the imaginary line 113. The first molecular weight or density may be smaller than the second molecular weight or density. The first molecular weight or density may be larger than the second molecular weight or density. The gaseous layers can be separated by temperature. The first gas can be in a lower region of the chamber relative to the second gas. The second gas and the first gas can be in adjacent locations. The second gas can be on top of, over, and/or above the first gas. In some cases the first gas can be argon and the second gas can be helium. The molecular weight or density of the first gas can be at least about 1.5*, 2*, 3*, 4*, 5*, 10*, 15*, 20*, 25*, 30*, 35*, 40*, 50*, 55*, 60*, 70*, 75*, 80*, 90*, 100*, 200*, 300*, 400*, or 500* larger or greater than the molecular weight or density of the second gas. “*” used herein designates the mathematical operation “times.” The molecular weight of the first gas can be higher than the molecular weight of air. The molecular weight or density of the first gas can be higher than the molecular weight or density of oxygen gas (e.g., O₂). The molecular weight or density of the first gas can be higher than the molecular weight or density of nitrogen gas (e.g., N₂). At times, the molecular weight or density of the first gas may be lower than that of oxygen gas or nitrogen gas.

The first gas with the relatively higher molecular weight or density can fill a region of the system where the material bed is located (e.g., 104). The second gas with the relatively lower molecular weight or density can fill a region of the system away from the region where the 3D object is formed (e.g., 101). The material layer can be supported on a substrate (e.g., 109). The substrate can have a circular, rectangular, square, or irregularly shaped cross-section. The substrate may comprise a base disposed above the substrate. The substrate may comprise a base (e.g., 102) disposed between the substrate and a material layer (or a space to be occupied by a material layer). A thermal control unit (e.g., a cooling member such as a heat sink or a cooling plate, a heating plate, or a thermostat) can be provided inside of the region where the 3D object is formed or adjacent to the region where the 3D object is formed. The thermal control unit can be provided outside of the region where the 3D object is formed.

The concentration of oxygen in the enclosure (e.g., chamber) can be minimized. The concentration of oxygen and/or humidity in the chamber can be maintained below a predetermined threshold value. For example, the gas composition of the chamber can contain a level of oxygen and/or humidity that is at most about 100 parts per billion (ppb), 10 ppb, 1 ppb, 0.1 ppb, 0.01 ppb, 0.001 ppb, 100 parts per million (ppm), 10 ppm, 1 ppm, 0.1 ppm, 0.01 ppm, or 0.001 ppm. The gas composition of the chamber can contain an oxygen and/or humidity level between any of the aforementioned values (e.g., from about 100 ppb to about 0.001 ppm, from about 1 ppb to about 0.01 ppm, or from about 1 ppm to about 0.1 ppm). In some cases, the chamber can be opened at the completion of a formation of a 3D object. When the chamber is opened, ambient air containing oxygen and/or humidity may enter the chamber. Exposure of one or more components inside of the chamber to oxygen, humidity, and/or air can be reduced by, for example, flowing an inert gas while the chamber is open (e.g., to prevent entry of ambient air), and/or by flowing a heavy gas (e.g., argon) that rests on the surface of the powder bed. In some cases, components that absorb oxygen and/or water on to their surface(s) can be sealed while the chamber is open.

The chamber can be configured such that gas inside of the chamber has a relatively low leak rate from the chamber to an environment outside of the chamber. In some cases the leak rate can be at most about 100 milliTorr/minute (mTorr/min), 50 mTorr/min, 25 mTorr/min, 15 mTorr/min, 10 mTorr/min, 5 mTorr/min, 1 mTorr/min, 0.5 mTorr/min, 0.1 mTorr/min, 0.05 mTorr/min, 0.01 mTorr/min, 0.005 mTorr/min, 0.001 mTorr/min, 0.0005 mTorr/min, or 0.0001 mTorr/min. The leak rate may be between any of the aforementioned leak rates (e.g., from about 0.0001 mTorr/min to about, 100 mTorr/min, from about 1 mTorr/min to about, 100 mTorr/min, or from about 1 mTorr/min to about, 100 mTorr/min). The enclosure can be sealed such that the leak rate of gas from inside the chamber to an environment outside of the chamber is low. The seals can comprise O-rings, rubber seals, metal seals, load-locks, or bellows on a piston. In some cases the chamber can have a controller configured to detect leaks above a specified leak rate (e.g., by using a sensor). The sensor may be coupled to a controller. In some instances, the controller is able to identify a leak by detecting a decrease in pressure in side of the chamber over a given time interval.

Pre-transformed material (e.g., powder) can be dispensed on to the platform (e.g., base and/or substrate) to form a 3D object from the Pre-transformed material. The platform may be lowered or elevated by a translation mechanism (e.g., elevator, FIG. 1, 101). The platform may be the bottom of the enclosure (e.g., FIG. 1, 111). The system may comprise

In some cases, auxiliary support(s) may adhere to the upper surface of the platform. In some examples, the auxiliary supports of the printed 3D object may touch the platform (e.g., the bottom of the enclosure, the substrate, or the base). Sometimes, the auxiliary support may adhere to the platform. In some embodiments, the auxiliary supports are an integral part of the platform. At times, auxiliary support(s) of the printed 3D object, do not touch the platform. The auxiliary supports may float in the material bed. The auxiliary supports may not be anchored to any part of the enclosure. In any of the methods described herein, the printed 3D object may be supported only by the material within the material bed (e.g., powder bed, FIG. 1, 104). Any auxiliary support(s) of the printed 3D object, if present, may be suspended adjacent to the platform. Occasionally, the platform may have a pre-hardened (e.g., pre-solidified) amount of material. Such pre-solidified material may provide support to the printed 3D object. At times, the platform may provide adherence to the material. At times, the platform does not provide adherence to the material. The platform may comprise elemental metal, metal alloy, elemental carbon, or ceramic. The platform may comprise a composite material. The platform may comprise glass, stone, zeolite, or a polymeric material. The polymeric material may include a hydrocarbon or fluorocarbon. The base may include Teflon. The platform may include compartments for printing small objects. Small may be relative to the size of the enclosure. The compartments may form a smaller compartment within the enclosure, which may accommodate the layer of pre-transformed material (e.g., powder).

The methods described herein can be performed in the enclosure (e.g., container or chamber). The 3D objects described herein can be formed in the enclosure. The enclosure may have a predetermined and/or controlled pressure. The enclosure may have a predetermined and/or controlled atmosphere. The control may be manual or automatic (e.g., via a controller).

The enclosure may comprise ambient pressure, negative pressure (i.e., vacuum) or positive pressure. The vacuum may comprise pressure below 1 bar. The positively pressurized environment may comprise pressure above 1 bar. The pressure in the enclosure can be at least about 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, 1000 bar, or 1100 bar. The pressure in the enclosure can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the enclosure can be between any of the aforementioned enclosure pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr).

The enclosure may include an atmosphere. The enclosure may comprise an inert atmosphere. The atmosphere in the enclosure may be substantially depleted by one or more gases present in the ambient atmosphere. The atmosphere in the enclosure may include a reduced level of one or more gases relative to the ambient atmosphere. For example, the atmosphere may be substantially depleted, or have reduced levels of water, oxygen, nitrogen, carbon dioxide, hydrogen sulfide, or any combination thereof. The level of the depleted or reduced level gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm volume by volume (v/v). The level of the depleted or reduced level gas may be at least about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the oxygen gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the water vapor may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the gas (e.g., depleted or reduced level gas, oxygen, or water) may between any of the afore-mentioned levels of the gas. The atmosphere may comprise air. The atmosphere may be inert. The atmosphere may be non-reactive. The atmosphere may be non-reactive with the material (e.g., the material deposited in the layer of material (e.g., powder), or the material comprising the 3D object). The atmosphere may prevent oxidation of the generated 3D object. The atmosphere may prevent oxidation of the material within the layer of material (e.g., powder) before its transformation, during its transformation, after its transformation, before its hardening, after its hardening, or any combination thereof. The atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be 1 atmosphere. Ambient temperature (also “room temperature,” R.T.) may be a typical temperature to which humans are generally accustomed. For example, from about 15° C. to about 30° C., from 16° C. to about 26° C., from about 20° C. to about 25° C. “Room temperature” may be measured in a confined or in a non-confined space. For example, “room temperature” can be measured in a room, an office, a factory, a vehicle, a container, or out doors. The vehicle may be a car, a truck, a bus, an airplane, a space shuttle, a space ship, a ship, a boat, or any other vehicle.

Apparatuses and/or systems described herein may comprise an energy beam that may project energy to the material bed. The systems and/or the apparatus described herein can comprise at least one energy beam (e.g., and array of energy beams such as in FIG. 1, emerging from the energy source 101). In some cases, the system can comprise two, three, four, five, or more energy beams. The energy beams may be arranged in an array (e.g., as disclosed herein). The energy beam may include radiation comprising charged or non charged energy beam. The charged energy beam may be an electron beam. The non charged energy beam may be an electromagnetic beam. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. The laser may comprise a fiber laser, a solid-state laser or a diode laser. The energy source can provide energy through an electromagnetic beam, electron beam, microwave beam or plasma beam. The electromagnetic beam can be a laser beam or a microwave beam. An energy beam can be provided by a diode. For example, a laser beam can be provided by a laser diode.

The laser source may comprise a Nd: YAG, Neodymium (e.g., neodymium-glass), or an Ytterbium laser. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro laser sintering. The energy beam (e.g., laser) may have a power of at least about 0.5 Watt (W), 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy beam may have a power of at most about 0.5 W, 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy beam may have a power between any of the afore-mentioned laser power values (e.g., from about 0.5 W to about 100 W, from about 1 W to about 10 W, from about 100 W to about 1000 W, or from about 1000 W to about 4000 W). In some instances, the energy beam array may comprise energy beams with a power ranging from 0.5 W to 400 W, 0.1 W to 100 W, or 0.1 W to 10 W.

The energy beam may travel at a velocity of at least about 1 millimeters per second (mm/sec), 2 mm/sec, 3 mm/sec, 4 mm/sec, 5 mm/sec, 6 mm/sec, 7 mm/sec, 8 mm/sec, 9 mm/sec, 10 mm/sec, 12 mm/sec, 14 mm/sec, 15 mm/sec, 16 mm/sec, 18 mm/sec, 20 mm/sec, 25 mm/sec, 30 mm/sec, 40 mm/sec, 50 mm/sec, 100 mm/sec, 500 mm/sec, 1000 mm/sec, 1400 mm/sec, 1500 mm/sec, or 2000 mm/sec. The energy beam may travel at a velocity of at most about 1 mm/sec, 2 mm/sec, 3 mm/sec, 4 mm/sec, 5 mm/sec, 6 mm/sec, 7 mm/sec, 8 mm/sec, 9 mm/sec, 10 mm/sec, 12 mm/sec, 14 mm/sec, 15 mm/sec, 16 mm/sec, 18 mm/sec, 20 mm/sec, 25 mm/sec, 30 mm/sec, 40 mm/sec, 50 mm/sec, 100 mm/sec, 500 mm/sec, 1000 mm/sec, 1400 mm/sec, 1500 mm/sec, or 2000 mm/sec. The energy beam may travel at a velocity between any of the afore-mentioned velocity values (e.g., from about 1 mm/sec to about 2000 mm/sec, from about 1 mm/sec to about 100 mm/sec, or from about 100 mm/sec to about 2000 mm/sec). The energy beam may derive from an electron gun. The energy beam may include a pulsed energy beam, a continuous wave energy beam, or a quasi continuous wave energy beam. The pulse energy beam may have a repetition frequency of at least about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHz, 3 MHz, 4 MHz, or 5 MHz. The pulse energy beam may have a repetition frequency of at most about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHz, 3 MHz, 4 MHz, or 5 MHz. The pulse energy beam may have a repetition frequency between any of the afore-mentioned repetition frequencies (e.g., from about 1 KHz to about 5 MHz, from about 1 KHz to about 1 MHz, or from about 1 MHz to about 5 MHz). The apparatuses and/or systems disclosed herein may comprise Q-switching, mode coupling or mode locking to effectuate the pulsing energy beam. The apparatus or systems disclosed herein may comprise an on/off switch, a modulator, or a chopper to effectuate the pulsing energy beam. The on/off switch can be manually or automatically controlled. The switch may be controlled by the controller. The switch may alter the “pumping power” of the energy beam. The energy beam may be at times focused, non-focused, or defocused.

The energy source(s) can project energy using a DLP modulator, a one-dimensional scanner, a two-dimensional scanner, or any combination thereof. The energy source(s) and/or the platform of the energy beam(s) can be stationary or translatable. The energy source(s) and/or the platform of the energy beam(s) can translate vertically, horizontally, or in an angle (e.g., planar or compound angle). The energy source(s) can be modulated. The energy beam(s) emitted by the energy source(s) can be modulated. The modulation can be effectuated using a modulator such as the one described herein.

The energy beam(s), energy source(s), and/or the platform of the energy beam array can be moved via a scanner (e.g., as described herein). The galvanometer may comprise a mirror. The galvanometer scanner may comprise a two-axis galvanometer scanner. The scanner may comprise a modulator (e.g., as described herein). The scanner may comprise a polygonal mirror. The scanner can be the same scanner for two or more energy sources and/or beams. At least two (e.g., each) energy source and/or beam may have a separate scanner. The energy sources can be translated independently of each other. In some cases at least two energy sources and/or beams can be translated at different rates, and/or along different paths. For example, the movement of a first energy source may be faster as compared to the movement of a second energy source. The systems and/or apparatuses disclosed herein may comprise one or more shutters (e.g., safety shutters), on/off switches, or apertures.

The energy beam (e.g., laser) may have a FLS (e.g., a diameter) of its footprint on the on the exposed surface of the material bed of at least about 0.1 micrometers (μm), 0.5 μm, 1 μm, 2 μm, 3 μm, 4 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the layer of it footprint on the exposed surface of the material bed of at most about 0.1 μm, 0.5 μm, 1 μm, 2 μm, 3 μm, 4 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the exposed surface of the material bed between any of the afore-mentioned energy beam fundamental length scale values (e.g., from about 0.1 μm to about 500 μm, from about 0.1 μm to about 50 μm, from about 1 μm to about 30 μm, or from about 30 μm to about 500 μm). The beam may be a focused beam. The beam may be a dispersed beam. The beam may be an aligned beam. The apparatus and/or systems described here in may further comprise a focusing coil, a deflection coil, or an energy beam power supply. The defocused energy beam may have a FLS on the exposed surface of the material bed of at least about 1 mm, 5 mm, 10 mm, 20 mm, 30 mm, 40 mm, 50 mm, or 100 mm. The defocused energy beam may have a FLS on the exposed surface of the material bed of at most about 1 mm, 5 mm, 10 mm, 20 mm, 30 mm, 40 mm, 50 mm, or 100 mm. The energy beam may have a defocused FLS on the exposed surface of the material bed between any of the afore-mentioned energy beam fundamental length scale values (e.g., from about 5 mm to about 100 mm, from about 5 mm to about 50 mm, or from about 50 mm to about 100 mm).

The power supply to any of the components described herein can be supplied by a grid, generator, local, or any combination thereof. The power supply can be from renewable or non-renewable sources. The renewable sources may comprise solar, wind, hydroelectric, or biofuel. The powder supply can comprise rechargeable batteries.

The exposure time of the energy beam may be at least 1 microseconds (μs), 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be most about 1 micrometers (μs), 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be any value between the afore-mentioned exposure time values (e.g., from about 5 μs to about 1000 μs, from about 5 μs to about 200 μs, from about 200 μs to about 500 μs, or from about 500 μs to about 1000 μs).

The systems and/or the apparatus described herein can further comprise at least one energy source. In some cases, the system can comprise two, three, four, five, or more energy sources. An energy source can be a source configured to deliver energy to an area (e.g., a confined area). An energy source can deliver energy to the confined area through radiative heat transfer.

The energy source can supply any of the energies described herein (e.g., energy beams). The energy source may be capable of delivering energy to a point or to an area (e.g., in the material bed such as in the exposed surface of the material bed). The energy source may include an electron gun source. The energy source may include a laser source. The energy source may comprise an array of lasers. In an example a laser can provide light energy at a peak wavelength of at least about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength between the afore-mentioned peak wavelengths (e.g., from 100 nm to 2000 nm, from 100 nm to 1100 nm, or from 1000 nm to 2000 nm). The energy beam can be incident on the top surface of the material bed. The energy beam can be substantially perpendicular to the top (e.g., exposed) surface of the material bed. The energy beam can be incident on, or be directed to, a specified area of the material bed over a specified time period. The material bed can absorb the energy from the energy beam (e.g., incident energy beam) and, as a result, a localized region of the material in the material bed can increase in temperature. The increase in temperature may transform the material within the material bed. The increase in temperature may heat and transform the material within the material bed. In some embodiments, the increase in temperature may heat and not transform the material within the material bed. The increase in temperature may heat the material within the material bed.

The energy beam and/or source can be moveable such that it can translate relative to the material bed. The energy beam and/or source can be moved by a scanner. The movement of the energy beam and/or source can comprise utilization of a scanner.

At one point in time, and/or substantially during the entire build of the 3D object: At least two of the energy beams and/or sources can be translated independently of each other or in concert with each other. At least two of the multiplicity of energy beams can be translated independently of each other or in concert with each other. At least two of the multiplicity of energy sources can be translated independently of each other or in concert with each other. In some cases at least two of the energy beams can be translated at different rates such that the movement of the one is faster compared to the movement of at least one other energy beam. In some cases at least two of the energy sources can be translated at different rates such that the movement of the one energy source is faster compared to the movement of at least another energy source. In some cases at least two of the energy sources (e.g., all of the energy sources) can be translated at different paths. In some cases at least two of the energy sources can be translated at substantially identical paths. In some cases at least two of the energy sources can follow one another in time and/or space. In some cases at least two of the energy sources translate substantially parallel to each other in time and/or space. The power per unit area of at least two of the energy beam may be substantially identical. The power per unit area of at least one of the energy beams may be varied. The power per unit area of at least one of the energy beams may be different. The power per unit area of at least one of the energy beams may be different. The power per unit area of one energy beam may be greater than the power per unit area of a second energy beam. The energy beams may have the same or different wavelengths. A first energy beam may have a wavelength that is smaller or larger than the wavelength of a second energy beam. The energy beams can derive from the same energy source. At least one of the energy beams can derive from different energy sources. The energy beams can derive from different energy sources. At least two of the energy beams may have the same power. At least one of the beams may have a different power. The beams may have different powers. At least two of the energy beams may travel at substantially the same velocity. At least one of the energy beams may travel at different velocities. The velocity of travel of at least two energy beams may be substantially constant. The velocity of travel of at least two energy beams may be varied. The travel may refer to a travel on the exposed surface of the material bed (e.g., powder material), or close to the exposed surface of the material bed. The travel may be within the material bed.

The energy (e.g., energy beam) may travel in a path. The path of the energy beam may comprise repeating a path. For example, the first energy may repeat its own path. The second energy may repeat its own path, or the path of the first energy. The repetition may comprise a repetition of 1, 2, 3, 4, 5, 6, 7, 8, 9, 10 times or more. The energy may follow a path comprising parallel lines. For example, FIG. 6A, 603 and 694 show paths that comprise parallel lines. The distance between each of the parallel lines or line portions may be at least about 1 micrometers (μm), 5 μm, 10 μm, 20 μm, 30 μm, 40 μm, 50 μm, 60 μm, 70 μm, 80 μm, 90 μm, or more. The distance between each of the parallel lines or line portions, may be at most about 1 μm, 5 μm, 10 μm, 20 μm, 30 μm, 40 μm, 50 μm, 60 μm, 70 μm, 80 μm, 90 μm, or less. The distance between each of the parallel lines or line portions may be any value between any of the afore-mentioned distance values (e.g., from about 1 μm to about 90 μm, from about 1 μm to about 50 μm, or from about 40 μm to about 90 μm). The distance between the parallel line portions may be substantially the same in every layer (e.g., plane) of transformed material. The distance between the parallel lines portions in one layer (e.g., plane) of transformed material may be different than the distance between the parallel line portions in another layer (e.g., plane) of transformed material within the 3D object. The distance between the parallel line portions within a layer (e.g., plane) of transformed material may be substantially constant. The distance between the parallel line portions within a layer (e.g., plane) of transformed material may be varied. The distance between a first pair of parallel line portions within a layer (e.g., plane) of transformed material may different than the distance between a second pair of parallel line portions within a layer (e.g., plane) of transformed material. The first energy beam may follow a path comprising two lines that cross in at least one point. The lines may be straight or curved. The lines may be winding lines. For example, FIG. 6 shows an example of winding line paths 601 and 602. The first energy beam may follow a path comprising a U shaped turn (e.g., FIG. 6, 601). The first energy beam may follow a path devoid of U shaped turns (e.g., shown in FIG. 6, 603). The path of the energy beam may comprise a zigzag, wave (e.g., curved, triangular, or square), or curve pattern. The curved wave may be a sine or cosine wave.

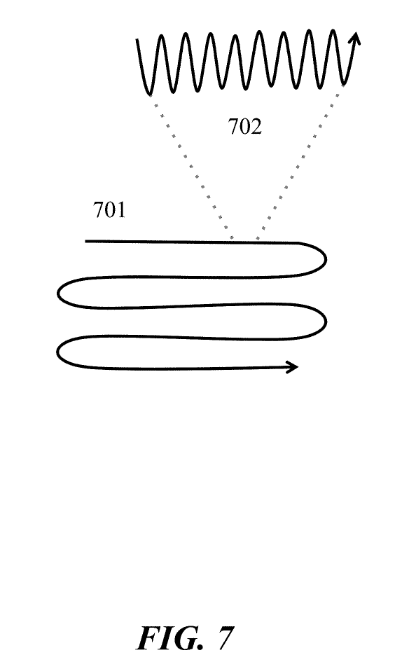

The path may comprise a sub-path. The sub-path may comprise a zigzag, wave (e.g., curved, triangular, or square), or curve pattern. The curved wave may be a sine or cosine wave. The sub-path may be a path that forms the path. The sub-path may be a small path that forms the large path. The sub-path may be a component of the path. The sub-path may form the path. FIG. 7 shows an example of a path 701 of an energy beam comprising a zigzag sub-pattern 702 shown as a blow up of a portion of the path 701. The path of the energy beam may comprise a wave (e.g., sine or cosine wave) pattern. The path that the energy beam follows (e.g., the first path) may be a predetermined path. A model may predetermine the path by a processor, by an individual, by a computer, by a computer program, by a drawing, by a statute, or by any combination thereof.

The controller may control and/or regulate the energy along the first path to allow a reduced amount of energy to concentrate at an edge of the 3D object. For example, the controller can control and/or regulate any of the energy characteristics or energy beam characteristics disclosed herein. For example, the controller can control and/or regulate the FLS of the cross-section of the energy beam on/within the layer of material (e.g., powder), or any variation thereof. For example, the controller can control and/or regulate the flux of energy, energy density, power per unit area of the energy beam, wavelength, amplitude, power, travel rate, travel time, traveling path, any variation thereof, or any combination thereof. The controller may direct the energy (e.g., energy beam) to at least a portion of the layer of material according to a path that deviates at least in part from a cross section of a desired 3D object. The deviation may be any path deviation mentioned herein. In some instances, the generated 3D object substantially corresponds to the desired 3D object. The desired 3D object can comprise a model of a 3D object. The model may be any model mentioned herein. The model can comprise vector-based graphics. The model can comprise computer-aided design, electronic design automation, mechanical design automation, or computer aided drafting. The model may comprise an output of a 3D modeling program (e.g., AutoCAD, SolidWorks, Google SketchUp, or SolidEdge).

The controller may direct the energy beam to at least a portion of the layer of material in the material bed (e.g., powder) according to a path comprising successive segments of lines, wherein at least one first pair of the successive segments of lines vary in at least one factor from at least one second pair of the successive segments of lines. The successive segments can be parallel. The factor can be any factor mentioned herein pertaining the successive segments of lines. The factor can be a distance between the pair of successive segments. The factor may be an angle formed by a pair of successive segments as mentioned herein. The generated 3D object can comprise a lesser degree of deformation as compared to a 3D object that is generated by an additive manufacturing method that uses a path wherein the successive segments of lines do not vary in the at least one factor.

The system and/or apparatus may comprise one or more energy beams. The first energy beam may be of a first type (e.g., low power), the second energy beam may be of a second type (e.g., medium power), and the third energy beam may be of a third type (e.g., high power). The first energy beam may fabricate fine structures (e.g., small-scaffold feature). The second energy beam may fabricate bulk structures. The third energy beam may ablate any debris (e.g., on any of the system components (e.g., lens). In some instances the second energy beam may both build bulk structure and ablate any debris. In some instances, the first energy beam may both fabricate fine and bulk portions of the 3D object (or a portion thereof). In some instances, the first energy beam may both fabricate fine structures and ablate any debris. In some embodiments, the first energy beam may fabricate fine and bulk structures of the 3D object (or part thereof) and ablate any debris.

The first energy source may deliver a power per unit area to the material (e.g., powder material). The second and/or third energy source may deliver a power per unit area that is varied by at least about 1.1, 1.2, 1.4, 1.5, 1.6, 1.8, 2, 3, 4, 5, 6, 7, 8, 9, 10, 15, 20, 25, 30, 35 or 40 times as compared to the power per unit are of the first energy source. The second and/or third energy source may deliver a power per unit area that is varied by at most about 1.1, 1.2, 1.4, 1.5, 1.6, 1.8, 2, 3, 4, 5, 6, 7, 8, 9, 10, 15, 20, 25, 30, 35 or 40 times as compared to the power per unit are of the first energy source. The second and/or third energy source may deliver a power per unit area that is varied by any value between the afore-mentioned multiplier values (e.g., from about 1.1 to about 40 times, from about 1.1. to about 20 times, or from about 20 times to about 40 times). Varied may be smaller. Varied may be larger. The second and/or third energy source may deliver a power per unit area that is substantially equal to the power per unit are of the first energy source.

The first energy beam may translate at a first velocity during its operation. The second and/or third energy beam may translate at a second velocity during its operation. The second and/or third energy source may translate at a velocity that is varied by at least about 1.5, 2, 3, 4, 5, 6, 7, 8, 9, 10, 15, 20, 25, 30, 35, 40, 50, 60, 70, 80, 90, 100 or 150 times compared to the translation velocity of the first energy source. The second and/or third energy source may translate at a velocity that is varied by at most about 1.5, 2, 3, 4, 5, 6, 7, 8, 9, 10, 15, 20, 25, 30, 35, 40, 50, 60, 70, 80, 90, 100 or 150 times compared to translation velocity of the first energy source. The second and/or third energy source may translate at a velocity that is varied by any value between the afore-mentioned velocity multiplier values (e.g., from 1.5 to 150 times, from 1.5 to 50 times, or from 50 to 150 times). The second and/or third energy source may deliver a power per unit area that is substantially equal to the power per unit are of the first energy source.

The systems and/or the apparatus described herein may further comprise a controller. The controller can be in communication with one or more energy sources and/or energy (e.g., energy beams). The energy sources may be of the same type or of different types. For example, the energy sources can be both lasers, or a laser and an electron beam. For example, the controller may be in communication with the first energy, with the second energy, and/or with the third energy. The controller may regulate the one or more energies (e.g., energy beams). The controller may regulate the energy supplied by the one or more energy sources. For example, the controller may regulate the energy supplied by a first energy beam, second energy beam, and/or third energy beam to the material (e.g., pre-transformed and/or transformed) within the material bed. The controller may regulate the position of the one or more energy beams and/or their associated platform. For example, the controller may regulate and/or control the position of the first energy beam, second energy beam, and/or third energy beam. For example, the controller may regulate and/or control the position of the energy beam array. For example, the controller may regulate and/or control the position of the energy beam array platform.

The 3D object can comprise small-scaffold features. The small-scaffold features can have a FLS and/or a perimeter that is of macroscopic scale size or dimension, such as from one end (or size) of the perimeter to another end (or side) of the perimeter. For example, if the 3D object is a sphere with small-scaffold features inside the sphere, the diameter of the sphere can have a macroscopic size. As another example, if the 3D object is a box with small-scaffold features and other features (e.g., non small-scaffold features), a cross-sectional area of the small-scaffold features may have a macroscopic dimension. The term “macroscopic,” as used herein, may refer to a macroscopic dimension that is at most about 10,000 μm (10 mm), 5000 μm, 4000 μm, 3000 μm, 2000 μm, 2000 μm, 1000 μm, 500 μm, 400 μm, 300 μm, 250 μm, 200 μm, 150 μm, or 100 μm.

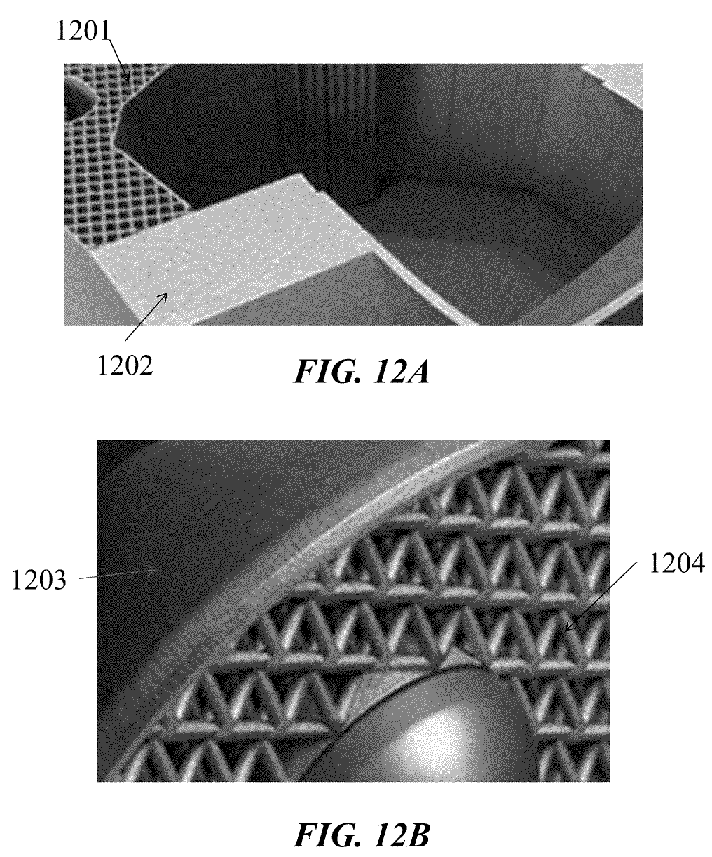

The object can have a high strength to weight ratio. The 3D printing method can be an additive method in which volume is added to an object layer by layer. Each additional layer can be added to the object by transforming (e.g., melting) at least a fraction of the material (e.g., powder). Both the macroscopic and small-scaffold features can be formed by the additive method. The macroscopic and small-scaffold features can be formed by the same energy source. FIGS. 12A-12B show examples of 3D objects that may be formed using the systems, apparatuses, and/or methods provided herein. Such objects include small-scaffold feature 1201. Individual small-scaffold features may be interconnected to one another and/or to non-scaffold features (e.g., dense features). Such dense features can be seen in FIG. 7A, 1202. In FIGS. 12A and 12B, interconnected small-scaffold features are disposed alongside features that may not have small-scaffold features (e.g., that comprise bulk features). The object of FIG. 12B has small-scaffold features (e.g., 1204) and an enclosure (e.g., 1203).

An object comprising a small-scaffold feature formed by the systems, apparatuses, and/or methods described herein can have a solid appearance (e.g., formed as a 3D object that is covered by a bulk material). The small-scaffold object can have a closed outer surface. The small-scaffold object can appear as a dense (e.g., solid) object. The small-scaffold object can have internal cavities (e.g., spaces), gas pockets, and/or holes that are not visible from the outside of the object. In some instances, the small scaffold features (e.g., cavities) are visible from visually inspecting the 3D object (e.g., by eye, or an optical microscope). In some instances, the scaffold features (e.g., comprising the cavities) are exposed. The internal cavities can decrease the weight of the 3D-object. The internal cavities and/or cavity walls can have a structure and/or material that allows an increase strength of the 3D object.

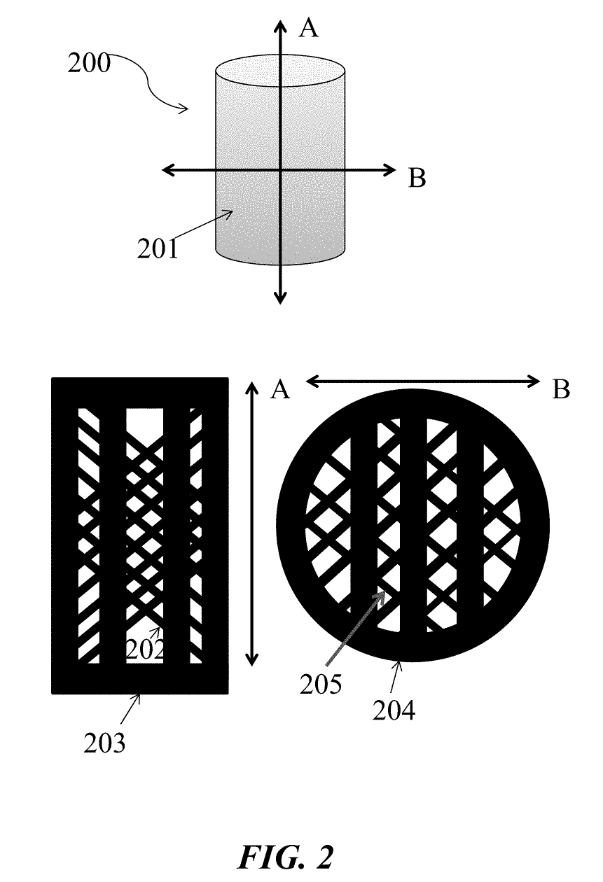

FIG. 2 shows an example of a 3D object 200 comprising both macroscopic and small-scaffold features that can be generated using the systems, apparatuses, and/or methods described herein. The object 200 can have a solid outer surface 201. The solid outer surface 201 can be continuous. A cross section of the 3D object can be taken along line A or line B as shown in FIG. 2. A cross-section taken along line A can reveal small-scaffold features 202. A cross-section taken along line B can show small-scaffold features 205. The macroscopic features 203, and/or 204 can have a larger dimension (e.g., FLS) than the small-scaffold features. The macroscopic features can comprise the outer surface of the object. The macroscopic features can be filled with one or more types of small-scaffold features. The macroscopic features can be built around one or more cavities. The one or more cavities may be filled with one or more types of small-scaffold features. The macroscopic features can be adjacent to the small-scaffold features. The small-scaffold features can be fibrous. The small-scaffold features can be arranged in an ordered lattice structure. In some cases the small-scaffold features can be part of an array comprising periodic domains. The small-scaffold features (or structures) can be interconnected. Individual small-scaffold features can be interconnected to at least 1, 2, 3, 4, 5, 6, 7, 8, 9, 10, 20, 30, 40, 50, or 100 other small-scaffold features. The interconnection can be directly (e.g., bordering) or indirectly. Indirectly can be though intervening small scaffold features, through bulk features, or any combination thereof

The small-scaffold features can be included in a covering (e.g., a covering that engulfs the exterior of the 3D object). The covering can be partially or fully closed. In some cases, the covering may not be fully closed. The covering can be additively generated (e.g., together with the micro scaffold). For example, a covering portion can be generated from the same layer as the respective small-scaffold portion). The small scaffold feature may be generated by the array of energy beams. The bulk feature (e.g., covering) may be generated by the array of energy beam (e.g., wherein the energy beams at least tough or partially overlap). The touching or overlapping may be due to defocusing and/or tilting of the energy beam array platform. The bulk feature (e.g., covering) may be generated by an energy beam that is different from the energy beam(s) that generate the small scaffold feature (e.g., energy beam array).

The small-scaffold features provided herein can be a mesh of interconnected fibers that can support each other. Such fibers can be carbon fibers, titanium fibers, or glass fibers. The small-scaffold features can form a woven mesh, for example, a woven mesh of carbon fibers. At least two of the wires (e.g., fibers) comprising the small-scaffold may be interlaced, interweaved, alternated, entwined, braided, weaved, contacted, bordered, touching, or any combination thereof. The wires (e.g., fibers) comprising the small-scaffold may form a pattern comprising lines that are arranged in crisscross, zigzag, parallel, or any combination thereof. At least one of the wires (e.g., fibers) comprising the small-scaffold may be twisted, bended, waggling, waving, oscillating, or irregular. The small scaffold may comprise a mesh, a braid, a tangled arrangement, a network, or an intertwined arrangement of wires. The pattern may comprise separated wires or planes. The pattern may comprise touching wires or planes. The pattern may be linear or non-linear. The pattern may comprise wires or planes of FLSs. The wires or planes may comprise a variation. The wires or planes within the small scaffold may vary. The variation may be in the microstructures, crystal structures, or metallurgical structures. The variation may be in the FLSs of the wires or planes comprising the small scaffold feature. The variation may be in relative angles of the wires or planes. The variation may be in the respective distance between the wires or planes. The variation may depend on the respective wire or plane position (e.g., relative position) within the small scaffold feature. The variation may depend on the position of the wire or plane within the 3D object with respect to a selected position or selected area. The selected position or selected area may be any selected position or area disclosed herein (e.g., edge, king, crossing, rim, ledge, or bridge). The variation may be in a FLS of the microstructures. The variation may follow a mathematical series. The variation may follow a power series (e.g., a Taylor series). The power series may be a geometric series. The pattern may follow a logarithmic series. The pattern may follow a trigonometric series (e.g., Fourier series). The pattern may follow a Laurent or Dirichlet series. The series may be converging or diverging. The series may be a telescopic series. The series may be a linear series, arithmetic series, geometric series, arithmetic-geometric series, exponential series, logarithmic series, or any combination thereof. The logarithmic series may be a natural logarithmic series. The exponential series may be a natural exponential series.

In some cases, the small-scaffold features can be inside a cross section of the macroscopic features. The macroscopic features can be non-dense with a non-dense space filled with the small-scaffold features. Small-scaffold features can connect two or more surfaces of a macroscopic feature. In some cases the small-scaffold features can be enclosed by the macroscopic features. The small-scaffold features can be fibers with a length of at most about a dimension of a cross section of a macroscopic features.

The 3D objects with macroscopic and small-scaffold features can be generated using an additive manufacturing process.

The additive manufacturing process can be performed with an additive manufacturing system and/or apparatus comprising a material (e.g., powder) bed and at least one energy source (e.g., energy beam array). In some cases, the system and/or apparatus can be in an enclosure. The material bed may be situated on a platform. The platform may comprise a substrate and/or a base. The platform (or pats thereof) may be a work piece on which an object is formed on or from. A platform can include, without limitation, silicon, germanium, silica, sapphire, zinc oxide, carbon (e.g., graphene), SiC, AlN, GaN, spinel, coated silicon, silicon on oxide, silicon carbide on oxide, glass, gallium nitride, indium nitride, titanium dioxide, aluminum nitride, a ceramic material (e.g., alumina, AlN), a metallic material (e.g., molybdenum, tungsten, copper, aluminum), and combinations (or alloys) thereof. In some cases, a platform is part of a susceptor. In some examples, a platform comprises steel, stainless steel, or a titanium alloy. The platform can comprise any material suitable as a building material for the 3D object (e.g., as disclosed herein).

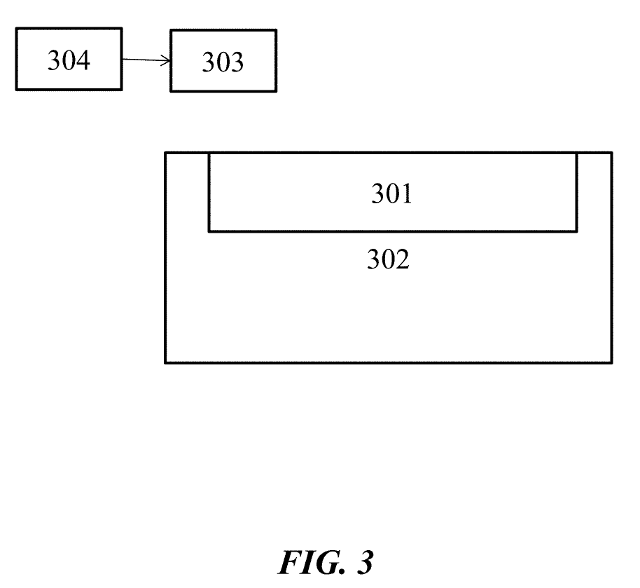

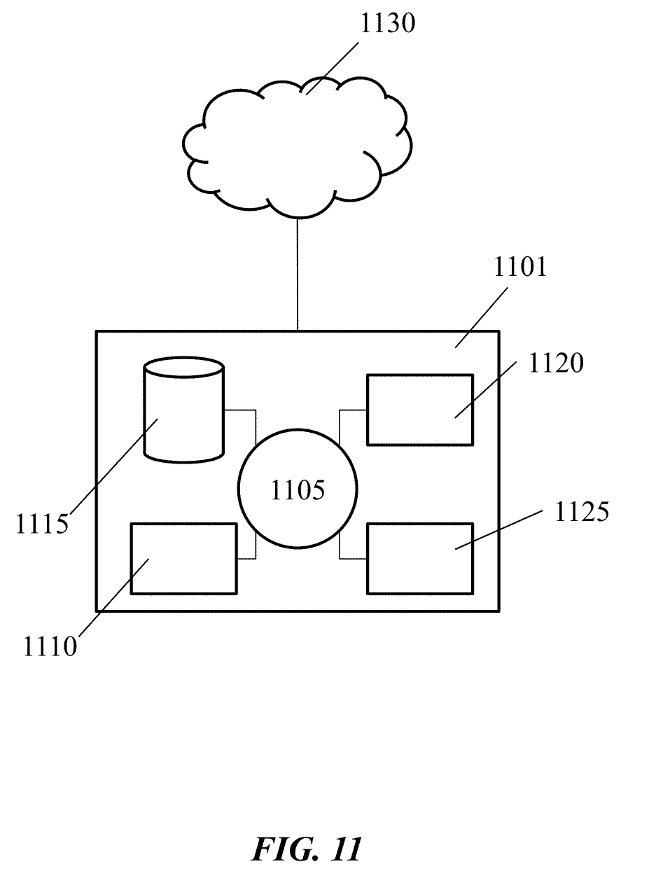

FIG. 3 shows a system that can be used to generate an object with macroscopic and small-scaffold features. The system can comprise a material (e.g., powder) bed 301. The material bed can be one or more layers of material (e.g., powder) adjacent to a platform 302. The system can be configured and/or adapted to provide one or more successive layers of material adjacent to a first layer of material while forming a 3D object. The one or more successive layers of material can be provided with a layer dispensing mechanism (e.g., recoater). The layer dispensing mechanism may comprise a material dispensing mechanism or material leveling mechanism. The layer dispensing mechanism (e.g., recoater) may include any layer dispensing mechanism and/or material dispensing mechanism (e.g., dispenser), material leveling mechanism. The system can be regulated using a controller. The controller may include a computer system, as described elsewhere herein (see, e.g., FIG. 11).

Energy can be provided by an energy source to the material bed 301 to form the 3D object. The application of energy (e.g., power and/or scan direction) can be regulated by a control system. Energy can be provided to the material layer to heat and/or transform at least a portion of the material (e.g., powder) layer. Energy can be provided via an energy source 303. A material layer can have uniform or non-uniform thickness.

Energy from the energy source can be directed to the material bed using optics. The optics can include a single lens or multiple lenses. In an example, the optics includes a single common lens. The apparatus and/or systems described herein may comprise an optical system. The optical components may be controlled manually or via a control system (e.g., a controller). The optical system may be configured to direct at least one energy beam from the at least one energy source to a position on the material bed within the enclosure (e.g., a predetermined position). A scanner can be included in the optical system. The various components of the optical system may include optical components comprising a mirror, a lens (e.g., concave or convex), a fiber, a beam guide, a rotating polygon or a prism. The lens may be a focusing or a dispersing lens. The lens may be a diverging or converging lens. The mirror can be a deflection mirror. The optical components may be tillable or rotatable. The mirror may be a deflection mirror. The optical components may comprise an aperture. The aperture may be mechanical. The optical system may comprise a variable focusing device. The variable focusing device may be connected to the control system. The variable focusing device may be controlled by the control system, or manually. The variable focusing device may comprise a modulator. The modulator may comprise an acousto optical modulator, mechanical modulator, or an electro optical modulator. The focusing device may comprise an aperture (e.g., a diaphragm aperture).

At least a portion of the material layer can be irradiated by the energy source (e.g., energy beam) 303. The energy source can be an electromagnetic beam, electron beam, ion beam, proton beam, or plasma beam. In some cases, the energy source can be a laser beam or a microwave beam. The energy source can have a single emission source or multiple emission sources. The energy source can be a single head laser or a multi-head laser. The multi-head laser can be a linear array of laser diodes or an n×m matrix of laser diodes.

The energy beam can be controlled and/or regulated by a controller (e.g., comprising a computer system) 304. The controller can regulate and/or control the energy beam. For example, the controller may instruct the energy beam to scan the surface of the material bed to form a 3D object. The controller can control and/or regulate the energy beam based on an input from a user, a software, a sensor, or any combination thereof. The input can describe a desired 3D object (e.g., by the user, and/or by a customer).

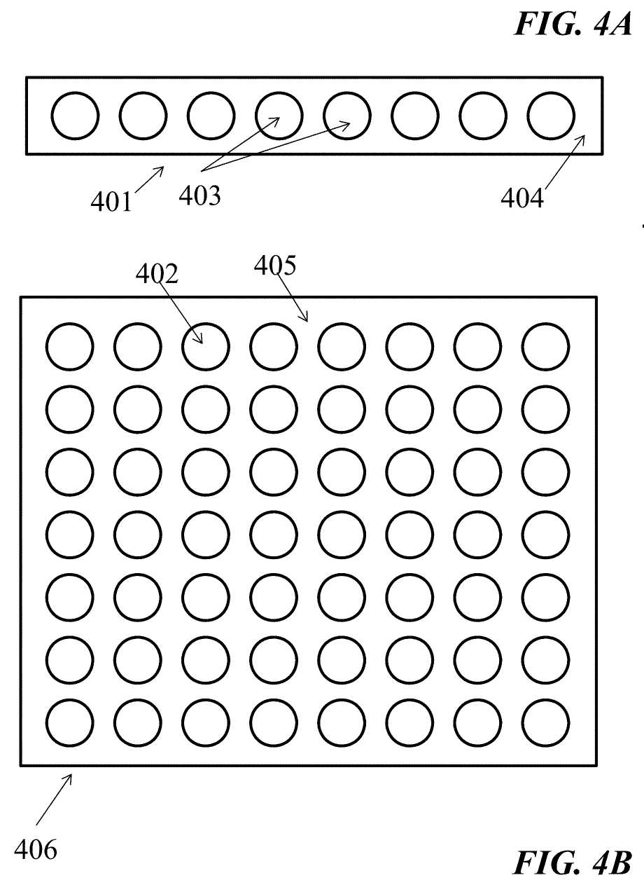

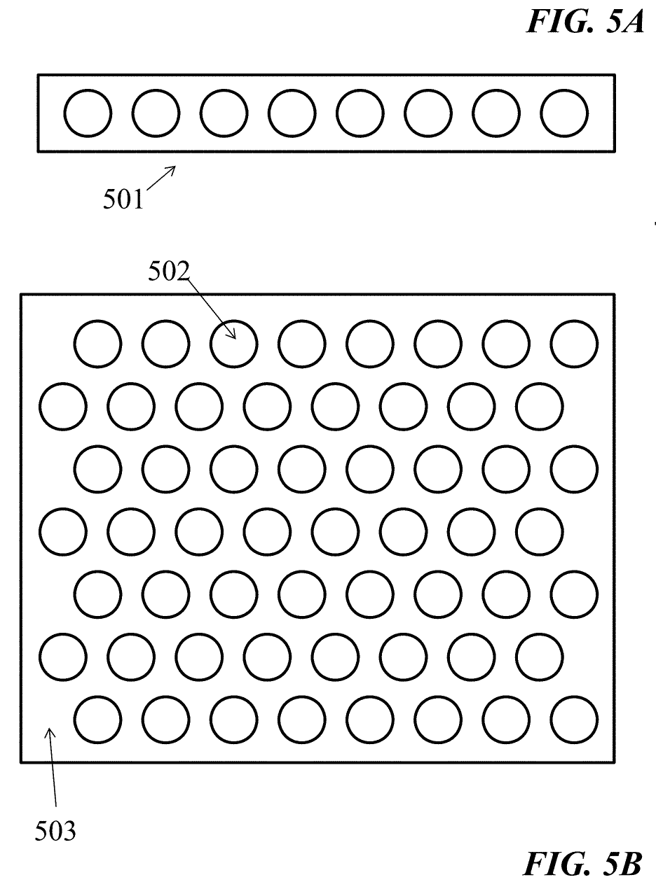

FIG. 4A shows an example of an array of energy sources (e.g., laser diodes) 401 that can irradiate at least a portion of the material layer as described herein. The array of energy sources can comprise a linear array of energy sources comprising at least two energy sources 403 that are arranged in a platform 404. Alternatively the energy sources in the array can be staggered or irregularly aligned. The array of energy sources can have a horizontal, vertical, or slanted orientation with respect to an edge of the powder bed. FIG. 4B shows an example of a matrix of energy sources 406 that can irradiate at least a portion of the material layer as described herein. The matrix can have a number of rows, n, and a number of columns, m, where ‘n’ and ‘m’ can each be greater than or equal to one. In some cases, ‘n’ is greater than or equal to one and ‘m’ is greater than or equal to two. The matrix can have one or more rows. The matrix can have one or more columns. In some example, ‘n’ is at least 1, 2, 3, 4, 5, 6, 7, 8, 9, 10, 20, 30, 40, 50, or 100, and ‘m’ is at least 2, 3, 4, 5, 6, 7, 8, 9, 10, 20, 30, 40, 50, or 100. FIG. 4B shows an example of an aligned matrix. FIG. 5B shows an example of a matrix in which the rows of energy sources (e.g., 502) arranged in the platform 503 are staggered.

The energy sources in the multi-head energy source (e.g., array or matrix) can have substantially identical energy source properties. For example, substantially identical power and/or beam FLS. In some cases at least two of the energy sources in the multi-head energy source can have different energy source properties. Each of the laser diodes can have a power that is at least about 0.5 W, 1 W, 2 W, 3 W, 4 W, 5 W, 10 W, 20 W, 30 W, 40 W, 50 W, 60 W, 70 W, 80 W, 90 W or 100 W. Each of the energy sources can have a power that is at most about 0.5 W, 1 W, 2 W, 3 W, 4 W, 5 W, 10 W, 20 W, 30 W, 40 W, 50 W, 60 W, 70 W, 80 W, 90 W or 100 W. At least one of the energy sources can have a power from 0.5 Watts (W) to about 100 W, 1 W to 50 W, or 2 W to 20 W. At least one of the energy sources can have a power that is between any of the afore-mentioned powers (e.g., from about 100 W to about 0.5 W, from abut 100 W to about 50 W, from about 0.5 W to about 50 W, or from about 0.5 W to about 20 W). At least one of the energy sources can have a power from 0.5 Watts (W) to about 100 W, 1 W to 50 W, or 2 W to 20 W. At least to of the energy sources (e.g., laser diodes) within the energy beam array can be independently controlled and/or regulated. For example, in an array of energy beams (e.g., energy sources) the power, focus, angle (e.g., with respect to the average exposed surface of the material bed) of each individual energy beams can be regulated and/or controlled separately from other energy beams in the array.

One or more additional energy sources can be provided. The one or more additional energy source can be controlled independently with respect to the array. In some cases, the one or more additional energy sources can be used to form other features, such as features that are separate from the small-scaffold features. In an example, the one or more additional energy sources are used to form the cover or perimeter (e.g., rim) around at least a portion of the small-scaffold features.

One or more of the energy sources within the array can be incident on a portion of the material bed for a fixed time interval. In some cases energy beam (e.g., of the array and/or the additional energy source(s)) can be pulsed with a frequency (e.g., predetermined) while incident on the portion of the material bed. The energy beam (e.g., from an individual laser diode) can be pulsed with a dwell time having a value equal to the value of the duration of an individual pulse disclosed herein. In some instances, the dwell time is substantially equal to the pulse duration. In some instances, the dwell time is different from the pulse duration. The energy beam power and dwell time can be modulated to deliver a desired or predetermined power density to the material (e.g., powder) layer in the material bed. While forming the 3D object, at least one of the energy beams in the array can provide energy to the material layer (e.g., in the material bed). Different energy beams in the array provide energy at different times to form a desired or predetermined pattern from at least a portion of the material layer (e.g., in the material bed). The array of energy beams may be arranged as a single file of energy beams (e.g., energy sources) or as a matrix of energy beams (e.g., energy sources).

In some cases, the energy beam can be reflected off of one or more mirrors before being incident on the material bed. The mirrors can tilt and/or pivot to direct the energy beam to different portions of the material bed. The object can be generated by directing the energy beam to one or more layers along a vector pattern. In some cases, the object can be generated by directing the energy beam to one or more layers along a raster scan pattern.

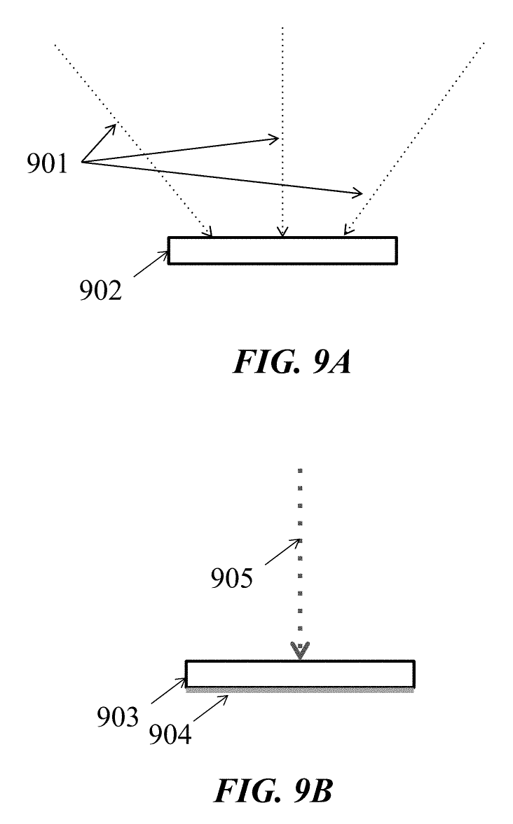

One or more energy beams (e.g., energy beams emitted by laser diodes) can be focused through a lens before being incident on the material bed. The lens can be positioned close to the surface of the material bed. The distance between the exposed surface of the material bed and the lens can be at least about 10 cm, 5 cm, 1 cm, 5000 μm, 1000 μm, 500 μm, 100 μm, 75 μm, 50 μm, 40 μm, 30 μm, 20 μm, 10 μm, 9 μm, 8 μm, 7 μm, 6 μm, 5 μm, 4 μm, 3 μm, 2 μm, 1 μm, 0.5 μm, 0.1 μm, 0.05 μm, 0.01 μm, or 0.005 μm. The distance between the exposed surface of the material bed and the lens can be at most about 10 cm, 5 cm, 1 cm, 5000 μm, 1000 μm, 500 μm, 100 μm, 75 μm, 50 μm, 40 μm, 30 μm, 20 μm, 10 μm, 9 μm, 8 μm, 7 μm, 6 μm, 5 μm, 4 μm, 3 μm, 2 μm, 1 μm, 0.5 μm, 0.1 μm, 0.05 μm, 0.01 μm, or 0.005 μm. The distance between the exposed surface of the material bed and the lens can any value between the aforementioned values (e.g., from about 0.005 μm to about 10 cm, from about 0.005 μm to about 5000 μm, from about 5000 μm, to about 10 cm, or from about 100 μm, to about 1 cm). The average distance between the platform of the energy beam array to the exposed surface of the material bed may be of a value equal to any of the values of the distance between the exposed surface of the material bed and the lens mentioned herein. FIG. 9A shows a plurality of energy beams 901 focused through a lens 902. In FIG. 9A the lens can have a clean surface facing the material bed. The lens may comprise a cleaning apparatus. The lens may comprise a coating that deters debris from clinging onto the lens.

Heated and/or melted powder material can condense on a surface of the lens during formation of the 3D object. FIG. 9B shows a lens 903 with a layer of condensed material (e.g., debris) 904. The condensed powder can form a material layer on the lens. The condensed layer can decrease optical transmission through the lens. The condensed layer can decrease optical properties of the lens. An ablation 905 energy beam (e.g., laser) can be provided to remove the condensed layer to provide a clean lens surface. The ablation energy beam can be the same energy beam used for forming the 3D object. Alternatively, the ablation laser can be a different energy beam that is not the energy beam used for forming the 3D object. The power of the ablation energy beam can be higher than the power provided by the energy beam used for forming the 3D object. The ablation energy beam can be spaced a distance from the lens such that the ablation energy beam focuses on the surface of the lens where the condensed layer forms. In some cases the distance between the ablation energy beam and the lens can be adjusted (e.g., using the controller).

In some examples, a system and/or apparatus for additively generating a 3D object with small-scaffold features comprises a platform that accepts a layer of a pre-transformed material (e.g., powder) and a source of the pre-transformed material that supplies the pre-transformed material to the platform. The system and/or apparatus further can include at least one energy source that provides energy to at least a portion of the layer in the material bed.

The system and/or apparatus may further include a controller that is in communication with the energy source(s). The control system may regulate the application of energy from the energy source to the layer along a vector pattern to form the 3D with small-scaffold features. The small-scaffolds can be spaced apart by most about 50 mm, 10 mm, 5 mm, 1 mm, 0.5 mm, 100 μm, 50 μm, 40 μm, 30 μm, 25 μm, 20 μm, 15 μm, 10 μm, 5 μm, 1 μm, 500 nm, 400 nm, 300 nm, 200 nm, 100 nm, or 50 nm. The small-scaffolds can be spaced apart by at least about 50 mm, 10 mm, 5 mm, 1 mm, 0.5 mm, 100 μm, 50 μm, 40 μm, 30 μm, 25 μm, 20 μm, 15 μm, 10 μm, 5 μm, 1 μm, 500 nm, 400 nm, 300 nm, 200 nm, 100 nm, or 50 nm. The small-scaffolds can be spaced apart by any value between the afore-mentioned values (e.g., from about 50 nm to about 1 mm, from about 50 nm to about 1 μm, from about 1 μm, to about 100 μm, or from about 100 μm, to about 50 mm).

The enclosure (e.g., chamber) can be in fluid communication with a fluid flow system, such a pumping system for maintaining the chamber at a given pressure. In some cases the chamber pressure can be standard atmospheric pressure. For instance, the chamber can be under an inert and/or non-reactive atmosphere, which can be provided by providing an inert and/or non-reactive gas (e.g., Ar) in and/or flowing the inert and/or non-reactive gas through the chamber.

The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valve-less pump, steam pump, gravity pump, eductor-j et pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump. In some examples, the systems and/or the apparatus described herein include one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector.

The system and/or apparatus may comprise one or more sensors. The sensor can be a proximity sensor. For example, the sensor can detect the amount of pre-transformed (e.g., powder) material deposited in the material bed (or on the platform). The sensor can detect the physical state of material deposited. The sensor can detect the crystallinity of material deposited. The sensor can detect the amount of material deposited. The sensor can detect the temperature of the material (e.g., within the powder bed, and/or within the material dispenser). The sensor may detect the temperature of the 3D object (or a portion thereof). The sensor may detect the temperature and/or pressure of the atmosphere within an enclosure.

The at least one sensor can be operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, or electromagnetic signal. The electromagnetic signal may comprise a visible, infrared, ultraviolet, ultrasound, radio wave, or microwave signal. The metrology sensor may measure the tile. The metrology sensor may measure the gap. The metrology sensor may measure at least a portion of the layer of material. The layer of material may be a pre-transformed material (e.g., powder), transformed material, or hardened material. The metrology sensor may measure at least a portion of the 3D object. The sensor may include temperature sensor, weight sensor, powder level sensor, gas sensor, or humidity sensor. The gas sensor may sense any of the gas delineated herein. The temperature sensor may comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, or Pyrometer. The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the material bed can be monitored by one or more weight sensors in, or adjacent to, the material. For example, a weight sensor in the material bed can be at the bottom of the material bed. The weight sensor can be between the bottom of the enclosure (e.g., FIG. 1, 111) and the substrate (e.g., FIG. 1, 109) on which the base (e.g., FIG. 1, 102) or the material bed (e.g., FIG. 1, 104) may be disposed. The weight sensor can be between the bottom of the enclosure and the base on which the material bed may be disposed. The weight sensor can be between the bottom of the enclosure and the material bed. A weight sensor can comprise a pressure sensor. The weight sensor may comprise a spring scale, a hydraulic scale, a pneumatic scale, or a balance. At least a portion of the pressure sensor can be exposed on a bottom surface of the material bed. In some cases, the weight sensor can comprise a button load cell. The button load cell can sense pressure from powder adjacent to the load cell. In another example, one or more sensors (e.g., optical sensors or optical level sensors) can be provided adjacent to the material bed such as above, below, or to the side of the material bed. In some examples, the one or more sensors can sense the powder level. The material (e.g., powder) level sensor can be in communication with the material dispenser. Alternatively, or additionally a sensor can be configured to monitor the weight of the material bed by monitoring a weight of a structure that contains the material bed. One or more position sensors (e.g., height sensors) can measure the height of the material bed relative to the platform (e.g., at various positions). The position sensors can be optical sensors. The position sensors can determine a distance between one or more energy beams (e.g., a laser or an electron beam) and a surface of the material (e.g., powder). The one or more sensors may be connected to a control system (e.g., to a processor, to a computer).

The systems and/or apparatuses can include an additional energy source that provides energy independently of the energy source. The energy source (e.g., array) can be usable to generate the small-scaffold features. Any additional energy source can be usable to generate a bulk feature (e.g., perimeter of the 3D object).

A scan direction of the vector pattern can be selected such that a projected distance between adjacent individual energy sources (e.g., gap) in the array along a scan direction is tunable to match a spacing (e.g., pitch) between individual small-scaffold features. The gap can be adjustable. The gap can be fixed. The gap can be automatically or manually adjusted. The gap can be regulated by a controller. In some cases, the array is rotatable (e.g., the array platform) such that a projected distance between individual energy sources in the array along a scan direction is tunable to match a spacing between individual small-scaffold features. The rotation direction and/or angle can be regulated by the controller (e.g., manually or automatically). For example, the array is rotatable along an axis that is angled (e.g., perpendicular) with respect to a plane of the layer.

The system can include a scanning member that directs energy from the energy source to the layer along the vector pattern. The scanning member can guide (e.g., move, tilt and/or rotate) the energy source. The energy beam(s), energy source(s), and/or the platform of the energy beam array can be moved via the scanning member. The scanning member may comprise a galvanometer scanner, a polygon, a mechanical stage, or any combination of thereof. The scanning member can be, for example, a piezoelectric device, gimble, X-Y stage, or any combination thereof. For example, the scanning member can be a combination of a galavanometer (e.g., for speed) and an X-Y stage (e.g., for range of motion). The galvanometer may comprise a mirror. The galvanometer scanner may comprise a two-axis galvanometer scanner. The scanner may comprise a modulator (e.g., as described herein). The scanner may comprise a polygonal mirror. The scanner can be the same scanner for two or more energy sources and/or beams. At least two (e.g., each) energy source and/or beam may have a separate scanner. A scanning member (e.g., scanner) can direct energy from the energy source to the material bed.

The energy sources can be translated independently of each other. In some cases at least two energy sources and/or beams can be translated at different rates, and/or along different paths. For example, the movement of a first energy source may be faster as compared to the movement of a second energy source. The systems and/or apparatuses disclosed herein may comprise one or more shutters (e.g., safety shutters), on/off switches, or apertures.

The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

The control system can direct the individual energy sources to supply energy to the layer in pulses. The duration of an individual pulse can be at least about 0.1 μsec, 0.5 μsec, 1 μsec, 2 μsec, 3 μsec, 4 μsec, 5 μsec, 10 μsec, 20 μsec, 30 μsec, 40 μsec, 50 μsec, 60 μsec, 70 μsec, 80 μsec, 90 μsec, or 100 μsec. The duration of an individual pulse can be at most about 0.1 μsec, 0.5 μsec, 1 μsec, 2 μsec, 3 μsec, 4 μsec, 5 μsec, 10 μsec, 20 μsec, 30 μsec, 40 μsec, 50 μsec, 60 μsec, 70 μsec, 80 μsec, 90 μsec, or 100 μsec. The pulses can have pulse durations between any of the abovementioned durations (e.g., from about 0.5 microseconds (μsec) to about 100 μsec, or from about 1 μsec to about 10 μsec).

The energy pulse can have a dwell time can be at least about 0.01 μsec, 0.1 μsec, 0.5 μsec, 1 μsec, 2 μsec, 3 μsec, 4 μsec, 5 μsec, 10 μsec, 20 μsec, 30 μsec, 40 μsec, 50 μsec, 60 μsec, 70 μsec, 80 μsec, 90 μsec, 100 μsec, 500 μs, 1000 μs, 5000 μs, or 10000 μs. The dwell time can be at most about 0.01 μsec, 0.1 μsec, 0.5 μsec, 1 μsec, 2 μsec, 3 μsec, 4 μsec, 5 μsec, 10 μsec, 20 μsec, 30 μsec, 40 μsec, 50 μsec, 60 μsec, 70 μsec, 80 μsec, 90 μsec, 100 μsec, 500 μs, 1000 μs, 5000 μs, or 10000 μs. The dwell time can be between any of the abovementioned durations (e.g., from about 0.01 microseconds (μsec) to about 10000 μsec, from about 1 μsec to about 10 μsec, from about 0.01 μs to about 100 μs, or from about 100 μs to about 10000 μs).

An individual energy source can be directed to the layer through an energy beam. The energy beam can have a footprint measured on the exposed surface of the material bed, having a FLS from about 0.3 μm to about 100 μm, or from about 1 μm to about 50 μm. The energy beam can have a footprint measured on the exposed surface of the material bed, having a FLS of at least about 0.005 μm, 0.01 μm, 0.05 μm, 0.1 μm, 0.2 μm, 0.3 μm, 0.4 μm, 0.5 μm, 1 μm, 2 μm, 3 μm, 4 μm, 5 μm, 10 μm, 20 μm, 30 μm, 40 μm, 50 μm, or 100 μm. The energy beam can have a footprint measured on the exposed surface of the material bed, having a FLS of at most about 0.005 μm, 0.01 μm, 0.05 μm, 0.1 μm, 0.2 μm, 0.3 μm, 0.4 μm, 0.5 μm, 1 μm, 2 μm, 3 μm, 4 μm, 5 μm, 10 μm, 20 μm, 30 μm, 40 μm, 50 μm, or 100 μm. The energy beam can have a footprint measured on the exposed surface of the material bed, having a FLS having any value between the afore mentioned FLS values (e.g., from about 0.005 μm to about 100 μm, from about 0.005 μm to about 0.1 μm, from about 0.1 μm to about 2 μm, from about 2 μm to about 5 μm, from about 5 μm to about 20 μm, or from about 20 μm to about 100 μm). The footprint of the energy beam may follow a Gaussian bell shape.

The enclosure (e.g., chamber) can be a gaseous environment with a controlled pressure, temperature, and/or gas composition. The gas composition in the environment contained by the chamber can be substantially oxygen free environment. For example, the gas composition can contain less than about 100 parts per million (ppm) oxygen, 10 ppm oxygen, or 1 ppm oxygen. Similarly the gas composition in the environment contained in the chamber can be a substantially moisture (e.g., water) free environment. The gaseous environment can comprise at most 100 ppm, 10 ppm, or 1 ppm water. The gaseous environment can comprise a gas selected from the group consisting of argon, nitrogen, helium, neon, krypton, xenon, hydrogen, carbon monoxide, carbon dioxide, or any combination of the listen gases.

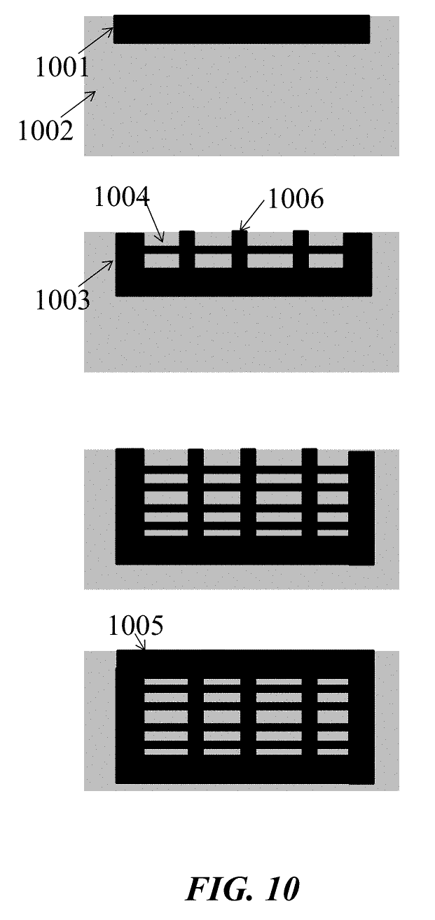

The additive manufacturing systems and/or apparatuses described can be used to form an object with macroscopic and/or small-scaffold features. FIG. 10 shows an example of a schematic diagram of the formation of an object with macroscopic and small-scaffold features. The schematics in FIG. 10 can be cross-sectional views of a material (e.g., powder) bed in an additive manufacturing system at different time intervals during the formation of an object. In the process a feature 1001 of the object can be formed in a powder bed 1002. The feature 1001 can be an outer surface of the object. The feature 1001 can be a fraction of a macroscopic structure. The feature 1001 can be an outer surface of the object. The feature 1001 can be formed by transforming a portion of a layer of the material bed 1002. Successive layers of pre-transformed material (e.g., powder) can be provided and irradiated by an energy beam to form additional outer walls such as 1003 and interior small-scaffold structures 1006 in the object that comprises cavities (e.g., 1004). The small scaffold structures 1006 can be formed. The outer walls 1003 and small-scaffold structures 1006 can be formed by the same energy beam (e.g., same energy beam array) or by different energy beams (e.g., energy beam array). The energy beam can operate at a first power density (e.g., energy and/or time) while forming the macroscopic structures 1003 and a second power density while forming the small-scaffold features 1006. The power densities can differ with respect to applied energy and/or exposure time. The first and second power densities can be identical or different. The first power density can be higher than the second power density. A third power density can be used to generate the outer walls, the third power density can be higher than the first and second power density. An additional (e.g., bulk) feature 1005 can be formed to enclose the small-scaffold structures. In some cases, the second feature 1005 can be an external surface of the object. Alternatively, the second (e.g., bulk) feature can be internal to the object.

An object with macroscopic and one or more small-scaffold features (e.g., types) can be formed in a layer-by-layer fashion. In some examples, a first layer of the object is formed along a pattern that is generated based on a design of the object. The layer can be formed by transforming at least a portion of a layer of pre-transformed (e.g., powder) material along a predetermined pattern (e.g., directional pattern). The method may further comprise cooling the layer (e.g., to a temperature below the transformation (e.g., melting) point of the powder material). A new layer of pre-transformed (e.g., power) material can be provided over the first layer and subsequently transformed along a (e.g., predetermined) pattern. The pattern may relate to a model design of a desired 3D object. The new layer can then be cooled. The layer wise process can be repeated as necessary (e.g., at least 1, 2, 3, 4, 5, 6, 7, 8, 9, 10, 100, 200, 300, 400, 500, 1000, or 10,000 times) to generate the 3D object.

The objects comprising small-scaffold structural features can have high or substantially high specific strength (e.g., strength to weight ratio). In some cases the 3D object can have a strength to weight ratio of at least about 5 kilo Newtons times meter per kilogram (kN*m/kg), 10 kN*m/kg, 20 kN*m/kg, 40 kN*m/kg, 60 kN*m/kg, 80 kN*m/kg, 100 kN*m/kg, 1000 kN*m/kg, 5000 kN*m/kg, 10000 kN*m/kg, 20000 kN*m/kg, 30000 kN*m/kg, 40000 kN*m/kg, or 50000 kN*m/kg. In some cases the 3D object can have a strength to weight ratio of at most about 5 kN*m/kg, 10 kN*m/kg, 20 kN*m/kg, 40 kN*m/kg, 60 kN*m/kg, 80 kN*m/kg, 100 kN*m/kg, 1000 kN*m/kg, 5000 kN*m/kg, 10000 kN*m/kg, 20000 kN*m/kg, 30000 kN*m/kg, 40000 kN*m/kg, or 50000 kN*m/kg. In some cases the 3D object can have a strength to weight ratio of any value between the aforementioned values (e.g., from about 5 kN*m/kg to about 50,000 kN*m/kg, from about 5 kN*m/kg to about 1000 kN*m/kg, from about 1000 kN*m/kg to about 50000 kN*m/kg, or from about 100 kN*m/kg to about 5000 kN*m/kg). The strength to weight ratio can be a ratio of a strength metric of the material, for example, the tensile strength or compressive strength of the material with respect to the weight of the material.

In some cases, the 3D object comprising the small-scaffold can have a higher tensile strength as compared to a similarly sized and/or shaped object made from the same bulk material as the small-scaffold 3D object. The small-scaffold 3D object can have a tensile strength of at least about 25 Mega Pascal (MPa), 50 MPa, 100 MPa, 500 MPa, 1000 MPa, 5000 MPa, or 10000 MPa. The small-scaffold 3D object can have a tensile strength of at most about 25 MPa, 50 MPa, 100 MPa, 500 MPa, 1000 MPa, 5000 MPa, or 10000 MPa. The small-scaffold 3D object can have a tensile strength between any of the abovementioned tensile strength values (e.g., from about 25 MPa, to about 10000 MPa, from about 25 MPa to about 1000 MPa, or from about 1000 MPa to about 5000 MPa). The tensile strength of the small-scaffold object can be measured by performing a materials test configured to determine tensile strength. For example, the tensile strength of the small-scaffold object can be measured with a uni-axial tensile test and/or a bi-axial tensile test. The tensile strength of the small-scaffold object can be measured with a universal tensile testing machine. The tensile strength of the small-scaffold object can be measured by applying a known tensile force and increasing the force until the object deforms plastically and/or until the object fails (e.g., breaks, fractures, or tears).

The small-scaffold object can have pockets of at least one gas (e.g., air). The pockets of gas (e.g., cavities) can be in the interior of the 3D object. The cavities can be inaccessible from an outer surface of the 3D object. The small-scaffold object can be porous. The small-scaffold object can have pockets of gas such that the object is not entirely dense (e.g., not entirely solid). The small-scaffold feature can have a porosity of at least about 1%, 5%, 10%, 20%, 30%, 40%, 50%, 60%, 70%, 80%, or 90%. Porosity can be a measurement of the amount of non bulk space in the small-scaffold object. The cavities can be a fraction of the volume of the small-scaffold object that is not filled by a transformed material that was used to form the 3D object. Porosity can be measured by a direct method, optical method, Computed tomography method (e.g., CT scan, MM, or Ultrasound), water evaporation method, mercury intrusion porosimitry, and/or a gas expansion method.

The 3D object comprising the small-scaffold can have a porosity such that the density of the small-scaffold object can be less than a density of an object formed of a bulk material that is the same material used to form the small-scaffold object with an equivalent volume to a volume of the small-scaffold object. The density of the 3D object comprising the small-scaffold can be at most about 90%, 80%, 70%, 60%, 50%, 40%, 30%, 20%, 10%, 5%, or 1% of the density of a volume equivalent 3D object formed of a bulk material (e.g., having the same or similar material used to form the 3D object comprising the small-scaffold feature).

A 3D object comprising a small-scaffold feature can have cavities with cross-sections that are circular, triangular, square, rectangular, pentagonal, hexagonal, or partial shapes and/or combinations thereof.

The cavity and/or cavity walls is included in the small scaffold feature may have a 3D shape. The multiplicity of cavity walls may form the scaffold structure. The 3D shape of the cavity and/or cavity walls may comprise a cuboid (e.g., cube), or a tetrahedron. The 3D shape may comprise a polyhedron (e.g., primary parallelohedron). The cavity and/or cavity walls may comprise a space-filling polyhedron (e.g., plesiohedron). The polyhedron may be a prism (e.g., hexagonal prism), or octahedron (e.g., truncated octahedron). The cavity and/or cavity walls may comprise a Platonic solid. The cavity and/or cavity walls may comprise a combination of tetrahedra and octahedra (e.g., that fill a space). The cavity and/or cavity walls may comprise octahedra, truncated octahedron, and cubes, (e.g., combined in the ratio 1:1:3). The cavity and/or cavity walls may comprise tetrahedra and/or truncated tetrahedra. The cavity and/or cavity walls may comprise convex polyhedra (e.g., with regular faces). For example, the cavity and/or cavity walls may comprise a triangular prism, hexagonal prism, cube, truncated octahedron, or gyrobifastigium. The cavity and/or cavity walls may comprise a non-self-intersecting quadrilateral prism. The cavity and/or cavity walls may comprise space-filling polyhedra. The cavity and/or cavity walls may exclude a pentagonal pyramid. The cavity and/or cavity walls may comprise 11-hedra, dodecahedra, 13-hedra, 14-hedra, 15-hedra, 16-hedron 17-hedra, 18-hedron, icosahedra, 21-hedra, 22-hedra, 23-hedra, 24-hedron, or 26-hedron. The cavity and/or cavity walls may comprise at least 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 faces. The cavity and/or cavity walls may comprise at most 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 faces. The cavity and/or cavity walls may comprise any number of faces between the aforementioned number of faces (e.g., from 4 to 38, from 4 to 20, from 20 to 40, or from 10 to 30 faces). The cavity and/or cavity walls may comprise a non-convex aperiodic polyhedron, convex polyhedron (e.g., Schmitt-Conway bi-prism). The cross-section of the cavity and/or cavity walls (e.g., vertical or horizontal) may be a square, rectangle, triangle, pentagon, hexagon, heptagon, octagon, nonagon, octagon, circle, or icosahedron. The cavity may be hollow. The cavity walls may comprise a dense material. The cavity walls may be composed of a transformed (e.g., and subsequently hardened) material. The cavity walls may comprise a material with high porosity. The cavity walls may comprise at least about 30%, 40%, 50%, 60%, 70%, 80%, 90% or 95% material. The cavity walls may comprise at most about 100%, 99%, 95%, 90%, 80%, 70%, 60%, or 50% material. The cavity walls may comprise a percentage of material corresponding to any percentage between the aforementioned percentages of material (e.g., the percent may be from 40% to 80%, from 50% to 99%, from 30% to 90%, or from 70% to 100% material). The cavity walls may comprise pores. The small scaffold structure may comprise an internal structure. The small scaffold structure may comprise one or more cavities. The layer of hardened material that is included in the 3D object may comprise a percentage of material having a value equal to the abovementioned percentages of material of the cavity walls. At least two of the cavities or cavity walls may have a substantially identical shape and/or cross section. At least two of the cavities or cavity walls may have a different shape and/or cross section. The cavity and/or cavity walls may be of substantially identical shape and/or cross section.

The cavity and/or cavity walls can be aligned with one another. As an alternative or in addition to, cavity and/or cavity walls can be angularly disposed in relation to one another.

Method of the present disclosure can be used to form 3D objects macroscopic and having small-scaffold features in a relatively short time frame. In some examples, the 3D object can be formed in a time frame that is at most about 2 days, 1 day, 12 hours, 6 hours, 5 hours, 4 hours, 3 hours, 2 hours, 1 hour, 30 minutes, 10 minutes, 5 minutes, 1 minute, or 30 seconds. The 3D object can be formed in a time frame that is any time frame between the above mentioned time frames (e.g., from about 30 seconds to about 2 days, from about 30 minutes to about 2 days, or from about 30 seconds to about 30 minutes). The time can vary based, for example, on the various properties of the 3D object, such as the size and/or porosity of the object.

Another aspect of the present disclosure provides roll-to-roll 3D printing systems and/or apparatuses, which can be used to generate 3D objects. The roll can comprise a motor. The motor can rotate in a circular motion. A roll-to-roll system and/or apparatus can include at least one platform that is directed from a payout roll to an uptake roll. A roll-to-roll system and/or apparatus can include a multiplicity of platforms (e.g., connected to each other to form an elongated platform) that are directed from a payout roll to an uptake roll. The system and/or apparatus may include at least one chamber between the payout roll and the uptake roll. The system and/or apparatus may be situated in an enclosure (e.g., in a chamber). The systems and/or apparatus may enable the additive generation of at least one 3D object (e.g., a multiplicity of 3D objects) adjacent to the platform(s) as the platform(s) moves from the payout roll to the uptake roll. The 3D object can be additively generated by providing a pre-transformed material (e.g., powder) adjacent to the platform and supplying energy to the pre-transformed material from one or more energy sources that are disposed along the platform (e.g., longitudinally and/or laterally). Energy can be supplied along a pattern (e.g., using an energy beam). The energy beam may travel along a vector and/or raster pattern. The multiplicity of energy beams can be arranged in an array (e.g., share a common platform). In some embodiments, the energy beams do not share a common platform.

The roll-to-roll system can be used to form an array and/or a collection of 3D objects. The array can include periodic and/or non-periodic domains. The 3D objects can include small-scaffold features. The array can span a longitudinal dimension (i.e., along the direction of roll movement) of at least about 0.1 meters (m), 0.5 m, 1 m, 2 m, 3 m, 4 m, 5 m, 6 m, 7 m, 8 m, 9 m, 10 m, 20 m, 30 m, 40 m, 50 m, 100 m, or 1000 m. The array can span a latitudinal dimension (i.e., along a direction that is perpendicular to the longitudinal dimension) that is at least about 0.1 meters (m), 0.5 m, 1 m, 2 m, 3 m, 4 m, 5 m, 6 m, 7 m, 8 m, 9 m, 10 m, 20 m, 30 m, 40 m, 50 m, 100 m, or 1000 m. The array of 3D object may comprise 2, 3, 4, 5, 6, 7, 8, 9, 10, 20, 30, 40, 50 60 70, 80, 90, 100, 1000, 10000, or 100000 3D object. The array may comprise any number of 3D object between the above mentioned numbers (e.g., from about 2 to about 100, from about 100 to about 1000, from about 1000 to about 10000, or from about 10000 to about 100000).

Systems, apparatuses and methods described herein can additively generate 3D objects. In some cases the 3D objects can be distributed in a honey comb pattern. The objects can comprise scaffolds. The scaffolds can be arranged a lattice pattern. The lattice may comprise substantially repeating units. The units may comprise cavity walls comprised of hardened material. the units may comprise cavities (e.g., filled with one or more gases, and/or non-transformed material such as powder). The lattice pattern can be a regular or irregular pattern. The lattice pattern can be a diamond, tetragonal, and/or cubic lattice. The 3D object can comprise a fiber, wire, shell, plate, or foil. In some cases, two or more 3D objects can be generated. The two or more 3D objects can be generated simultaneously or sequentially. The two or more 3D objects can be interconnected. The two or more objects can be separated by a gap. The gap may have dimensions of any gap disclosed herein. In some cases the 3D objects can comprise wall features. Wall features can at least partially enclose a cavity. In some cases, wall features can protrude from a surface of the 3D object such that they do not enclose a cavity. Wall or other features on the object can have a thickness that is at most to about 1 millimeter (mm), 0.5 mm, 0.2 mm, 0.1 mm, 0.05 mm, 0.02 mm, or 0.01 mm. Wall or other features on the object can have a thickness that is of any value between the aforementioned values (e.g., from 0.01 mm to 1 mm, from 0.01 mm to 0.1 mm, or from 0.05 mm to 0.5 mm).

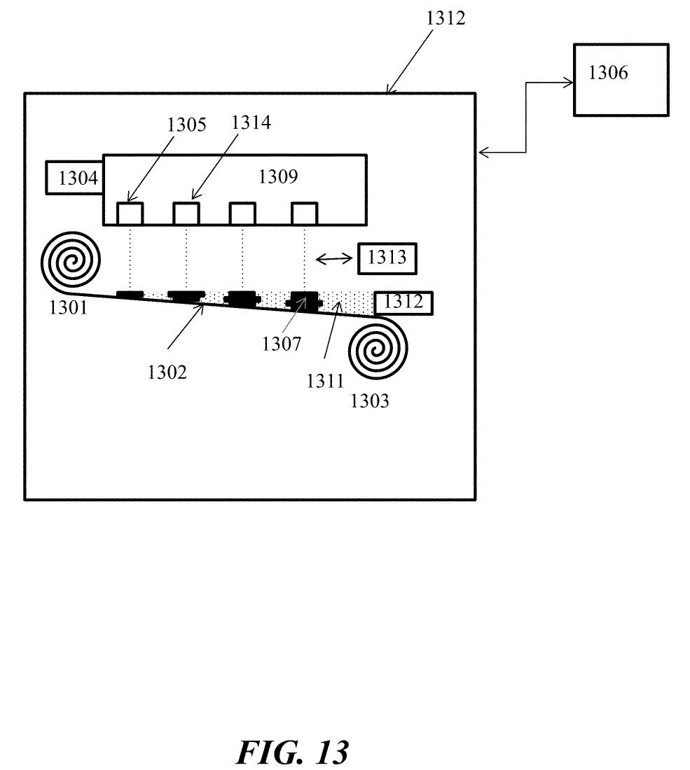

FIG. 13 shows an example of a schematic apparatus configured to generate a 3D object with roll-to-roll additive printing. One or more of the system components can be contained in a chamber 1312. The chamber can include a reaction space that is suitable for introducing precursor to form a 3D object, such as powder material 1311.

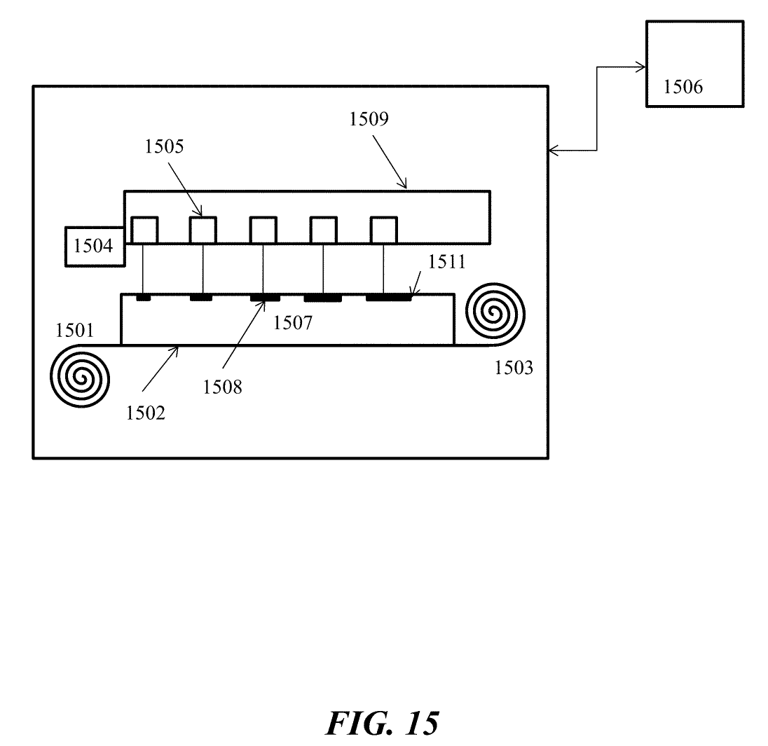

The system and/or apparatus can comprise a payout roll 1301 that retains a roll of a platform 1302. The payout roll can rotate and/or translate to cause movement of the platform. The payout roll can cause movement of the platform towards an uptake roll 1303. The payout roll and/or uptake roll can be situated horizontally above, at or below the surface of the platform. FIG. 15 shows an example in which the payout roll 1501 is situated below the platform 1502, and the uptake roll 1503 is situated above the platform 1502. The uptake roll can continuously or semi-continuously accept the platform from the payout roll during formation of the 3D object. The platform can move continuously, or in pulses. A pulsed movement includes a movement of the platform that is separated by periods of non-movement. The platform can move the various portions of the 3D objet from one station to another. In each station a different energy beam (e.g., 1305) may transform the pre-transformed material 1311 to form transformed material (e.g., that subsequently hardens into at least a portion of the 3D object). The platform can move from the payout roll to the uptake roll continuously or in discrete periodic pulses or movements. The platform can be a conveyor belt. The platform can be a part of a conveyor belt. The platform can be situated on a conveyor belt (e.g., fastened thereto). The platform can be detachable, exchangeable, and/or movable. The platform can be a belt such that when a section of the belt moves from the payout roll to the uptake roll the section of the belt returns to the payout roll and can repeat movement from the payout roll to the uptake roll. The uptake roll 1303 can accept the platform from the payout roll 1301. The payout roll and the uptake roll can be in a same horizontal and/or vertical plane. The payout roll and the uptake roll can be in different horizontal and/or vertical plane. The payout roll and the uptake roll can be separated by a distance of at least about 0.01 meters (m), 0.1 m, 1 m, 2 m, 3 m, 4 m, 5 m, 6 m, 7 m, 8 m, 9 m, 10 m, 20 m, 30 m, 40 m, 50 m, 100 m, 200 m, 300 m, 400 m, or 500 m. The payout roll and the uptake roll can be separated by a distance of at most about 0.01 m, 0.1 m, 1 m, 2 m, 3 m, 4 m, 5 m, 6 m, 7 m, 8 m, 9 m, 10 m, 20 m, 30 m, 40 m, 50 m, 100 m, 200 m, 300 m, 400 m, or 500 m. The payout roll and the uptake roll can be separated by a distance between any of the abovementioned distances (e.g., from about 0.01 m to about 500 m, from about 0.01 m to about 100 m, or from about 100 m to about 500 m).

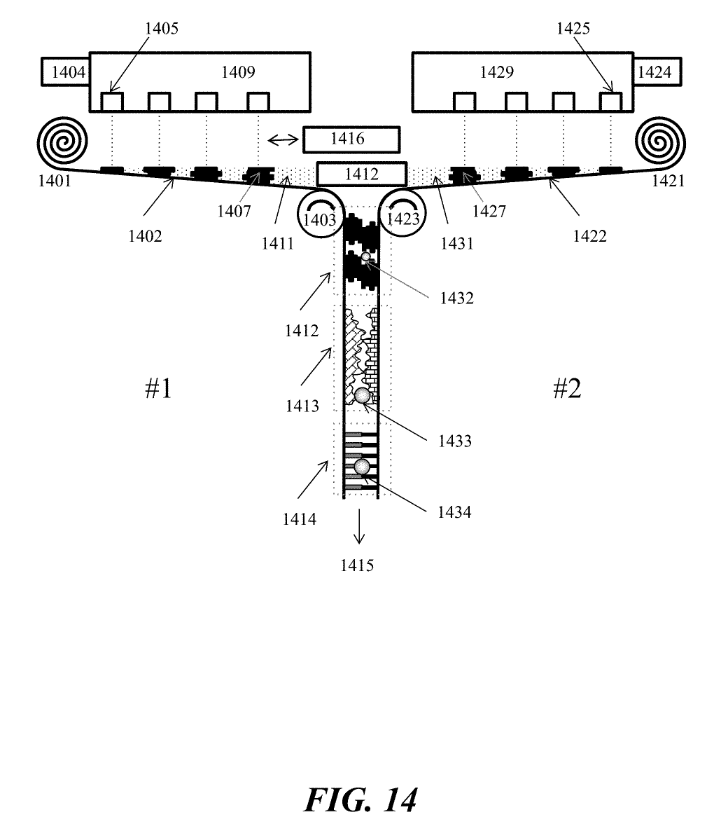

The platform may be flexible. The platform may be rolled on the payout and/or uptake roll. The conveyor belt may be rolled on the payout and/or uptake roll. In some examples, the platform may not be rolled on the payout and/or uptake roll. In some examples, the conveyor belt may not be rolled on the payout and/or uptake roll. FIG. 14 shows an example of a payout roll where the platform or the conveyor belt is rolled on the payout roll 1401, and not rolled on the uptake roll 1403. In some embodiments the payout and/or uptake roll may comprise a gear, tooth, or hook. The tooth or hook may cause the belt and/or platform to move as the roll rotates (e.g., payout and/or uptake).

The platform can be a sheet, belt, or platform. The platform can have a thickness (T1). The platform can have a thickness of at most about 1000 millimeters (mm), 100 mm, 10 m, 9 mm, 8 mm, 7 mm, 6 mm, 5 mm, 4 mm, 3 mm, 2 mm, 1 mm, 0.5 mm, 0.25 mm, 0.1 mm, 0.05 mm, 0.025 mm, or 0.01 mm. The platform can have a thickness of at least about 1000 mm, 100 mm, 10 m, 9 mm, 8 mm, 7 mm, 6 mm, 5 mm, 4 mm, 3 mm, 2 mm, 1 mm, 0.5 mm, 0.25 mm, 0.1 mm, 0.05 mm, 0.025 mm, or 0.01 mm. The platform can have a thickness between any of the aforementioned values (e.g., from about 0.025 mm to about 1000 mm). A layer that comprises at least a portion of the 3D object can be adjacent to the platform. The layer comprising the 3D object can have a second thickness (T2). The second thickness (T2) can be less than or equal to the platform thickness (T1). In some cases, the second thickness (T2) can be greater than or equal to 3*T1. In some cases, the second thickness (T2) can be greater than or equal to 10*T1. A total thickness (T3) of the 3D object can be about equal to a sum of the thickness of the platform (e.g., sheet) (T1) and/or the thickness of the layer comprising the 3D object (T2). The total thickness (T3) can be less than or equal to about 5 mm, 3 mm, 2 mm, 1 mm, 0.5 mm, 0.1 mm, 0.05 mm, 0.025 mm, 0.01 mm, or any value between (inclusive) of the aforementioned thickness values (e.g., from about 0.01 mm to about 5 mm, or from 1 mm to about 5 mm).

In some embodiments, the 3D object comprises a multiplicity of materials. For example, at least one layer of pre-transformed material in the material bed can be of a different material (e.g., in chemical formula, metallurgical structure, and/or crystal structure) than the previous pre-transformed material in the material bed.

The 3D objects can be formed adjacent to the platform. Alternatively, the 3D objects can be formed form at least a portion of the platform. As another alternative, the 3D objects can be formed to adhere to the platform but be separable from the platform. In some embodiments, the 3D object is suspended (e.g., float) in the material bed and does not contact the platform. In some embodiments, the 3D object is not anchored to any part of the enclosure (e.g., to the platform, and/or to the material bed walls)

The pre-transformed material (e.g., powder) can be at least partially enclosed in the enclosure (e.g., chamber). The enclosure can include a reaction space that is suitable for introducing precursor to form a 3D object, such as powder. In some cases the chamber can be a vacuum chamber, a positive pressure chamber, or an ambient pressure chamber. Alternatively the chamber can be a gaseous environment with a controlled pressure, temperature, and/or gas composition.

One or more layers of pre-transformed material (e.g., powder) 1311 can be provided on the platform by a pre-transformed material supply member 1313. The pre-transformed material supply member may comprise a reservoir and/or an exit opening though which the pre-transformed material can exit the material supply member and be disposed adjacent to the platform to form a material bed. A pre-transformed material can be provided to the platform at one or more locations along the platform. The pre-transformed material can be provided to the platform at one or more locations between the payout roll and the uptake roll. The pre-transformed material can be supplied in predetermined amounts and/or at predetermined time intervals. The pre-transformed material can be provided to the platform as the platform moves from the payout roll to the uptake roll. The pre-transformed material in the material bed 1311 (e.g., situated adjacent to the platform) can comprise a plurality of pre-transformed material layers. The pre-transformed material layers can have a thickness L1. A total thickness of all the pre-transformed material layers can have a thickness of L2. In some cases the total pre-transformed material thickness L2 can vary between the payout roller and the uptake roller. The number of pre-transformed material layers can be an integer n, where n=L2/L1 at any given location in the powder.

In some embodiments, platform is slanted (e.g., with respect to the horizon, and/or with respect to the plane normal to the direction of the gravitational force). The platform may be slanted such that the pre-transformed material that forms the material bed does not slide spontaneously. An example of a slanted platform(s) can be seen in FIG. 13, 1302.

The systems and/or apparatus may comprise a material evacuating member (e.g., 1312). The material evacuating member may comprise a force that attracts the pre-transformed material from the material bed. The force may comprise electronic, magnetic, or vacuum force. The material evacuating member may comprise an entrance port from which the material enters the material evacuating member from the powder bed. In some embodiments, the material is allowed to fall off the powder bed in a position adjacent to the uptake roll. The falling material may be collected by a colleting mechanism. The collecting mechanism may comprise a reservoir. The collecting mechanism may comprise a vacuum pump. The collecting member may comprise at least one obstruction that prevents from the at least a portion of the 3D object from being collected, but allows any pre-transformed material in the material bed to be collected. The obstruction may comprise a mesh, or a plane comprising one or more holes.

The energy source or one or more energy sources can provide power at a constant or variable power. At least two of the plurality of energy sources are provided energy beams having different power. At least two of the plurality of energy beams can have different power. In some cases, two or more of the energy sources can operate at substantially the same power.

The n×m array or matrix of energy sources can be oriented along a distance between the payout roll and the uptake roll. The n×m array or matrix of energy sources can comprise at least a first energy source and a second energy source. The first energy source and the second energy source can be oriented longitudinally with respect to a direction of movement of the platform. In some cases, the first and second energy source can be oriented laterally with respect to a direction of movement of the platform. The n×m array or matrix can oriented adjacent to at least a portion of a surface of the platform. The n×m array or matrix can oriented adjacent to at least a portion of a powder layer surface on the platform.

The energy source 1305 can provide energy to at least a portion of the pre-transformed material as the platform moves from the payout roll to the uptake roll. The system and/or apparatus can additionally comprise another energy source that can provide energy to the pre-transformed material independently of the energy source 1305. The pre-transformed material can rest on the platform such that movement of the platform causes movement of at least a portion of the pre-transformed. The pre-transformed material can rest on the platform such that movement of the platform does not substantially move the pre-transformed in the material bed. In some cases one or more energy sources can be provided in a matrix or an array along a distance traveled by the platform between the payout roll and the uptake roll. The one or more energy sources can supply energy to the same portion of the pre-transformed material at different time intervals. When energy is supplied to at least a portion of the pre-transformed material by the energy source the portion of the pre-transformed material that receives the energy source can have a temperature increase. In some cases the portion of the pre-transformed material that receives the energy source can undergo a transformation such as a phase change (e.g., melt). At least one additional layer of pre-transformed material can be provided over the portion of the pre-transformed material between energy supply from a first and second energy source.

The energy source or energy sources can operate in an “on” mode and an “off” mode. In “on” mode the energy source can provide continuous, pulsed, or quasi-continuous energy beam. The beam can be scanned over at least a portion of the pre-transformed material bed in a predetermined pattern. The beam can be “on” while it is continuously scanning. The beam can modulate between the “on” mode while the platform is in a stationary location and the “off” mode while the platform is moving. In some cases the energy source can provide a pulsed energy emission when the energy source is operating in “on” mode.

The energy pulses can be locked in to a predetermined frequency, or vary in frequency (e.g., linearly, exponentially, or logarithmically). In cases where the system comprises two or more energy sources pulse energy emissions from the two or more energy sources can be synchronized. Alternatively, the pulse energy emissions from the two or more energy sources can be independent of each other and/or not synchronized. The dwell time can comprise a time that the energy source is dwelling (e.g., incident) on a given point and/or portion of the material bed. Alternatively the dwell time can comprise a time that it takes the energy source to traverse a beam spot size in situations where the energy source is moving continuously.

A lens can be in optical communication with at least one energy source. The lens can direct energy from the at least one energy source to the material bed. The lens can focus an energy beam emitted from the at least one energy source on or near the exposed surface of the material bed. In some cases the energy source can comprise a plurality of energy sources. At least two of the plurality of energy sources (e.g., all of the energy sources) can be simultaneously or independently controlled. A at least one lens can be in optical communication with the plurality of energy sources. In some cases a plurality of lenses can be provided to the plurality of energy sources. A distance between a lens and at least one energy source can be adjustable (e.g., manually, automatically such as by a controller). A position of the one or more energy sources can be modulated by a scanning member 1304 (e.g., a scanner). The scanning member can direct energy from the at least one energy sources to at least a portion of the powder along a pattern. The pattern can be a predetermined pattern.

The system and/or apparatus can comprise a controller 1306. The controller can be in communication with a component comprising an energy source, pre-transformed material dispenser, uptake roll, payout roll, material evacuating member, material collecting member, lens, scanner, or energy beam. The controller can control and/or regulate the application of energy from the energy source 1305 to the material bed (e.g., exposed surface of the material bed) along a predetermined pattern to additively generate at least a portion of the 3D object. The control system can be configured to modulate the energy source power, dwell time, pulse frequency, spot size, beam diameter, timing, and/or intensity. The control system can direct at least one energy source to supply energy to the material bed in pulses. The control system can additionally be in communication with the payout roll and/or the uptake roll to control movement of the platform.

A system as described in FIG. 13 can generate a 3D object through an additive roll-to-roll process. In an example, as the platform 1302 moves through the payout roll 1301 to the uptake roll 1303, 3D objects (e.g., 1307) are generated adjacent to or from the platform 1302 from at least a portion of the pre-transformed material in the material bed 1311. The 3D objects 1307 can be rolled around the uptake roll 1303. In some cases, a barrier layer or material (e.g., a polymer or foam film) can be provided adjacent to the 3D objects 1308 to prevent the objects from sticking to each other when the platform 1302 is wrapped around the uptake roll 1303. The barrier layer may be used as the platform 1302. In some instances, a barrier (e.g., a slab of material) prevents the pre-transformed material within the material bed from sliding passed the uptake roll.

In some situations, the payout roll (e.g., 1301) may be precluded and the 3D objects (e.g., 1307) may be directed (e.g., continuously or semi-continuously) onto the uptake roll (e.g., 1303). In some situations, the uptake roll (e.g., 1303) may be precluded and the 3D objects (e.g., 1307) may be directed (e.g., continuously or semi-continuously) from the payout roll (e.g., 1301). The platform (e.g., 1302) (e.g., directed from the payout roll 1301) may be separated from the 3D objects (e.g., 1307) before they are rolled around the uptake roll (e.g., 1303).

The platform can be a flexible structure that can be rolled out of the payout roll and rolled into the uptake roll. The platform can form part of the 3D objects or can be separate or separable from the 3D objects. The platform can be a sheet having a bundle of fibers, a mesh or a net, which can be rolled into the uptake roll or separated from the uptake roll.

The systems and/or apparatuses described herein can form a single 3D object or an array of 3D objects. The systems and/or apparatuses can perform actions in a series of steps to form the 3D object. Forming the 3D object can comprise initiating a movement of the platform from the payout roll to the uptake roll. At least one layer of pre-transformed material can be supplied to at least a portion of the platform. The pre-transformed material can be supplied as the platform moves from the payout roll to the uptake roll. The pre-transformed material can be supplied as the platform is stationary (e.g., stops from moving from the payout roll to the uptake roll). One or more energy sources can provide energy to the at least a portion of the one or more layers of the pre-transformed material. The one or more energy sources can provide energy to the portion of the one or more layers of pre-transformed material along a pattern that corresponds to a cross section of the 3D object. Corresponds can comprise deviation. Corresponds can comprise corrective deviation such that the transformed material deviates from a cross section of the desired 3D object, but will form a portion of the 3D object that does not substantially deviates upon hardening (e.g., cooling) of the transformed material. At least a portion of the pre-transformed material can have an increased temperature resulting from receiving energy from the one or more energy sources. The increased temperature can be a temperature sufficient to transform (e.g., sinter, melt, connect, or other wise bind) at least a portion of the pre-transformed material. In some cases, the pre-transformed material can be passively and/or actively cooled after receiving energy from the one or more energy sources. Active cooling can comprise forced convection and/or providing a heat sink near or in contact with at least a portion of the material bed. Additively generating the 3D object can comprise directing energy (e.g., energy beam) to a least a portion of the pre-transformed material along a raster pattern, directing energy (e.g., energy beam) to a least a portion of the powder along a vector pattern, transforming and subsequently hardening (e.g., cooling) at least a portion of the pre-transformed material.

The pattern can be provided by a model design of at least one desired 3D object. The model can comprise a set of values or parameters that describe the shape and dimensions of the 3D object. The instructions can be provided through a file having a Standard Tessellation Language file format. In an example, the instructions can come from a 3D modeling program (e.g., AutoCAD, SolidWorks, Google SketchUp, or SolidEdge). In some cases, the model can be generated from a provided sketch, image, or 3D object.

In some cases a layer of pre-transformed material can be provided vertically adjacent to the portion of the pre-transformed material that received energy from the one or more energy sources. The pre-transformed material dispenser may travel laterally (e.g., 1313) along the material bed. The pre-transformed material dispenser may travel laterally, vertically, and/or in an angle (planar or compound). The one or more energy sources can provide energy to a layer of pre-transformed material adjacent to the portion of the pre-transformed material that previously received energy. The platform can be moving while the energy source applies energy to the pre-transformed material. The platform can be stationary while the energy source applies energy to the pre-transformed material (e.g., in the material bed). FIG. 13 shows different stages of a 3D object being formed in a roll-to-roll additive 3D printing system. Multiple 3D objects can be formed adjacent to or from the platform 1302.

The payout roll and the uptake roll can be at an angle relative to each other such that the platform is slanted as shown in FIG. 13. In the configuration shown in FIG. 13 a surface of a layer comprising the 3D object and a surface of the platform (e.g., sheet) can be oriented at an angle that is less than 90° with respect to the plane of the platform. In some cases the angle can be at least about 80°, 70°, 60°, 50°, 40°, 30°, 20°, 10°, 5°, or 1°. The platform may be disposed at an angle that is equal or less than the angle of repose of the pre-transformed material (e.g., powder) relative to the horizontal plane (e.g., to prevent sliding of the pre-transform material). The platform may be disposed at an angle of at most 8°, 7°, 6°, 5°, 4°, 3°, 2°, 1°, 0.5°, or 0.1° less than (e.g., smaller than) an angle of repose. The platform may be disposed at an angle of at least 8°, 70, 6°, 5°, 4°, 3°, 2°, 0.5°, or 0.1° smaller than an angle of repose. The platform may be disposed at an angle that is smaller than the angle of repose by any value between the aforementioned angle values (e.g., from about 8° to about 0.1°, from about 8° to about 4°, or from about 4° to about 0.1°).

The configuration shown in FIG. 13 permits the depth of the material bed 1311 to increase from the payout roll to the uptake roll while the surface of the material bed 1311 can remain substantially on the same plane (e.g., horizontal and/or normal to the direction of the gravitational field) between the payout roll and the uptake roll. Such a configuration can permit successive formation of layers as the at least a portion of the 3D object moves from one station (e.g., energy beam, 1305) to another station (e.g., 1314).

Layers of pre-transformed material can be provided substantially horizontally adjacent to the platform and/or an exposes surface of the material bed during the additive printing process (e.g., as shown in FIG. 13). In some cases a layer of pre-transformed material can be provided horizontally adjacent to the portion of the pre-transformed material that received energy from the one or more energy sources.

In some cases, the roll-to-roll systems and/or apparatuses and methods described herein can additively generate 3D objects with small-scaffold features. The energy beam schematically shown in FIG. 13 (e.g., emerging from the energy source 1305), can comprise a multiplicity of energy beam array (e.g., as described herein).

In some embodiment, the systems, apparatuses, and/or methods disclosed herein include two or more roll-to-roll apparatuses. The roll to roll system and/or apparatus is abbreviated herein as “roll-to-roll mechanism.” An example of two roll-to-roll mechanisms is shown in FIG. 14. The two roll-to-roll may operate in concert, in a synchronized manner, or not in a synchronized manner (e.g., out of synchronization). The first roll and the second roll may be rolling one towards each other such that the first object carried by the first roll and the second object carried by the second roll will meet each other. The meeting may be aligned, or misaligned. For example, the first and second objects in example 1412 are misaligned. The misalignment can be controlled and/or regulated (e.g., by a controller). The misalignment may be non controlled and/or non regulated. For example, the first and second objects in example 1414 are aligned. The two roll-to-roll mechanisms may mirror each other, or not mirror each other. FIG. 14 shows an example of a first roll-to-roll mechanism comprising payout roll 1401, uptake roll 1403, and moving platform(s) 1402; and a second roll-to-roll mechanism comprising payout roll 1421, uptake roll 1423, and moving platform(s) 1422. In the example shown in FIG. 14, the first and second roll-to-roll mechanisms mirror each other. Other components of the roll-to-roll mechanism may substantially mirror or not mirror each other. Other components of the roll-to-roll mechanism may be substantially identical or different. Different may include may differ in number of components, type, alignment, movement, control, regulation, method of operation, power (e.g., generated or supplied), or any combination thereof. The number of components (e.g., of each type of components) can be zero, one, two, three, four, five, six, seven, eight, nine, ten, or more. In the example shown in FIG. 14, the first array of energy beams emerging from platform 1409 mirror the second array of energy beams that emerge from platform 1429, and the position of the energy sources (e.g., 1405 and 1425 respectively); the scanners (1404 and 1424 respectively). Mirroring and/or similarity may be in the position, type, and/or operation of the various components. Other components of the roll-to-roll mechanism may be common to both the first and second roll-to-roll mechanisms. In the example shown in FIG. 14, the material (e.g., pre-transformed material) dispenser 1416 is common to both first and second roll-to-roll mechanisms and may travel along both material beds. In other dual roll-to-roll mechanisms, each roll-to-roll mechanism may include its own material dispenser. The number of material dispensers in each roll-to-roll mechanism may differ. For example, the first roll-to-roll mechanism may comprise one material dispenser, and the second roll-to-roll mechanism may comprise two or more material dispensers. The material dispensers of each roll-to-roll mechanism may be substantially identical, mirroring, or different. The material dispensers may differ in type, number, alignment, movement path, control, regulation, method of dispensing the material, the material being dispensed, or any combination thereof. The scanners may differ in type, number, alignment, movement path, control, regulation, method of scanning, or any combination thereof. The energy sources may differ in type, number, alignment, position, control, regulation, power, method of generating an energy beam, type of energy beam generated, or any combination thereof. The energy sources may differ in type, number, alignment, position, control, regulation, power, pulse frequency, focus, path traveled, scanner, or any combination thereof. The roll (e.g., uptake or payout) may differ in type, number, alignment, position, control, regulation, power, on/off times, or any combination thereof. The platforms may differ in type, number, alignment, position, control, regulation, velocity, on/off times (e.g., stopping and moving times), or any combination thereof. The material evacuating member may differ in type, number, alignment, position, control, regulation, velocity, on/off times, power (e.g., vacuum power), material entrance port(s), or any combination thereof. The material collecting mechanism may differ in type, number, alignment, position, control, regulation, power (e.g., vacuum power), material entrance port(s), reservoir, material collected, or any combination thereof. FIG. 14 shows an example of a single material evacuating member that evacuates pre-transformed material (e.g., excess of pre-transformed material) from the material bed of both first and second roll-to-roll mechanisms. The single evacuating member may comprise a single or multiple compartments (e.g., reservoirs). The material evacuating member may comprise one, two or more material entrance ports though which pre-transformed material may enter the evacuating member (e.g., using vacuum, mechanical, electric (e.g., charge), or magnetic force). In some embodiments, the material evacuating member may comprise a first opening directed towards the first roll-to-roll mechanism (e.g., first material bed), and a second opening directed towards the second roll-to-roll mechanism (e.g., second material bed). In some examples, the first and second openings may be in fluid communication with each other. In some examples, the first and second openings may not be in fluid communication with each other (e.g., physically separated). The physical separation may be effectuated by an obstruction (e.g., a wall). In some embodiments, the power exerted through the first opening does not affect the power exerted through the second opening.

The 3D objects or parts thereof fabricated in the first and second roll-to-roll mechanism may be substantially identical, substantially mirroring, and/or different. The 3D objects or parts thereof fabricated in the first and second roll-to-roll mechanisms may differ in their material type (e.g., chemical composition), microstructure (e.g., metallurgical or crystal structure), porosity, strength, small-scaffold features, structure (e.g., 3D structure including volume, length, width, height, or circumference), elasticity, temperature, or relative alignment. The 3D objects or parts thereof fabricated in the first and second roll-to-roll mechanisms may differ in the number of materials from which each respective 3D object is composed. For example, the first roll-to-roll mechanism may fabricate 3D objects composed of a single material type, and the second roll-to-roll mechanism may fabricate 3D objects composed of two or more material types. The first and second roll-to-roll mechanism may be arranged in a manner that will allow each of the 3D objects to form a third 3D object that is comprised of the first 3D object formed by the first roll-to-roll mechanism and of the second 3D object formed by the second roll-to-roll mechanism.

FIG. 14 shows examples of various third 3D objects formed from substantially similar or different first and second 3D object respectively. In the example shown in FIG. 14, 1412, the first and second 3D objects are substantially identical, but are arranged in a misalignment to form the third 3D object. In the example shown in FIG. 14, 1413, the first and second 3D objects are substantially different, they differ both in their general 3D shape as well as in their internal structure (e.g., microstructure (metallurgical and/or crystal) and/or small-scaffold structure). In the example shown in FIG. 14, 1414 the first and second 3D objects are aligned, and have the same general shape, but the first 3D object is composed of two material (e.g., rim and interior), whereas the second 3D object is composed of a single material type.

The third 3D object may be formed by connecting and/or contacting the first and second 3D objects in at least one position. The connecting and/or contacting may comprise chemical or physical contact. The connecting and/or contacting may comprise interlocking, welding, lamination, gluing, chemically binding (e.g., covalent, or complexation), sticking, or otherwise adhering to each other. The connecting and/or contacting may be reversible or irreversible. The connecting and/or contacting may include introducing a connecting and/or contacting material. The connecting and/or contacting material may be the same or different than the materials comprising the first and second 3D objects.

The third 3D object may have a unique internal structure. The 3D object may be actuated (e.g., electrically, optically, and/or magnetically). The 3D object may be actuated (e.g., stimulated) to change its 3D shape (e.g., deform). The deformation may include contraction or expansion. The internal structure may be controlled. The control may be effectuated by a controller and/or by a stimulus. The control may be manual and/or automatic. The control may comprise controlling (e.g., regulating) the porosity, temperature, conductivity, thickness, transparency, color, absorption, permeability, chemical, and/or physical characteristics of the 3D object.

The third 3D object may comprise cavities and/or integration of one or more devices. The device may be integrated within the third 3D object, and/or at the surface of the 3D object. The device may be accessible and/or visible from the surface of the 3D object. The device may be buried within the 3D object. The device may be non visible from the surface of the 3D object. Visible may include with a naked eye and/or optical microscope. Visible may include optically. The devices may include passive or active devices. The devices may include electronic devices. The devices may include Bluetooth® technology. The devices may include sensor, actuator, antenna (e.g., radio frequency identification (RFID)), magnet, energy harvesting device (e.g., solar cell), colors, radiation emitter, or energy generating device (e.g., batteries). The device may include any sensor described herein. The device may effectuate control. Controlling the properties of the third 3D object may be though the device. The properties may include color, radiation, volume, height, width, length, temperature, charge, magnetism, specific density, specific strength, porosity, stiffness, hygroscopicity, lipophilicity, hydrophilicity, surface structure, or any combination thereof. The devices may respond to an external trigger (e.g., signal and/or other input). For example, the external trigger (e.g., signal) may be received by the device and cause it to alter the characteristic of the 3D object. FIG. 14 shows examples of various devices within the third 3D object (e.g., 1432-1434). The devices may be inserted during the formation of the first, second, and/or third 3D object. The device may be inserted during the connecting stage of the first and second 3D objects to form the third 3D object. A 3D object may comprise of one or more devices. The one or more devices may be identical or different. The one or more devices may be evenly or unevenly distributed within the 3D object. The distribution of the devices within the 3D object (e.g., third 3D object) may be controlled. The distribution of the devices within the 3D object may depend on the structure (e.g., internal, external and/or overall) of the 3D object. The internal structure may comprise one or more cavities and/or one or more small scaffold features. The third 3D object may comprise substantially a single type of first 3D object and a single type of second 3D object (e.g., only 1412, 1413, or 1414 type). The third 3D object may comprise two or more types of first 3D object and one or more types of second 3D object (e.g., 1412 and 1413 forming a single third 3D object). The third 3D object may be devoid of a device (e.g., as disclosed herein).

Methods of the present disclosure can be implemented using a control system. Any of the systems and/or apparatuses disclosed herein and/or any of their components can be controlled and/or regulated by the control system (e.g., controller). The control system can be a programmed computer control systems. FIG. 11 shows a computer system 1101 that is programmed or otherwise configured to control an additive manufacturing system while forming a 3D object with macroscopic and small-scaffold features. The computer system 1101 can regulate various aspects of the energy beam of the present disclosure, such as, for example, controlling scanning rate and/or location of the energy beam(s) (e.g., of the energy beam array platform). The computer system 1101 can scan the energy beam in a raster or vector pattern on the surface of the material bed to form the 3D object. The computer system can control the power of the energy beam(s). The computer system can turn different energy sources (e.g., diodes) on and off in a multi headed energy beam (e.g., array) as described herein.

The computer system 1101 may include a processor (e.g., a central processing unit (CPU)) 1005. The processor can be a single core or multi core processor, or a plurality of processors for parallel processing. The computer may comprise multiple processor architecture. The computer may comprise parallel processor architecture. The computer may comprise field programmable gate arrays (FGPA). The computer system may include memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage, and/or electronic display adapters. The memory, storage unit, interface and/or peripheral devices may be in communication with the CPU through a communication bus (solid lines), such as a motherboard. The storage unit can be a data storage unit (or data repository) for storing data. The computer system can be operatively coupled to a computer network (“network”) 1030 with the aid of the communication interface 1020. The network can be the Internet, an Internet and/or extranet, an intranet and/or extranet that is in communication with the Internet, or any combination thereof. The network in some cases is a telecommunication, data network, or any combination thereof. The network can include one or more computer servers, which can enable distributed computing, such as cloud computing. The network, in some cases with the aid of the computer system 1001, can implement a peer-to-peer network, which may enable devices coupled to the computer system to behave as a client or a server.

The processor can execute a sequence of machine-readable instructions, which can be embodied in a program or software. The instructions may be stored in a memory location, such as the memory. The instructions can be directed to the processor, which can subsequently program or otherwise configure the processor to implement methods of the present disclosure. Examples of operations performed by the processor can include fetch, decode, execute, and write back.

The processor can be part of a circuit, such as an integrated circuit. One or more other components of the system 1001 can be included in the circuit. In some cases, the circuit is an application specific integrated circuit (ASIC), digital signal processor (DSP), a group of processing components, or any combination thereof.

The storage unit can store files, such as drivers, libraries and saved programs. The storage unit can store user data, e.g., user preferences and user programs. The computer system, in some cases, can include one or more additional data storage units that are external to the computer system, such as located on a remote server that is in communication with the computer system through an intranet or the Internet. The communication can be electrical, physical, proximal, remote, or any combination thereof.

The computer system can communicate with one or more remote communication devices through the network 1030. The remote communication devices may comprise a remote computer system. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network. The remote communication device may comprise cellular phone, smart phone, or tablet. The remote communication device may comprise Bluetooth® technology.

Methods as described herein can be implemented by way of machine (e.g., computer processor) executable code stored on an electronic storage location of the computer system, such as, for example, on the memory and/or electronic storage unit. The machine executable or machine-readable code can be provided in the form of software. During use, the processor can execute the code. In some cases, the code can be retrieved from the storage unit and stored on the memory for ready access by the processor. In some situations, the electronic storage unit can be precluded, and machine-executable instructions are stored on memory 1010.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems, apparatus and/or methods provided herein, such as the computer system, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; wire (e.g., copper wire) and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system can include or be in communication with an electronic display that comprises a user interface (UI) for providing, for example, a model design or graphical representation of an object to be printed (object to be formed). Examples of UI's include, without limitation, a graphical user interface (GUI) and web-based user interface. The computer system can monitor and/or control various aspects of the printing system. The control may be manual or programmed. The control may rely on feedback mechanisms that have been pre-programmed. The feedback mechanisms may rely on input from sensors (described herein) that are connected to the control unit (i.e., control system or control mechanism e.g., computer). The computer system may store historical data concerning various aspects of the operation of the printing system. The historical data may be retrieved at predetermined times or at a whim. The historical data may be accessed by an operator or by a user. The historical and/or operative data may be displayed on a display unit. The display unit (e.g., monitor) may display various parameters of the printing system (as described herein) in real time or in a delayed time. The display unit may display the currently printed 3D object (e.g., in real time), the ordered printed 3D object, the actually printed 3D object or any combination thereof. The display unit may display the printing progress of the printed 3D object, or various aspects thereof. The display unit may display at least one of the total time, time remaining and time expanded on printing the generated 3D object. The display unit may display the status of sensors, their reading and/or time for their calibration or maintenance. The display unit may display the type or types of material used and various characteristics of the material or materials such as temperature and flowability of the material (e.g., powder material). The display unit may display the amount of gas in the chamber. The gas may comprise oxygen, hydrogen, water vapor, or any of the afore-mentioned gasses. The display unit may display the pressure in the printing chamber (i.e., the chamber where the object is being formed). The computer may generate a report comprising various parameters of the printing system and/or printing process. The report may be generated at predetermined time(s), on a request (e.g., from an operator) or at a whim.

Methods and systems of the present disclosure can be implemented by way of one or more algorithms. An algorithm can be implemented by way of software upon execution by one or more computer processors.

The systems, apparatuses, and/or parts thereof may comprise Bluetooth technology. systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The surface identification mechanism may comprise a plug and/or a socket (e.g., electrical, AC power, DC power). The systems, apparatuses, and/or parts thereof may comprise an adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

While preferred embodiments of the present invention have been shown and described herein, it will be obvious to those skilled in the art that such embodiments are provided by way of example only. It is not intended that the invention be limited by the specific exanokes provided within the specification. While the invention has been described with reference to the afirenebtuibed specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for generating a three-dimensional object, comprising: (a) providing a material bed comprising a material for use in generating at least a portion of the three-dimensional object; and (b) transforming at least a portion of the material in the material bed using a plurality of energy beams from an energy beam array to form a hardened material, which transforming comprises subjecting the plurality of energy beams to relative motion with respect to material bed along a vectorial path, wherein the hardened material forms at least a portion of the three-dimensional object.

2. The method of claim 1, wherein the material is a powder material.

3. The method of claim 2, wherein the material comprises individual particles formed of an elemental metal, metal alloy, ceramic, or an allotrope of elemental carbon.

4. The method of claim 1, further comprising translating the energy beam.

5. The method of claim 1, further comprising translating the material bed.

6. The method of claim 1, wherein transforming is indirectly hardening.

7. The method of claim 6, wherein indirectly hardening comprises transforming at least a portion of the material in the material bed into a transformed material that subsequently hardens into a hardened material to form at least a portion of the three-dimensional object.

8. The method of claim 7, wherein transforming comprises fusing.

9. The method of claim 8, wherein fusing comprises melting or sintering.

10. The method of claim 1, wherein transforming is directly hardening.

11. The method of claim 1, wherein the three-dimensional object comprises a scaffold feature.

12. The method of claim 1, wherein the three-dimensional object comprises a scaffold feature generated by the plurality of energy beams.

13. The method of claim 12, wherein the path for generating the scaffold feature comprises simultaneously generating a multiplicity of cells within the scaffold feature.

14. The method of claim 13, wherein the cells are space filling polygons.

15. The method of claim 1, wherein the energy beam array comprises an electromagnetic beam or a charged particle beam.

16. The method of claim 13, wherein the electromagnetic beam is a laser.

17. The method of claim 15, wherein the laser is a laser diode.

18. The method of claim 1, wherein the energy beam array comprises an n by m matrix of energy sources, wherein ‘n’ is an integer greater than or equal to one, and wherein ‘m’ is an integer greater than or equal to two.

19. The method of claim 1, wherein the energy beams are single mode energy beams.

20. The method of claim 1, wherein the energy beams are a high focus energy beams.

21. The method of claim 1, wherein each of the plurality of energy beams has a footprint diameter on an exposed surface of the material bed that is at most about 100 micrometers.

22. The method of claim 1, wherein each of the plurality of energy beams has a footprint diameter on an exposed surface of the material bed that is from about 0.3 micrometers to about 100 micrometers.

23. The method of claim 1, wherein each energy beam of the plurality of energy beams is generated by an energy source as part of the energy beam array.

24. The method of claim 1, wherein the energy beams are low power energy beams.

25. The method of claim 23, wherein the energy source produces a power of at most about 10 Watts.

26. The method of claim 23, wherein the energy source produces a power of from about 0.5 watts to about 10 Watts.
